(19) United States
(12) Patent Application Publication
(10) Pub. No.: US 2024/0033826 A1
(43) Pub. Date: Feb. 1, 2024

(54) DEFORMATION REDUCTION IN THREE-DIMENSIONAL OBJECT FORMATION

(71) Applicant: Velo3D, Inc., Campbell, CA (US)

(72) Inventor: Benyamin Buller, Cupertino, CA (US)

(21) Appl. No.: 18/218,135

(22) Filed: Jul. 5, 2023

Related U.S. Application Data
(63) Continuation of application No. 18/122,209, filed on Mar. 16, 2023.
Application No. 18/122,209 is a continuation of application No. 18/073,781, filed on Dec. 2, 2022, now abandoned.
Application No. 18/073,781 is a continuation of application No. 17/888,591, filed on Aug. 16, 2022, now abandoned.
Application No. 17/888,591 is a continuation of application No. 17/740,447, filed on May 10, 2022, now abandoned.
Application No. 17/740,447 is a continuation of application No. 17/592,710, filed on Feb. 4, 2022, now abandoned.
Application No. 17/592,710 is a continuation of application No. 17/509,509, filed on Oct. 25, 2021, now abandoned.
Application No. 17/509,509 is a continuation of application No. 17/372,425, filed on Jul. 10, 2021, now abandoned.
Application No. 17/372,425 is a continuation of application No. PCT/US20/12616, filed on Jan. 7, 2020.
(60) Provisional application No. 62/791,589, filed on Jan. 11, 2019.

(51) Int. Cl. B22F 10/47; B22F 10/30; B22F 3/11; B33Y 10/00; B33Y 30/00; B33Y 50/02; B33Y 70/00

(52) U.S. Cl. CPC B22F 10/47; B22F 10/30; B22F 3/11; B33Y 10/00; B33Y 30/00; B33Y 50/02; B33Y 70/00

(57) ABSTRACT

The present disclosure relates to generation of a non-connected support for use during maturation stage(s) of an intermediate three-dimensional (3D) object (e.g., green object). The non-connected support may comprise a shrinkable, and/or flowable material (e.g., particles). The non-connected support may be provided into a (e.g., shrinkable) enclosure, along with the intermediate 3D object, during the maturation stage(s). The non-connected support may reduce formation of a defect in the maturing 3D object, during and/or following the maturation stage(s). The non-connected support may be readily separated from the matured (e.g., densified) 3D object.

### CROSS-REFERENCE

This application is a continuation of U.S. patent application Ser. No. 18/122,209 filed Mar. 16, 2023; which is a continuation of U.S. patent application Ser. No. 18/073,781 filed Dec. 2, 2022; which is a continuation of U.S. patent application Ser. No. 17/888,591 filed Aug. 16, 2022; which is a continuation of U.S. patent application Ser. No. 17/740,447 filed May 10, 2022; which is a continuation of U.S. patent application Ser. No. 17/592,710 filed Feb. 4, 2022; which is a which continuation of U.S. patent application Ser. No. 17/509,509 filed Oct. 25, 2021; which is a continuation of U.S. patent application Ser. No. 17/372,425 filed Jul. 10, 2021; which is a continuation application of PCT/US20/012616 filed Jan. 7, 2020; which claims priority claims the benefit of U.S. Provisional Patent Application No. 62/791,589, filed Jan. 11, 2019, each of which is entirely incorporated herein by reference.

### BACKGROUND

Three-dimensional (3D) objects may be formed using various methodologies, for example, molding, sculpting, or three-dimensional (3D) printing. Many three-dimensional forming processes are currently available. A variety of materials can be used in a three-dimensional forming process, including elemental metal, metal alloy, ceramic, elemental carbon, or polymeric material. Different three-dimensional forming processes may vary in the material(s) that are used to generate the designed structure. Different three-dimensional forming processes may differ in the manner a requested material is provided to form a requested 3D object therewith. In some methods, layers of a requested material are deposited and/or formed to create a materialized structure.

A 3D object may be for example generated by additive manufacturing. Additive manufacturing may include any methodology related to layer-wise deposition. In some 3D printing processes (e.g., additive manufacturing), a first layer of hardened material is formed, and thereafter successive layers of hardened material are added one by one, wherein each new layer of hardened material is added on a pre-formed layer of hardened material, until the entire designed three-dimensional structure (3D object) is layer-wise materialized. This process may be controlled, e.g., computer controlled, manually controlled, or both. A 3D printer can be an industrial robot.

The requested 3D object may be formed considering a (e.g., three-dimensional) model. Three-dimensional (3D) models may be generated with a computer-aided design (CAD) package, via a 3D scanner, and/or manually. The modeling process of preparing geometric data for 3D computer graphics may be similar to those of the plastic arts, such as sculpting or animating. 3D scanning is a process of analyzing and collecting digital data on the shape and appearance of a real object (e.g., real-life object). Based on these data, 3D models of the scanned object can be produced.

At times, a requested 3D object, e.g., that is formed of a requested material, may be formed through an intermediate state (also referred herein as “intermediate 3D object” or “intermediate object”). The intermediate object may be a brown object or a green object. The intermediate object may require further maturation to generate the requested 3D object in one or more maturation stages (e.g., a densification stage). The maturation process may result in a deformed 3D object as compared to the requested 3D object.

### SUMMARY

At times, it is requested to reduce deformation (e.g., geometric deformation or material deformation) of intermediate (e.g., green and/or brown) 3D objects during their maturation (e.g., densification). Deformation during maturation may be due to drooping and/or sagging of at least a portion of the object. In some embodiments, attenuating deformation may be promoted without reliance on (e.g., rigid, and/or non-flowable) auxiliary support(s). The 3D object may or may not be a complex 3D object. A complex 3D object may comprise at least one cavity or ledge.

In some embodiments, a non-connected support is provided to the intermediate object, e.g., during one or more maturation stages. In some embodiments, absence of connection between the intermediate object and the supporting substance is during at least one maturation stage(s). The absence of connection may persist after the maturation stage(s). The supporting substance may comprise a filler. For example, the non-connected support may comprise a shrinkable and/or flowable filler. The filler may be configured to support the 3D object, e.g., at least during a maturation stage (e.g., during densification). The 3D object and the filler may be provided in a (e.g., sealable) container. At least during densification, the filler may be configured to occupy at least some of the spaces in the sealable container that are not occupied by the 3D object. The filler may occupy at least some (e.g., macroscopic) cavities within the 3D object. The cavities may be accessible to the filler. Under conditions of at least one maturation stage, the container, filler and 3D object may undergo a similar volumetric reduction (e.g., simultaneously). The contracted container (e.g., that is sealed) may compress the filler. The (e.g., non-connected support) filler may remain flowable before, after, and/or during a densification stage. The filler may remain in contact with surfaces of the pre-densified 3D object, e.g., for support to prevent deformation as it densifies (e.g., contracts). The container may be configured to be sealed during at least one maturation stage, such that the filler does not escape. Following the at least one maturation stage(s), the filler may be removed from contacting the 3D object and the container.

The operations of any of the methods, non-transitory computer readable media, and/or controller directions described herein can be in any order. At least two of the operations in any of the methods, non-transitory computer readable media, and/or controller(s) can be performed simultaneously.

In another aspect, a method for forming a densified three-dimensional object, comprises: (a) disposing a porous three-dimensional object and a flowable filler in an enclosure; (b) densifying (i) the porous three-dimensional object to form the densified three-dimensional object that has a density greater than the porous three-dimensional object, and (ii) the flowable filler such that the flowable filler remains flowable upon formation of the densified three-dimensional object; and (c) separating the densified three-dimensional object from the flowable filler.

In some embodiments, the method further comprises separating the densified three-dimensional object from the enclosure. In some embodiments, the flowable filler that is separated from the densified three-dimensional object in (c), has been densified in (b). In some embodiments, the method further comprises contracting the enclosure during densification of the porous three-dimensional object. In some embodiments, the enclosure is a porous enclosure, and wherein the method further comprises densifying the porous enclosure during densification of the porous three-dimensional object. In some embodiments, the method further comprises evacuating the densified three-dimensional object from the enclosure after forming the densified three-dimensional object. In some embodiments, the method further comprises evacuating the flowable filler from the enclosure after forming the densified three-dimensional object. In some embodiments, the flowable filler is flowable (i) during densification of the porous three-dimensional object and/or (ii) during contraction of the flowable filler. In some embodiments, during densification, the flowable filler supports (i) the porous three-dimensional object and/or (ii) the densified three-dimensional object. In some embodiments, the enclosure has an opening that can facilitate ingress and/or egress of (i) the porous three-dimensional object, (ii) the flowable filler, and/or (iii) the densified three-dimensional object. In some embodiments, the opening is openable and/or closable by a lid. In some embodiments, during densification of the porous three-dimensional object, the lid is closed. In some embodiments, at least two of: (i) the enclosure, (ii) the porous three-dimensional object, and (iii) the flowable filler, comprise the same material. In some embodiments, at least two of: (i) the enclosure, (ii) the porous three-dimensional object, and (iii) the flowable filler, contract in the same manner during densification of the porous three-dimensional object. In some embodiments, the porous three-dimensional object is a green body or a brown body. In some embodiments, densification of the porous three-dimensional object comprises using heat or pressure. In some embodiments, the method further comprises controlling densification of the porous three-dimensional object using one or more controllers. In some embodiments, the flowable filler is smaller than the densified three-dimensional object.

In another aspect, an apparatus for forming a densified three-dimensional object, comprises: at least one controller that is configured to: (a) operatively couple to a first component, and a second component; (b) direct the first component to provide a flowable filler to an enclosure to at least partially support a porous three-dimensional object disposed within the enclosure, wherein the enclosure is configured to enclose an interior environment in a volume, wherein the enclosure is configured to accommodate in the volume the porous three-dimensional object and the flowable filler during densification of the porous three-dimensional object that forms the densified three-dimensional object that has a greater density as compared to the porous three-dimensional object; and (c) direct the second component to adjust a characteristic of the interior environment to (i) densify the porous three-dimensional object to form the densified three-dimensional object, and (ii) densify the flowable filler, wherein the flowable filler remains flowable upon formation of the densified three-dimensional object.

In some embodiments, the at least one controller is further configured to direct the first component to distribute the flowable filler to at least partially surround the porous three-dimensional object, in order to provide the flowable filler. In some embodiments, the first component comprises a conveyor (e.g., conveyor belt), an emitter (e.g., of a sonicator), a hopper, a piston, a robotic arm, or a rotating screw. In some embodiments, the emitter is configured to emit an electromagnetic wave, and/or a sound wave, into a medium that is coupled with the enclosure. In some embodiments, the first component comprises a hopper, a dispenser, a funnel, an opening, or a channel, wherein the opening and/or the channel are configured to flow the flowable filler therethrough. In some embodiments, the second component comprises a pump, a heat source, a gas source, or a fluid source. In some embodiments, the first component and/or the second component comprises an actuator. In some embodiments, to adjust the characteristic of the interior environment comprises an adjustment to a temperature, a pH, and/or to a pressure. In some embodiments, the adjustment comprises an increase with respect to an environment that is external to the interior environment. In some embodiments, the adjustment comprises a decrease with respect to an environment that is external to the interior environment. In some embodiments, the at least one controller is further configured to consider a maturing instruction(s) (e.g., set) to perform (b) and/or (c). In some embodiments, the maturing instruction(s) comprises a temperature (e.g., threshold) profile, a pH (e.g., threshold) profile, or a pressure (e.g., threshold) profile. In some embodiments, one or more commands of the maturing instruction(s) consider a given maturation stage of the porous three-dimensional object. In some embodiments, the maturing instruction(s) comprise one or more commands for at least two maturation stages of the porous three-dimensional object. In some embodiments, the at least two maturation stages comprise (i) removal of a binder material of the porous three-dimensional object, (ii) connecting (e.g., particulate) material of the porous three-dimensional object, or (iii) densifying (e.g., particulate) material of the porous three-dimensional object. In some embodiments, densifying material of the porous three-dimensional object comprises fusing the material. In some embodiments, the maturing instruction comprises a densification instruction. In some embodiments, the at least one controller is further configured to operatively couple to a third component, and to direct the third component to separate between the densified three-dimensional object and the flowable filler. In some embodiments, the at least one controller is further configured to consider a signal from a sensor to direct the third component. In some embodiments, the at least one controller is configured to direct the third component to evacuate the flowable filler from the enclosure to separate. In some embodiments, the third component comprises, or is configured to operatively couple to a force source comprising: a magnetic, electrostatic, gaseous, or mechanical force source. In some embodiments, the third component comprises, or is configured to operatively couple to a brush, a squeegee, a crane, a robotic arm, an agitator, or an actuator. In some embodiments, the at least one controller is configured to direct the third component to remove the densified three-dimensional object from the enclosure to separate. In some embodiments, the first component and the third component are the same. In some embodiments, the first component and the third component are different. In some embodiments, the at least one controller comprises a closed loop control scheme. In some embodiments, the closed loop control comprises a feedback or a feed-forward control scheme. In some embodiments, the at least one controller is further configured to consider a signal from a sensor to direct the first component and/or the second component. In some embodiments, the at least one controller is configured to consider the signal to perform a feedback and/or a feed-forward control scheme. In some embodiments, the sensor comprises an optical, capacitive, inductive, or mechanical, sensor. In some embodiments, the sensor comprises a transducer or a switch. In some embodiments, the at least one controller is configured to operatively couple to an opening of the enclosure, and to direct ingress and/or egress of (i) the porous three-dimensional object, (ii) the flowable filler, and/or (iii) the densified three-dimensional object. In some embodiments, the at least one controller is configured to direct operation of (A) a shutter, (B) a lid, and/or (C) a valve, to direct the ingress and/or the egress. In some embodiments, during (c), the at least one controller is configured to direct the opening to separate the interior environment from an external environment. In some embodiments, (b) and (c) are performed by a same controller. In some embodiments, (b) and (c) are performed by different controllers. In some embodiments, the enclosure comprises an inert and/or non-reactive atmosphere, which non-reactive (e.g., during, upon and/or after densification) is with respect to (i) the porous three-dimensional object, (ii) the densified three-dimensional object, and/or (iii) the flowable filler. In some embodiments, the interior environment of the enclosure comprises an atmosphere maintained at a pressure above ambient pressure. In some embodiments, the apparatus further comprises the at least one controller configured to operatively couple with a communication component, the communication component configured to communicate with the first component and/or the second component by a signal. In some embodiments, the communication component is configured to communicate wireless or via a wired connection. In some embodiments, the at least one controller comprises a socket. In some embodiments, the at least one controller comprises an electrical circuit.

In another aspect, a particulate material, comprises: one or more particles having characteristics comprises: (a) an average fundamental length scale of at most three (3) millimeters, (b) is flowable prior to densification of the one or more particles by at least twenty-five percent, (c) densifiable by the at least twenty-five percent upon heating, and (d) remains flowable upon densification by the at least twenty-five percent.

In some embodiments, the particulate material comprises an elemental metal or a metal alloy. In some embodiments, the particulate material is flowable prior to densification by the at least twenty-five percent. In some embodiments, the particulate material comprises a plurality of particles that do not adhere to each other before, upon, and/or after densification by the at least twenty-five percent. In some embodiments, before, upon, and/or after densification by the at least twenty-five percent, at least two particles of the particulate material are clumped together (e.g. connected). In some embodiments, before, upon, and/or after densification by the at least twenty-five percent, at least two particles of the particulate material are disconnected. In some embodiments, the particulate material comprises a plurality of particles that adhere to each other before, upon, and/or after densification by the at least twenty-five percent. In some embodiments, before, upon, and/or after densification by the at least twenty-five percent, the particulate material has a basic flow energy of at least about 100 milli-Joule (mJ). In some embodiments, before, upon, and/or after densification by the at least twenty-five percent, the particulate material has a specific energy of at least about 1.0 milli-Joule per gram (mJ/g). In some embodiments, before, upon, and/or after densification by the at least twenty-five percent, the particulate material has a critical angle of repose of 50 degrees or less. In some embodiments, a flowability of the particulate material prior to and upon densification by the at least twenty-five percent, remains (e.g., substantially) the same. In some embodiments, a flowability of the particulate material prior to the densification by the at least twenty-five percent, is higher than the flowability upon and/or after the densification. In some embodiments, the particulate material comprises a pore. In some embodiments, the pore is a closed pore. In some embodiments, the pore is an open pore. In some embodiments, the pore is isotropic. In some embodiments, the pore is anisotropic. In some embodiments, the particulate material comprises a plurality of pores. In some embodiments, at least two pores of the plurality of pores are disconnected. In some embodiments, at least two pores of the plurality of pores are interconnected. In some embodiments, the particulate material comprises an elemental metal or a metal alloy. In some embodiments, the particulate material has at least a partial coating that comprises an elemental metal, a metal alloy, a ceramic, or an allotrope of elemental carbon. In some embodiments, the particulate material has a coating that encapsulates the one or more particles. In some embodiments, the particulate material is a mature particulate material having a coating that comprises a material generated at least in part by a surface treatment of an immature particulate material from which the mature particulate material is derived. In some embodiments, the particulate material is a mature particulate material having a coating that comprises a material generated at least in part by a chemical manipulation of an immature particulate material from which the mature particulate material is derived. In some embodiments, the chemical manipulation comprises oxidation. In some embodiments, the particulate material comprises a network, or a lattice. In some embodiments, the particulate material comprises a foam. In some embodiments, the particulate material comprises a layer. In some embodiments, on average, the layer is an ellipsoid. In some embodiments, on average, the layer is planar. In some embodiments, the layer at least partially surrounds a core of the particulate material. In some embodiments, the particulate material comprises multi layers.

In another aspect, a method for forming a particulate material, comprises: forming one or more particles having characteristics comprises: (a) an average fundamental length scale of at most three (3) millimeters, (b) are flowable prior to densification of the one or more particles by at least twenty-five percent, (c) densifiable by the at least twenty-five percent upon heating, and (d) remain flowable upon densification by the at least twenty-five percent.

In some embodiments, forming the one or more particles comprises three-dimensional printing. In some embodiments, forming the one or more particles comprises sintering or melting (e.g., using an energy beam, e.g., such as a laser or an electron-beam). In some embodiments, forming the one or more particles comprises gas injection, or gas forming. In some embodiments, gas forming comprises decomposition or combustion. In some embodiments, forming the one or more particles comprises casting, molding, replication, imprinting, or deposition. In some embodiments, the deposition comprises chemical deposition or physical deposition. In some embodiments, the deposition comprises plasma deposition or vapor deposition. In some embodiments, forming the one or more particles comprises using a binder. In some embodiments, forming the one or more particles excludes using a binder. In some embodiments, forming the one or more particles comprises forming a coating on, or impregnating, the one or more particles. In some embodiments, the coating or impregnating is of a polymer. In some embodiments, the coating or impregnating is of a (e.g., metallic) foam. In some embodiments, the foam comprises an elemental metal or a metal alloy. In some embodiments, forming the one or more particles comprises passivating or oxidizing at least a portion of an external surface of the one or more particles. In some embodiments, forming the one or more particles comprises forming a pore within the one or more particles. In some embodiments, the pore comprises a closed pore. In some embodiments, the pore comprises an open pore. In some embodiments, densifiable comprises contractible. In some embodiments, densifiable facilitates supporting (i) a porous three-dimensional object during its densification, and (b) a densified three-dimensional object formed upon densification of the porous three-dimensional object. In some embodiments, the method further wherein the one or more particles are flowable during densification by the at least twenty-five percent.

In another aspect, a particulate material comprises: a plurality of particles having a fundamental length scale of at most three (3) millimeters, which plurality of particles includes a particle having characteristics comprises: (a) a shell constituent that (I) occupies at least a portion of an external surface of the particle and (II) is transformed at a first temperature, wherein transformation of the shell constituent comprises (i) densification by melting or (ii) densification by sintering; and (b) a core constituent that (A) has at least one pore, and (B) at least a portion of the core constituent is transformed at a second temperature lower than the first temperature, wherein transformation of the at least the portion of the core constituent comprises (b1) densification by melting or (b2) densification by sintering; and (c) before and upon transformation of the at least the portion of the core constituent, the particulate material is flowable.

In some embodiments, transformation of the at least the portion of the core constituent comprising densifying the at least the portion of the core constituent by at least twenty-five percent. In some embodiments, the shell constituent occupies at least fifty percent of the external surface of the particle. In some embodiments, the particulate material comprises an elemental metal or a metal alloy. In some embodiments, the particulate material is flowable prior to transformation of the at least the portion of the core constituent. In some embodiments, the plurality of particles do not adhere to each other before, upon, and/or after transformation of the at least the portion of the core constituent. In some embodiments, before, upon, and/or after transformation of the at least the portion of the core constituent, at least two particles of the plurality of particles are clumped together (e.g. connected). In some embodiments, before, upon, and/or after densification transformation of the at least the portion of the core constituent, at least two particles of the particulate material are disconnected. In some embodiments, at least two particles of the plurality of particles are adhered to each other before, upon, and/or after transformation of the at least the portion of the core constituent. In some embodiments, before, upon, and/or after transformation of the at least the portion of the core constituent, the particulate material has a basic flow energy of at least about 100 milli-Joule (mJ). In some embodiments, before, upon, and/or after transformation of the at least the portion of the core constituent, the particulate material has a specific energy of at least about 1.0 milli-Joule per gram (mJ/g). In some embodiments, before, upon, and/or after transformation of the at least the portion of the core constituent, the particulate material has a critical angle of repose of 50 degrees or less. In some embodiments, a flowability of the particulate material prior and upon transformation of the at least the portion of the core constituent, remains (e.g., substantially) the same. In some embodiments, a flowability of the particulate material prior to the transformation of the at least the portion of the core constituent, is higher than the flowability upon and/or after the transformation of the at least the portion of the core constituent. In some embodiments, the particulate material comprises a pore. In some embodiments, the pore is a closed pore. In some embodiments, the pore is an open pore. In some embodiments, the pore is isotropic. In some embodiments, the pore is anisotropic. In some embodiments, the particulate material comprises a plurality of pores. In some embodiments, at least two pores of the plurality of pores are disconnected. In some embodiments, at least two pores of the plurality of pores are interconnected. In some embodiments, the particulate material comprises an elemental metal or a metal alloy. In some embodiments, the core constituent comprises an elemental metal or a metal alloy. In some embodiments, the shell constituent comprises an elemental metal, a metal alloy, a ceramic, or an allotrope of elemental carbon. In some embodiments, the shell constituent at least in part encapsulates the core constituent. In some embodiments, the shell constituent is generated at least in part by a surface treatment of the core constituent. In some embodiments, the shell constituent is generated at least in part by a chemical manipulation of an external surface of the core constituent. In some embodiments, the chemical manipulation comprises oxidation. In some embodiments, the particulate material comprises a network, or a lattice. In some embodiments, the particulate material comprises a foam. In some embodiments, the core constituent comprises a network, or a lattice. In some embodiments, the core constituent comprises a foam. In some embodiments, the particulate material comprises a layer. In some embodiments, the shell constituent comprises the layer. In some embodiments, on average, the layer is an ellipsoid. In some embodiments, on average, the layer is planar. In some embodiments, the layer at least partially surrounds a core of the particulate material. In some embodiments, the particulate material comprises multi layers. In some embodiments, the shell constituent comprises the multi layers. In some embodiments, the core constituent comprises the multi layers.

In another aspect, a method for forming a particulate material, comprises: forming a plurality of particles, wherein forming a particle of the plurality of particles comprises: (a) forming a core such that the core (I) includes at least one pore and (II) at least a portion of the core is transformed at a first temperature, which transformation of the at least the portion of the core comprises: (i) densifying by melting or (ii) densifying by sintering, wherein the at least the portion of the core is transformable by heating, and wherein before and upon transformation of the at least the portion of the core, the particulate material is flowable; and (b) forming a shell such that the shell (I) at least partially occupies an external surface of the particle, and (II) is transformed at a second temperature that is higher than the first temperature, which transformation of the shell comprises: (i) densifying by melting or (ii) densifying by sintering, and wherein the plurality of particles have an average fundamental length scale of at most three (3) millimeters.

In some embodiments, forming the plurality of particles comprises three-dimensional printing. In some embodiments, forming the plurality of particles comprises an exothermic reaction and/or an explosive reaction. In some embodiments, forming the plurality of particles comprises casting, molding, replication, imprinting, or deposition. In some embodiments, deposition comprises chemical deposition or physical deposition. In some embodiments, deposition comprises plasma deposition or vapor deposition. In some embodiments, forming the plurality of particles comprises sintering or melting. In some embodiments, forming the plurality of particles comprises gas injection, or gas forming. In some embodiments, gas forming comprises decomposition or combustion. In some embodiments, forming the plurality of particles comprises using a binder. In some embodiments, forming the plurality of particles excludes using a binder. In some embodiments, forming the shell comprises coating, or impregnating. In some embodiments, coating or impregnating is of a material comprising a polymer. In some embodiments, coating or impregnating is of a material comprising a (e.g., metallic) foam. In some embodiments, the at least one pore comprises an open pore. In some embodiments, the at least one pore comprises a closed pore. In some embodiments, the plurality of particles is contractible to facilitate supporting (a) a porous three-dimensional object during its densification, and (b) a densified three-dimensional object that is formed upon densification of the porous three-dimensional object. In some embodiments, each particle of the plurality of particles is contractible. In some embodiments, the core comprises a network, or a lattice. In some embodiments, the core comprises a foam. In some embodiments, the core comprises a first material and the shell comprises a second material, and further wherein forming the shell comprises modifying the first material by the second material. In some embodiments, the modifying comprises adding the second material to the first material. In some embodiments, the modifying comprises treating the first material by a surface treatment. In some embodiments, the modifying comprises chemically manipulating. In some embodiments, chemically manipulating comprises passivating or oxidizing. In some embodiments, forming the core in (a) and forming the shell in (b) are performed (e.g., substantially) simultaneously. In some embodiments, forming the core in (a) and forming the shell in (b) are performed sequentially. In some embodiments, forming the core in (a) is performed prior to forming the shell in (b). In some embodiments, forming the shell in (b) is performed prior to forming the core in (a).

In another aspect, a particulate material, comprises: (a) a first material that forms a core of the particulate material, which particulate material supports: (i) a porous three-dimensional object during its densification to a densified three-dimensional object that has a density greater than the porous three-dimensional object, and (ii) the densified three-dimensional object upon densification; and (b) a second material disposed in an exterior of the particulate material, which second material allows the particulate material to be flowable during, and upon densification of the porous three-dimensional object, wherein flowable is at least to an extent that the particulate material is separable from the densified three-dimensional object.

In some embodiments, the first material is contractible to facilitate supporting (a) the porous three-dimensional object during its densification, and (b) the densified three-dimensional object upon densification. In some embodiments, the first material comprises a pore. In some embodiments, the pore is a closed pore. In some embodiments, the pore is an open pore. In some embodiments, the pore is isotropic. In some embodiments, the pore is anisotropic. In some embodiments, the first material is comprised in the porous three-dimensional object and/or in the densified three-dimensional object. In some embodiments, the first material comprises a plurality of pores. In some embodiments, at least two pores of the plurality of pores are disconnected. In some embodiments, at least two pores of the plurality of pores are interconnected. In some embodiments, the first material comprises an elemental metal or a metal alloy. In some embodiments, the second material comprises an elemental metal, a metal alloy, a ceramic, or an allotrope of elemental carbon. In some embodiments, the second material at least partially results from a surface treatment of the first material. In some embodiments, the second material comprises the first material that has been altered by a chemical manipulation. In some embodiments, the chemical manipulation of the first material to the second material comprises oxidation. In some embodiments, the first material comprises a network, or a lattice. In some embodiments, the first material comprises a foam. In some embodiments, the particulate material is smaller than the densified three-dimensional object. In some embodiments, the second material encapsulates the first material. In some embodiments, the particulate material comprises a layer. In some embodiments, on average, the layer is an ellipsoid. In some embodiments, on average, the layer is planar. In some embodiments, the layer surrounds the core of the particulate material. In some embodiments, the particulate material comprises multi layers.

In another aspect, a method for forming a particulate material, comprises: (a) forming a first material that is a core of the particulate material, which particulate material supports: (i) a porous three-dimensional object during its densification to a densified three-dimensional object that has a density greater than the porous three-dimensional object, and (ii) the densified three-dimensional object upon densification; and (b) forming a second material that at least partially covers the first material, which second material allows the particulate material to be flowable during and upon densification of the porous three-dimensional object, wherein flowable is at least to an extent that the particulate material is separable from the densified three-dimensional object.

In some embodiments, forming the first material comprises three-dimensional printing. In some embodiments, forming the first material comprises sintering or melting. In some embodiments, forming the first material comprises gas injection, or gas forming. In some embodiments, gas forming comprises decomposition or combustion. In some embodiments, forming the first material comprises casting, molding, replication, imprinting, or deposition. In some embodiments, the deposition comprises chemical deposition or physical deposition. In some embodiments, the deposition comprises plasma deposition or vapor deposition. In some embodiments, forming the first material comprises using a binder. In some embodiments, forming the first material excludes using a binder. In some embodiments, forming the first material includes coating, or impregnating. In some embodiments, coating or impregnating is of a polymer. In some embodiments, coating or impregnating is of a foam. In some embodiments, forming comprises an exothermic reaction and/or an explosive reaction. In some embodiments, the first material comprises a closed pore. In some embodiments, the first material comprises an open pore. In some embodiments, the first material is contractible to facilitate supporting (a) the porous three-dimensional object during its densification, and (b) the densified three-dimensional object upon densification. In some embodiments, the first material comprises a pore. In some embodiments, the first material is comprised in the porous three-dimensional object and/or in the densified three-dimensional object. In some embodiments, the first material comprises an elemental metal or a metal alloy. In some embodiments, the second material comprises an elemental metal, a metal alloy, a ceramic, or an allotrope of elemental carbon. In some embodiments, forming the second material comprises addition of the second material to the first material. In some embodiments, forming the second material comprises passivation. In some embodiments, forming the second material comprises chemically manipulating the first material. In some embodiments, chemically manipulating the first material to the second material comprises oxidation. In some embodiments, the first material comprises a network, or a lattice. In some embodiments, the first material comprises a foam. In some embodiments, the particulate material is smaller than the densified three-dimensional object. In some embodiments, the second material encapsulates the first material. In some embodiments, the particulate material comprises a layer. In some embodiments, on average, the layer is an ellipsoid. In some embodiments, on average, the layer is planar. In some embodiments, the layer surrounds the core of the particulate material. In some embodiments, the particulate material comprises multi layers. In some embodiments, the first material and the second material are of the same material. In some embodiments, forming the first material in (a) and forming the second material in (b) is performed (e.g., substantially) simultaneously. In some embodiments, forming the first material in (a) and forming the second material in (b) is performed sequentially. Another aspect of the present disclosure provides a system for effectuating the methods disclosed herein.

Another aspect of the present disclosure provides an apparatus for effectuating the methods disclosed herein.

Another aspect of the present disclosure provides one or more methods for utilizing the systems disclosed herein.

Another aspect of the present disclosure provides one or more methods for utilizing the apparatuses disclosed herein.

Another aspect of the present disclosure provides an apparatus comprising a controller that directs effectuating one or more operations (e.g., steps) in the method disclosed herein, wherein the controller is operatively coupled to the apparatuses, systems, and/or mechanisms that it controls to effectuate the method.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods above or elsewhere herein.

Another aspect of the present disclosure provides an apparatus for printing one or more 3D objects comprising a controller that is programmed to direct a mechanism used in a 3D printing methodology to implement (e.g., effectuate) any of the method disclosed herein, wherein the controller is operatively coupled to the mechanism.

Another aspect of the present disclosure provides a computer software product, comprising a non-transitory computer-readable medium in which program instructions are stored, which instructions, when read by a computer, cause the computer to direct a mechanism used in the 3D forming procedure to implement (e.g., effectuate) any of the method disclosed herein, wherein the non-transitory computer-readable medium is operatively coupled to the mechanism.

Another aspect of the present disclosure provides a non-transitory computer-readable medium comprising machine-executable code that, upon execution by one or more computer processors, implements any of the methods disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.,” Figs.,” “Fig.” or “Figs.” herein), of which:

FIGS. 1A-1D schematically illustrate various maturation stages;

FIG. 2 illustrates a flowchart;

FIG. 3 illustrates a flowchart;

FIGS. 4A-B schematically illustrates various examples of filler particles; and FIG. 4C schematically illustrates examples of contraction dependencies;

FIG. 5 schematically illustrates various examples of filler particles;

FIGS. 6A-6C schematically illustrate vertical cross sections of various maturation stages;

FIGS. 7A-B schematically illustrate vertical cross sections of various maturation stages;

FIGS. 8A-8C schematically illustrate vertical cross sections of various maturation stages;

FIGS. 9A-9D schematically illustrate various examples of separating a 3D object;

FIG. 10 schematically illustrates a forming device;

FIG. 11 schematically illustrates a control scheme;

FIG. 12A schematically illustrates an example of a 3D plane; FIG. 12B schematically illustrates a cross section in portion of a 3D object; and FIG. 12C shows a cross-sectional view of a 3D object with an auxiliary support member;

FIG. 13 schematically illustrates a computer system; and

FIG. 14 schematically illustrates a computer system.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

The present disclosure provides apparatuses, systems and methods for reducing (e.g., preventing) deformation during at least one maturation stage of forming (e.g., printing) 3D objects.

In some embodiments, a requested 3D object, e.g., that is formed of a requested material, may be formed through an intermediate object (e.g., a green object and/or a brown object). An intermediate object may comprise gaps and/or pores between (e.g., particles of) requested material. A brown object may comprise an intermediate 3D object formed of a requested material that is loosely connected together, e.g., that is not densified to a requested extent. A green object may comprise an intermediate 3D object formed of a requested material that is connected together with at least one binder. In the green object, gaps and/or pores may be occupied at least in part by the binder.

In some embodiments, an intermediate 3D object requires a subsequent maturation stage to achieve a requested material property(ies) (e.g., density). In some embodiments, a green (e.g., or porous) object requires a maturation process (e.g., comprising sintering) to convert it to a denser object having one or more requested material properties (e.g., density). In some embodiments, during a maturation process, gaps and/or pores in the intermediate (e.g., green) object are reduced (e.g., eliminated). The conditions (e.g., forces) of a maturation stage may promote deformation in the intermediate 3D object, e.g., due to shrinkage, gravity and/or thermal gradients within the object. Sometimes, a forming process and/or a maturation stage leads to at least a portion of a generated 3D object having an increased likelihood of forming least one defect. At times, it may be difficult to predict a location and/or extent of deformation for a given requested object (e.g., overall geometry and/or dimensional inaccuracy).

In some embodiments, a non-connected support is provided to reduce (e.g., prevent) deformation of a 3D object, e.g., during formation and/or one or more maturation stages. Upon completion of the maturation stage(s), the non-connected support may be removed to facilitate delivering the (e.g., densified) 3D object that was requested. In some embodiments, supports can at least partially provide a counterforce to forces causing deformation (e.g., due to shrinkage, gravity and/or thermal gradients). In some embodiments, once a maturation process ends, these supports are removed from the finished, and/or denser object.

In some embodiments, a non-connected support reduces a likelihood of at least one defect. Support that is devoid of connection (e.g., non-connected) to a 3D object may be in contact with the 3D object in an unattached and/or non-anchored manner. The 3D object may be an intermediate 3D object, and/or a densified 3D object (e.g., following a maturation stage). Lack of attachment precludes existence of intramolecular chemical bonds (e.g., strong chemical bonds such as covalent, ionic, or metallic bonds) between the support and the 3D object. Lack of attachment may include weak intermolecular bonds between the support and the 3D object, (e.g., van-der-Waals, or polar forces). The geometrical deformation may comprise bending, warping, or twisting. The deformation may include a geometric distortion and/or altered material property, with respect to a requested three-dimensional object having one or more geometric requirements (e.g., as to shape and/or tolerances) and/or one or more requested material properties. The deformation may comprise an internal deformation. Internal may be within the 3D object or a portion thereof. The deformation may be disruptive (e.g., for the intended purpose of the 3D object). The deformation may occur before, during, upon, and/or after densification of the material in the intermediate state. The deformation may comprise balling, warping, curling, bending, rolling, or external cracking. The geometrical deformation may comprise a deviation from at least one requested dimension of the requested 3D object.

Terms such as “a,” “an,” and “the” are not intended to refer to only a singular entity, but may include the general class of which a specific example may be used for illustration. The terminology herein is used to describe specific embodiments of the invention, but their usage does not delimit the invention.

When ranges are mentioned, the ranges are meant to be inclusive, unless otherwise specified. The term “between” as used herein is meant to be inclusive unless otherwise specified. For example, between X and Y is understood herein to mean from X to Y. For example, a range between value 1 and value 2 is meant to be inclusive and include value 1 and value 2, unless otherwise stated. The inclusive range will span any value from about value 1 to about value 2.

The term “adjacent” or “adjacent to,” as used herein, includes ‘next to’, or ‘in proximity to.’ In some instances, adjacent to may be ‘above’ or ‘below.’

The term “operatively coupled” or “operatively connected” refers to a first mechanism that is coupled (or connected) to a second mechanism to allow the intended operation of the second and/or first mechanism, e.g., including a first mechanism that is in signal communication with a second mechanism. The term “configured to” refers to an object or apparatus that is (e.g., structurally) configured to bring about an intended result.

The phrase “is/are structured,” or “is/are configured,” when modifying an article, refers to a structure of the article that is able to bring about the enumerated result.

Fundamental length scale (abbreviated herein as “FLS”) can refer to any suitable scale (e.g., dimension, or size) of an object. For example, a FLS of an object may comprise a length, a width, a height, a diameter, a spherical equivalent diameter, or a diameter of a bounding sphere.

A “global vector” may be (a) a (e.g., local) gravitational field vector, (b) a vector in a direction opposite to the direction of a layerwise 3D object formation, and/or (c) a vector normal to a surface of a platform that supports the 3D object, in a direction opposite to that of the 3D object.

The phrase “a three-dimensional object” as used herein may refer to “one or more three-dimensional objects,” as applicable.

“Real time” as understood herein may be during at least part of the forming (e.g., printing) of a 3D object. Real time may be during a forming operation. Real time may be during a forming cycle. Real time may comprise during formation of: an intermediate 3D object, a layer of material as part of the intermediate 3D object, during at least part of a maturation stage, or any combination thereof.

The phrase “a target surface” may refer to (1) a surface of a build plane (e.g., an exposed surface of a material bed), (2) an exposed surface of a platform, (3) an exposed surface of a 3D object (or a portion thereof), (4) any exposed surface adjacent to an exposed surface of the material bed, platform, or 3D object, and/or (5) any other targeted surface. Targeted may be by at least one energy beam, by a light source, or by a dispenser (e.g., having a printing head such as, for example, a dispenser of a binder).

“Pre-transformed material,” as understood herein, is a material before it has been first transformed by a transforming agent during the formation (e.g., printing) of an intermediate state of one or more 3D objects. The pre-transformed material may be a material that was, or was not, transformed prior to its use in the 3D printing process. The pre-transformed material may be a starting material for the 3D forming process. The pre-transformed material may be liquid, solid, or semi-solid (e.g., gel). The pre-transformed material may be a particulate material. The particulate material may be a powder material. The powder material may comprise solid particles of material. The particulate material may comprise vesicles (e.g., containing liquid or semi-solid material). The particulate material may comprise solid or semi-solid material particles.

The methods, systems, apparatuses, and/or software may effectuate the formation of one or more requested objects (e.g., 3D objects). In some cases, the one or more (e.g., intermediate, and/or requested) objects comprise metal (e.g., an elemental metal or a metal alloy), ceramic, an allotrope of elemental carbon, a polymer, or a resin. The pre-transformed material may comprise an organic, or an inorganic material.

The FLS of the formed (e.g., printed) 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 meter (m), 2 m, 3 m, 4 m, 5 m, 10 m, 50 m, 80 m, 100 m or 1000 m. In some cases, the FLS of the formed 3D object may be between any of the afore-mentioned FLSs (e.g., from about 50 μm to about 1000 m, from about 120 μm to about 1000 m, from about 120 μm to about 10 m, from about 200 μm to about 1 m, or from about 150 μm to about 10 m).

In some embodiments, a 3D forming (e.g., printing, or print) cycle refers to forming one or more 3D objects in a system configured for forming 3D objects, e.g., using one forming instruction batch. A 3D forming (e.g., formation) cycle may include forming one or more 3D objects above a (e.g., single) platform, in an enclosure, using one forming instruction set (e.g. one forming instruction file), and/or in a material bed. For example, a 3D printing cycle may include printing all layers of one or more 3D objects in a 3D printer. For example, a 3D printing cycle may include using a mold to form one or more 3D objects. For example, a 3D printing cycle may include forming one or more 3D objects above one platform. For example, a 3D printing cycle may include forming one or more 3D objects in a material bed. For example, a 3D printing cycle may include forming one or more 3D objects using a forming instruction file directed to a forming device. On completion of a 3D forming cycle, the one or more objects may be removed from the 3D forming system (e.g., by sealing and/or removing a build module from the system) in a removal operation (e.g., simultaneously). During a forming cycle, the one or more objects may be formed (a) in the same material bed, (b) above the same platform, (c) with the same forming system (e.g., forming device), (d) at the same time span, (e) using the same forming (e.g., printing) instructions, or (f) any combination thereof. A print cycle may comprise printing the one or more objects layer-wise (e.g., layer-by-layer). A layer may comprise a layer height. A layer height may correspond to a height of (e.g., distance between) an exposed surface of a (e.g., newly) formed layer with respect to a (e.g., top) surface of a prior-formed layer. In some embodiments, the layer height is (e.g., substantially) the same for at least two layers (e.g., each layer) of a print cycle (e.g., within a material bed). In some embodiments, at least two layers of a print cycle (e.g., within a material bed) have different layer heights. A forming cycle may comprise a collection (e.g., sum) of print operations. A print operation may comprise a print increment, e.g., formation of a layer as part of the 3D object, e.g., deposition of a layer and transformation of a portion thereof to form at least part of the 3D object. A printing cycle (also referred to herein as “build cycle”) may comprise one or more printing-laps (e.g., the process of forming a printed layer in a layerwise deposition to form the 3D object). The printing-lap may be referred to herein as “build-lap” or “print increment.” In some embodiments, a forming (e.g., printing) cycle comprises one or more printing laps. The 3D printing lap may correspond with (i) depositing a (planar) layer of pre-transformed material (e.g., as part of a material bed) above a platform, and (ii) connecting at least a portion of the pre-transformed material (e.g., by at least one transforming agent) to form a layer of a 3D objects above the platform (e.g., in the material bed). The printing cycle may comprise a plurality of laps to layerwise form the 3D object. The 3D printing cycle may correspond with (I) depositing a pre-transformed material toward a platform, and (II) connecting at least a portion of the pre-transformed material (e.g., by at least one transforming agent) at or adjacent to the platform to form one or more 3D objects above the platform at the same time-window. An additional sequential layer (or part thereof) can be added to a previous layer of a 3D object by connecting (e.g., binding) a fraction of pre-transformed material that is introduced (e.g., as a pre-transformed material stream) to the prior-formed layer. At times, the platform supports a plurality of material beds and/or a plurality of 3D objects. One or more 3D objects may be formed in a single material bed during a printing cycle (e.g., one or more print jobs). The connecting operation may comprise utilizing a transforming agent to connect the pre-transformed material. The transforming agent may comprise an electrical current, electric potential (e.g., voltage) difference, an energy beam, a particle beam, a heat, a pressure, or a binder. In some instances, the transforming agent (e.g., energy beam) is utilized to connect pre-transformed material for at least a portion of the material bed (e.g., utilizing any of the methods described herein).

In some embodiments, a 3D forming cycle refers to forming one or more 3D objects in a (e.g., injection) molding device, e.g., using one forming instruction batch (e.g., set, or file). A 3D forming cycle may include forming one or more 3D objects in a (e.g., set of) mold(s). The 3D forming cycle may correspond with (I) providing a (e.g., granular) feedstock of a pre-transformed material (e.g., a particulate material) and a first transforming agent (e.g., a binder) to a dispenser (e.g., an injector), (II) connecting at least a portion of the pre-transformed material (e.g., by at least one second transforming agent) within the dispenser, and (III) dispensing the connected (e.g., transformed) material to the (e.g., set of) mold(s) to form one or more 3D objects (e.g., by hardening the first transforming agent, e.g., by hardening the binder), in the same time-window. The connecting operation may comprise utilizing a second transforming agent (e.g., a heat source, a pressure source) to connect the pre-transformed material (e.g., with the binder). In some embodiments, the above operations of (I) and (II) are (e.g., continuously) repeated until the mold(s) is filled by the connected (e.g., transformed) material to a selected degree to form an intermediate 3D object. Upon filling of the mold(s) to the selected degree and/or cooling of the connected (e.g., transformed) material and/or the first transformed material (e.g., binder), the intermediate object may be subjected to one or more maturation stages to achieve a selected (e.g., requested) geometry and/or material properties (e.g., density).

In some embodiments, the methods, systems, software, and/or apparatuses disclosed herein comprise at least one transforming agent generator. The transforming agent generator may comprise an electrical source (e.g., circuit), an energy source, a heating member, a pressurizing member, or a dispenser. The transforming agent may comprise an electric discharge, an energy beam, a particle beam, a heat (e.g., flux), a pressure (e.g., gradient), or a binder. In some cases, the system can comprise 1, 2, 3, 4, 5, 6, 7, 8, 9, 10, 30, 100, 300, 1000 or more transforming agent generators and/or transforming agents. For example, one or more dispensers can be direct binding materials (e.g., binders) onto the target surface. The binder may comprise an organic or an inorganic material. One or more energy sources can be direct energy beam(s) onto the target surface. One or more transforming agent generators can be directed onto the target surface. The system can comprise an array of transforming agent generators. Alternatively or additionally, the target surface, material bed, 3D object (or part thereof, e.g., in its mature and/or intermediate state), or any combination thereof, may be heated by a heating member comprising a lamp (e.g., a focused lamp), heating rod, or radiator (e.g., a panel radiator). The heating member may comprise an energy beam.

Three-dimensional forming (also “3D printing”) generally refers to a process for generating a 3D object. The apparatuses, methods, controllers, and/or software described herein concerning generating (e.g., forming, or printing) a 3D object pertain also to generating a plurality of 3D objects. For example, 3D forming may include sequential addition of material layers or joining of material layers (or parts of material layers) to form a 3D structure, e.g., in a controlled manner. The controlled manner may comprise manual or automated control (e.g., using one or more controllers). In a 3D forming process, the (e.g., deposited) pre-transformed material can be connected, e.g., sintered, fused, bound, or otherwise transformed, to form at least a part of the 3D object. Sintering, fusing, binding, or otherwise connecting the pre-transformed material is collectively referred to herein as transforming a pre-transformed material (e.g., powder material), e.g., into an intermediate state material. An intermediate state object (e.g., green object and/or brown object) may comprise intermediate state material. Fusing the pre-transformed material may include melting or sintering a portion (e.g., a binder) of the pre-transformed material. Binding can comprise chemical bonding. Chemical bonding can comprise covalent bonding. Examples of 3D printing may include additive printing (e.g., layer by layer printing, or additive manufacturing). Bonding may utilize an adhesive (e.g., polymer or resin). Bonding may comprise embedding one material in another (e.g., in a matrix formed by another material). 3D printing may include layered manufacturing (e.g., layer-wise deposition). 3D printing may include rapid prototyping. 3D printing may include solid freeform fabrication. The 3D printing may include binding pre-transformed material with a binder (e.g., polymer or resin). The 3D printing may further comprise subtractive printing (e.g., sculpting, and/or machining).

In some embodiments, a green object is formed by binding particulates (e.g., powder particles) of a requested material with a binder, e.g., in relation to a requested 3D object geometry. The requested geometry may be provided as a model, e.g., a computer-aided design (CAD) model. The binder may hold (e.g., fix) the positions of particulates to (e.g., ultimately) achieve a selected geometry for the green 3D object. To fix the positions may comprise positioning the particulates in space in a (e.g., substantially) fixed manner in a way that is at least sufficient for the (e.g., eventual) formation of the requested 3D object. Following generation of the green 3D object, the binder may be (e.g., readily) removed, while the requested material remains. The binder can be a polymer or resin. A binder can be a glue. A binder can be a tacky material. Removal of the binder may be performed in a debinding step. For example, (i) the requested material may have a melting point that is distinguishably and/or controllably higher from that of the binder, and/or (ii) the requested material may be (e.g., substantially) insoluble in a solvent that dissolves the binder. The requested 3D object may be formed from a requested material. At least two particulates in the green object may be separated from each other by a gap. The gap may be filled at least in part by the binder (e.g., that holds the particulates together). For example, a volume of the particulates may occupy at least about 50%, 55%, 60%, 65%, or 70% of the volume of the green 3D object. The volume occupied by the particulates may be any value of the afore-mentioned values (e.g., from about 50% to about 70%, from about 50% to about 60%, or from about 60% to about 70% of the volume of the green 3D object). Following at least one maturation stage (e.g., densification), at least a portion of the gaps and/or pores of the intermediate object may be shrunk and/or removed. Diminishing the gaps and/or pores may have a reduction to a volume of 3D object. For example, a volume of the requested 3D object (e.g., that has been densified following at least one maturation stage) may be at least about 50%, 55%, 60%, 65% or 70% of the volume of the green 3D object. The volume of the requested 3D object may be any value of the afore-mentioned values (e.g., from about 50% to about 70%, from about 50% to about 60%, or from about 60% to about 70% of the volume of the green 3D object).

At times, the pre-transformed (e.g., requested) material and/or binder material comprises a particulate (e.g., powder) material. The pre-transformed material and/or binder material may comprise a solid material. The pre-transformed material and/or binder material may comprise one or more particles or clusters. The term “powder,” as used herein, generally refers to a solid having fine particles. The powder may also be referred to as “particulate material.” Powders may be granular materials. The powder particles may comprise micro particles. The powder particles may comprise nanoparticles. In some examples, a powder comprises particles having an average FLS of at least about 5 nanometers (nm), 10 nm, 20 nm, 40 nm, 50 nm, 100 nm, 200 nm, 300 nm, 400 nm, 500 nm, 1 μm, 5 μm, 10 μm, 15 μm, 20 μm, 30 μm, 35 μm, 40 μm, 45 μm, 50 μm, 55 μm, 60 μm, 65 μm, 70 μm, 75 μm, 80 μm, 100 μm, 500 μm, 1 millimeter (mm), 2 mm, or 3 mm. In some embodiments, the powder may have an average fundamental length scale of any of the values of the average particle fundamental length scale listed above (e.g., from about 5 nm to about 3 mm, from about 1 μm to about 500 μm, from about 15 μm to about 45 μm, from about 5 μm to about 80 μm, from about 5 nm to about 500 μm, or from about 500 μm to about 3 mm). A powder (e.g., in a material bed or a container) may be flowable (e.g., retain its flowability), during (i) formation of a 3D object, and/or (ii) a maturation stage.

At times, the powder is composed of individual particles. The individual particles can be ellipsoid (e.g., spherical), oval, prismatic, cubic, elongated, closed amorphous (e.g., potato), or irregularly shaped. The particles can have a FLS. The powder can be composed of a homogenously shaped particle mixture such that all of the particles have (e.g., substantially) the same shape and/or fundamental length scale magnitude within at most about 1%, 5%, 8%, 10%, 15%, 20%, 25%, 30%, 35%, 40%, 50%, 60%, or 70%, distribution of FLS. In some embodiments, the powder may have a distribution of FLS of any of the values of the average particle FLS listed above (e.g., from at most about 1% to about 70%, about 1% to about 35%, or about 35% to about 70%). In some embodiments, the powder can be a heterogeneous mixture such that the particles have variable shape and/or fundamental length scale magnitudes.

In some embodiments, the formation of an intermediate state object (e.g., a green object and/or a brown object) is accomplished by at least one formation process. For example, a formation process may comprise (I) a 3D forming process, or (II) a molding process, e.g., such as injection molding. Injection molding may comprise ceramic injection molding (CIM) or metal injection molding (MIM).

In some embodiments, injection molding comprises preparation of a feedstock. The feedstock may comprises a mixture of granules of a requested material and at least one binder. In ceramic injection molding (CIM) the requested material comprises a ceramic, and in metal injection molding (MIM) the requested material comprises an elemental metal or a metal alloy. The requested material may comprise a polymer or resin that is different from that of the binder. The feedstock (e.g., mixture) may be subjected to conditions (e.g., temperatures and/or pressures) that cause the granules to fuse. The fused granules may be provided to a mold having a geometry of a requested 3D object, e.g., to form an intermediate state (e.g., green) object. A maturation process is performed on the green object, to form the requested 3D object.

3D printing methodologies can comprise powder feed or wire deposition. 3D printing methodologies may comprise forming a green-body. 3D printing methodologies may comprise a binder that binds pre-transformed material (e.g., binding a requested material). The binder may remain in the 3D object, or may be (e.g., substantially) released from the 3D printing (e.g., by heating, extracting, evaporating, dissolving, and/or burning).

3D printing methodologies can comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise Laser Metal Deposition (LMD, also known as Laser Deposition Welding) or Laser Engineered Net Shaping (LENS).

3D forming processes (e.g., methodologies) may differ from methods traditionally used in semiconductor device fabrication, e.g., vapor deposition, etching, annealing, masking, or molecular beam epitaxy. For example, 3D forming methodologies can differ from vapor deposition methods such as chemical vapor deposition, physical vapor deposition, or electrochemical deposition. In some instances, the forming process (e.g., 3D printing) may comprise one or more (printing) methodologies that are traditionally used in semiconductor device fabrication. In some instances, the forming process (e.g., 3D printing) may include vapor deposition methods.

A 3D forming process may comprise (a) binder jetting, (b) fused deposition modeling, (c) stereolithographic imaging, or (d) direct metal laser sintering. There are various ways in which a 3D forming processes, e.g., that utilizes a binder to form a green 3D object, may provide (e.g., dispense) the binder. The binder may fix positions of the requested material (e.g., particulates or molecules) according to a selected pattern (e.g., geometry). The binder may comprise an initial state (e.g., a liquid or a gel), and a second (e.g., hardened) state (e.g., a gel or a solid). The binder may be transitioned from the first state to the second state by a change in pressure, temperature, and/or a chemical environment (e.g., acidity or basicity). The binder may fix the requested material upon its transformation to the second state. In some embodiments, the binder fixes the requested material (e.g., substantially) upon contact with the requested material. Fixing the requested material may comprise (i) fixing a particulate material relative to another particulate material, or (ii) fixing one particulate material relative to a position in space. The binder may fix the requested material by application of a transforming agent (e.g., that transforms the binder). The transforming agent that transforms the binder may comprise heat, pressure, accelerated particles, or (e.g., electromagnetic) radiation. In some embodiments, the binder is maintained (e.g., stored) separately from the requested material. Storing the binder separately may be prior to (i) a transition of the binder to the second state, and/or (ii) fixing the pre-transformed material (e.g., particulate material) by the binder. In some embodiments, the binder (e.g., that is maintained separately) is activated upon contact with the requested material. In some embodiments, the binder and the requested material are maintained together (e.g., in a mixture). The binder may be activated (e.g., in selected locations) by a transforming agent generator. In some embodiments, the binder is dispensed by a dispenser. The binder may comprise macro-scale molecules, micro-scale molecules, or nano-scale molecules. The requested material may be in a pre-transformed form (e.g., in a powder form). In some embodiments, the binder is dispensed toward a requested material. The dispenser may dispense the requested material. In some embodiments, a dispenser is configured to dispense both the binder and the requested material, e.g., separately or simultaneously. A dispenser may be configured to dispense the binder and the requested material in parallel, and/or in an alternating fashion (e.g., in series). The dispenser may comprise a print head. The dispenser may comprise an injector. The dispenser may dispense the binder by jetting (e.g., droplets or granules), or by extruding (e.g., granules). The binder (e.g., and/or requested material) may be dispensed in (e.g., according to) a path and/or a selected geometry. The binder and requested material may be dispensed into a mold, e.g., that is of the requested 3D geometry. The path and/or selected geometry of dispensed binder may transform selected portions of the requested material to form a portion of a 3D object, e.g., according to a requested geometry. In some embodiments, a binder is provided in a complex (e.g., a mixture) with a requested material. The complex of the binder and requested material may be provided in a container (e.g., a vat, or a material bed). Selected portions of the complex of the binder and the requested material (e.g., in the container) may be transformed to form a portion of a 3D object, e.g., according to a requested geometry.

In some embodiments, a 3D forming processes forms an intermediate object without use of a binder. For example, a 3D forming process may (e.g., directly) form a brown 3D object. The brown 3D object may comprise an imperfect object. Imperfect may be with respect to at least one material property or a geometry of a requested 3D object. A brown 3D object may comprise dislocations and/or pore(s). In some embodiments, a transforming agent generator (e.g., imperfectly, or loosely) binds pre-transformed material (e.g., powder particles, or granules) of a requested material type to form the brown 3D object. The pre-transformed material may be provided in a container. A transforming agent (e.g., energy beam) may be directed toward the pre-transformed material, for transforming selected portions of the pre-transformed material, e.g., according to a requested geometry. In some embodiment, the pre-transformed material and a transforming agent are directed toward a (e.g., target) surface in (e.g., according to) a path and/or a selected geometry. The pre-transformed material may be bound (e.g., to have fixed positions) by the transforming agent generator through the application of heat, pressure, accelerated particles, and/or (e.g., electromagnetic) radiation. A brown 3D object may be subjected to at least one maturation stage (e.g., densified), to achieve the at least one material property or the geometry of the requested 3D object (e.g., removal of a dislocation, densification of a pore).

In some embodiments, one or more maturation stages comprise transformation of one or more material properties of an intermediate 3D object. In some embodiments, an intermediate 3D object is subjected to one maturation stage. In some embodiments, an intermediate 3D object is subjected to at least two maturations stages. In some embodiments, at least two maturation stages are performed in situ and/or simultaneously. For example, a (e.g., first) maturation stage may comprise removal of at least a portion of a binder material from an intermediate 3D object that comprises a binder (e.g., a green 3D object). For example, a maturation stage may reduce (e.g., eliminate) dislocations, pores and/or gaps in the requested 3D object, e.g., to achieve a requested material property such as porosity (e.g., within an accepted tolerance). In some embodiments, removal of a binder material leads to formation of one or more dislocations, gaps and/or pores within an intermediate 3D object. A binder removal operation may be performed considering the proportion of binder present in the intermediate 3D object. In some embodiments, the (e.g., binder removal) maturation stage is optional, depending on the occurrence and/or proportion of binder in the total volume of the intermediate 3D object. For example, a binder removal operation may be performed for an intermediate 3D object that comprises binder material that occupies at least about 1%, 5%, 10%, 20%, 30%, 40%, or 50% of the volume of the (e.g., green) intermediate 3D object. The volume occupied by the binder material may be any value of the afore-mentioned values (e.g., from about 1% to about 50%, from about 1% to about 10%, or from about 10% to about 50% of the volume of the green 3D object). Removal of binder material may occur in one or more operations. For example, in a (e.g., first) operation the maturation stage may comprise placing the green 3D object into a solution, e.g., for removal of at least a portion of a binder material. The selection of a solution may be such that the binding material(s) become soluble, and the requested material remains (e.g., substantially) insoluble. In some embodiments, removal comprises chemically dissolving the binder. For example, in a (e.g., second) operation the maturation stage may comprise subjecting the green 3D object to conditions (e.g., temperatures, pH, and/or pressures) that transform (e.g., melt, evaporate, or dissolve) the binder. A transformation of the binder may comprise (e.g., chemical and/or thermal) decomposition. For example, heating the green 3D object to a temperature and pressure that are above the evaporation point of the binder. For example, incinerating (e.g., burning) the binder. For example, transforming the binder material into a flowable (e.g., liquid) state. In some embodiments, the (e.g., at least two) operations are performed sequentially (e.g., serially). In some embodiments, the (e.g., at least two) operations are performed (e.g., substantially) simultaneously.

In some embodiments, a (e.g., second) maturation stage comprises connecting particulates (e.g., of requested material) to each other to form a brown 3D object. A brown object may be an object in which particulates of requested material are (e.g., directly) connected. For example, the connection(s) of the requested material may be (e.g., substantially) devoid of any binder material. In some embodiments, a (e.g., second) maturation stage comprises subjecting a green 3D object to conditions in which particles of requested material are able to connect, e.g., with each other. For example, conditions for forming a brown 3D object may comprise heating the green 3D object to a temperature and/or pressure sufficient to promote sintering and/or at least partial melting of the particles of the requested material. For example, conditions for forming a brown 3D object may comprise increasing a pressure and/or temperature to which the green 3D object is subjected, to promote sintering and/or at least partial melting of the requested material. At times, the intermediate object is a brown 3D object in which the particulates connect to each other (e.g., a lightly sintered 3D object).

In some embodiments, a (e.g., third) maturation stage comprises densification of an intermediate 3D object, e.g., a brown 3D object. The conditions for densification may promote reduction (e.g., removal) of gaps between the connected particulates, e.g., of the requested material. In some embodiments, the (e.g., third) maturation stage may include densification of an object comprising the connected particulates (also referred to herein as “pre-densified 3D object”), e.g., in conditions that allow removal of gaps between the connected particulates, to form the requested 3D object according to a prescribed density. In some embodiments, the densification stage may comprise elevating temperature and/or pressure. In some embodiments, the maturation stage may comprise providing the intermediate 3D object to a heating device, e.g., an oven or furnace. The heating device may comprise feedback regarding a detected (e.g., achieved) temperature and/or pressure of the intermediate 3D object. The heating device may comprise one or more sensors that sense, e.g., the temperature and/or pressure. In some embodiments, the elevated temperature and/or pressure is sufficient to at least partially sinter or at least partially (e.g., to fully) melt the requested material. In some embodiments, the elevated temperature and/or pressure is sufficient to place at least a portion of the requested material in a liquid state. In some embodiments, the densified material has a gaseous residue (e.g., disposed in one or more remaining pores). For example, the (e.g., fully) densified 3D object has a volume of gas that is at most about 5%, 4%, 3%, 2%, 1%, or 0.1% of the total volume of the densified 3D object. The densified 3D object may have a gas volume that is between any value of the afore-mentioned values (e.g., from about 5% to about 0.1%, from about 5% to about 3%, or from about 3% to about 0.1%, of the total volume of the densified 3D object).

The conditions of a maturation stage may cause the intermediate 3D object to undergo a volumetric reduction, e.g., to change in size according to a reduction factor. The volumetric reduction may occur as gaps and/or pores are diminished (e.g., removed) from the intermediate 3D object. In some embodiments, volumetric reduction occurs in one or more maturation stages. The reduction factor may be a value, or a function. The volume reduction function may be volume as a function of time. For example, a reduction factor function may comprise a linear, polynomial, exponential, or logarithmic, function. In some embodiments, the densified 3D object may have a volume (e.g., final volume, “FV”) that is about 60%, 70%, 80%, or 90% of the volume of the intermediate 3D object (e.g., green 3D object and/or brown 3D object). The densified 3D object may have a volume that is between any value of the afore-mentioned values (e.g., from about 60% to about 90%, from about 60% to about 80%, or from about 80% to about 90%, of the volume of the intermediate 3D object). The final volume of the (e.g., densified) 3D object may be given according to a relationship between (i) a volume (e.g., initial volume, “IV”) of an intermediate 3D object, and (ii) the reduction factor. In some embodiments, the final volume of the densified 3D object is given according to the relationship: FV=(IV/reduction factor), where “/” is the mathematical division operation. In some embodiments, a reduction factor may be at least about 1.05, 1.2, 1.5, 1.8, or 2. The reduction factor may be any value between the aforementioned values (e.g., from about 1.05 to about 2, from about 1.05 to about 1.5, or from about 1.5 to about 2). The volumetric reduction may occur in one maturation stage or in a plurality of maturation stages. A first volumetric reduction occurring in first maturation stage may be different than a second volumetric reduction occurring in a second maturation stage. A first volumetric reduction occurring in first maturation stage may be (e.g., substantially) the same as a second volumetric reduction in a second maturation stage. The volumetric reduction may be of the intermediate three-dimensional object(s), the filler, and/or the container. The container may comprise a closure (e.g., shutter or lid).

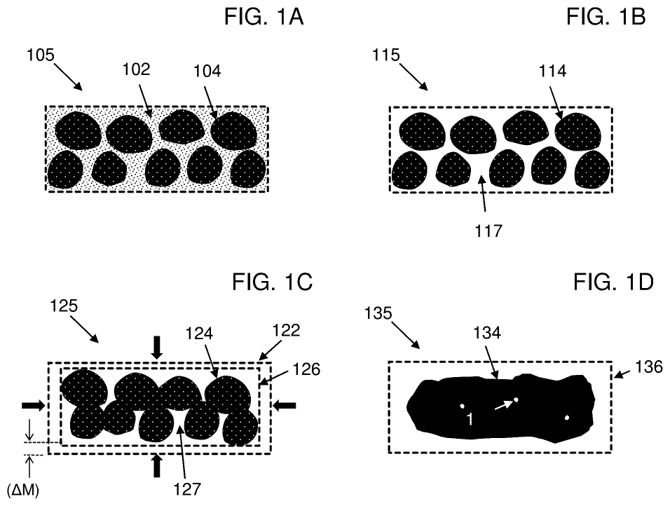

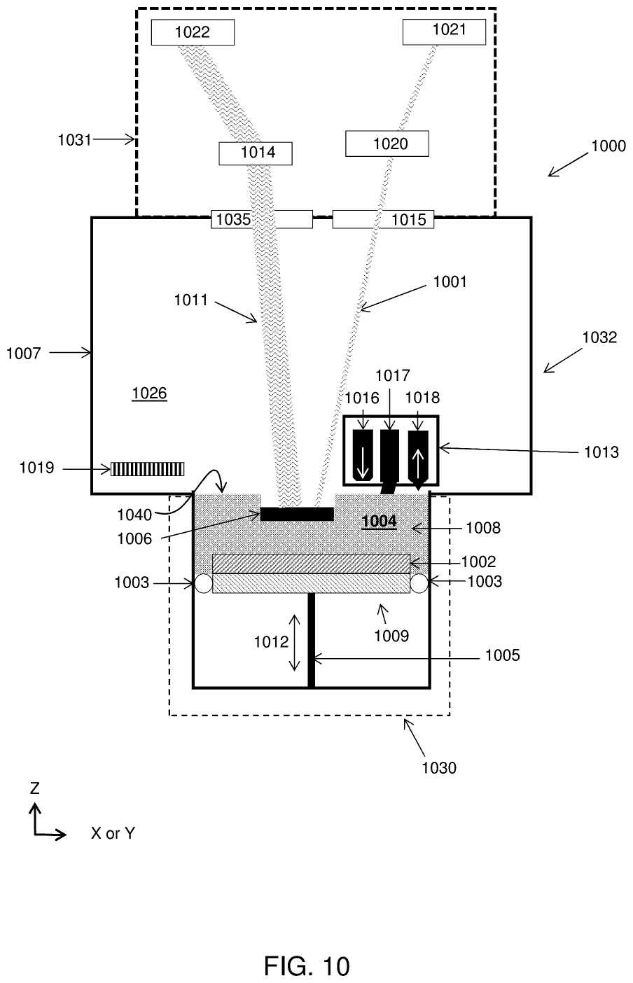

FIGS. 1A-1D depict examples of various maturation stages. In the example of FIG. 1A, a portion of green object 105 comprises particles of (e.g., a requested) material 104 that are connected (e.g., bound) together by a binder material 102. FIG. 1B depicts an example of a portion of an intermediate object 115 following a (e.g., first) maturation stage. In the example of FIG. 1B, the binder material was (e.g., substantially) removed and/or absent, the particles of (e.g., requested) material 114 are present, and are separated at least one gap such as 117. In the example of FIG. 10, a portion of an intermediate (e.g., brown) object 125 is depicted following a (e.g., second) maturation stage. In the example of FIG. 10, the particles of requested material 124 are (e.g., loosely) connected, and are separated by at least one (e.g., volume reduced) gap such as 127. The example of FIG. 10 depicts a reduction in size (e.g., by a reduction factor, ΔM) from a first size 122 to a second size 126, e.g., reduction of size is depicted by bold arrows in the example shown in FIG. 10. In some embodiments, a reduction in size corresponds to a reduction in a volume or in an area of an intermediate 3D object. In the example of FIG. 1D, a portion of a densified (e.g., requested) 3D object 135 is depicted following a (e.g., third) maturation stage. In the example of FIG. 1D the requested material 134 shows a denser portion of the requested material as compared to that of 125, 115, or 105, e.g., it is (e.g., substantially) devoid of pores. In some embodiments, a densified 3D object comprises (e.g., retains) gaps and/or pores (e.g., FIG. 1D, 138). The gaps and/or pores may be reduced in size, as compared to a size of the gaps and/or pores in the intermediate 3D object. The example of FIG. 1D depicts a (e.g., further) reduction in size of the densified 3D object 134, as compared to a size 136 of the portion of the intermediate 3D object such as the green 3D object depicted in FIG. 1A.

At times, a volumetric reduction is accompanied by a deformation in an intermediate 3D object. Without wishing to be bound to theory, the deformation may occur, e.g., due to shrinkage, gravity, and/or thermal gradients formed within the object. At times, a thermal gradient may develop within an intermediate 3D object during one or more maturation stages. For example, a thermal gradient may develop from an outer portion of the intermediate 3D object to an inner portion of the intermediate 3D object. For example, a thermal gradient may develop from an inner portion of the intermediate 3D object to an outer portion of the intermediate 3D object. The deformation may occur due to a reduction in a number and/or size of gaps (e.g., pores) within the 3D object. In some embodiments, the deformation may occur during and/or following formation of at least a portion of the (e.g., intermediate) 3D object. In some embodiments, the deformation may occur during and/or following at least one maturation stage. In some embodiments, support provided to the intermediate 3D object may reduce the deformation. The support may be connected or not connected (e.g., anchored) to the intermediate 3D object. The non-connected (e.g., non-anchored) support may reduce (e.g., prevent) deformation upon densification of the intermediate 3D object. In some embodiments, the non-connected support may be unattached (e.g., unbound) to the intermediate 3D object, e.g., for at least a portion of a maturation stage. For example, the support may be non-connected to the 3D object during the entire maturation stage(s). The non-connected support may be provided by a material and/or structure that does not form a part of the requested 3D object. The non-connected support may be (e.g., readily) separated from the requested 3D object, e.g., upon and/or following at least one maturation stage. Readily separated may comprise separation by flowing, blowing, and/or suction. Readily separated may comprise separation without (e.g., substantial) damage (e.g., introduction of defect) to the (e.g., densified and/or requested) 3D object. The non-connected support may comprise a supporting substance. In some embodiments, the supporting substance comprises a particulate material. In some embodiments, the supporting substance comprises a filler. In some embodiments, the intermediate 3D object and the filler are provided to (e.g., rest within) a container. The container may be (e.g., reversibly) sealable. The intermediate 3D object may be supported by the filler, e.g., while the 3D object is disposed in the container (e.g., enclosure). Under conditions of at least one maturation stage, the container (e.g., enclosure), filler, and intermediate 3D object, may undergo a similar (e.g., same) volumetric reduction (e.g., simultaneously). The contracted container (e.g., that may be sealed) may compress the filler. The container may comprise an opening that is closable (e.g., sealable), for example, by a shutter. The shutter may prevent the filler to pour through the enclosure during at least one maturation stage. The opening may facilitate ingress and egress of the filler, the intermediate 3D object, and/or the densified 3D object. The (e.g., non-connected support) filler may remain flowable before, after, and/or during the at least one maturation stage. In some embodiments, a first filler material is used for a first maturation stage, a second filler material is used for a second maturation stage, and a third filler material is used for a third maturation stage. In some embodiments, at least two of the first filler material, the second filler material, and the third filler material, are the same. In some embodiments, at least two of the first filler material, the second filler material, and the third filler material, are different. The filler material may remain in contact with surfaces of the intermediate 3D object (e.g., for support to prevent deformation) during at least one maturation stage, e.g., as the intermediate 3D object densifies (e.g., contracts).

In some embodiments, the non-connected support may promote a reduction in deformation (e.g., deformation due to droop or sagging) of green and/or porous 3D objects during maturation (e.g., sintering). In some embodiments, the non-connected support may be without reliance on rigid auxiliary supports that could be used for reduction of the deformation. In some embodiments, the non-connected support comprises placing the porous and/or green 3D object in a sealed (e.g., green and/or porous) container that comprises the same material as the requested 3D object. In some embodiments, the non-connected support comprises filing the (e.g., rest of the) space in the container that is not taken by the 3D object with small disconnected green and/or porous (e.g. loose) objects comprises the same material as the requested 3D object. In some embodiments, the loose (e.g., flowable and/or disconnected) objects fill the space in the container. In some embodiments, the loose (e.g., flowable and/or disconnected) objects fill the space in the macroscopic cavities within the 3D object that they are sized to fill. In some embodiments, the space is tightly filled with these loose objects (e.g., filler). In some embodiments, the container is sealed during at least one maturation stage such that under the forces of shrinkage, the loose objects will not exit (e.g., get out of) the container. In some embodiments, the container is not gas tight (e.g., sealed to gas). In some embodiments, the container is gas tight (e.g., sealed to gas). In some embodiments, the loose objects are coated with a coating material that is not undergoing densification during at least one maturation stage (e.g., the sintering). In some embodiments, the loose objects remain loose and/or disconnected after the at least one maturation stage. In some embodiments, during the at least one maturation stage, the container, the 3D object, and the loose object all shrink (e.g., simultaneously). In some embodiments, as the 3D object, loose objects, and container shrink, the loose objects that were fit to fill (e.g., all) the space within the container (e.g., all), maintain their proportions and relative positions, and deformation of the 3D object is reduced (e.g., mitigated). In some embodiments, at the end of the sintering (e.g., maturation process), the loose objects are removed (e.g., shaken loose, blown off, sucked away) from the container and/or the 3D object.

In some embodiments, forming a densified three-dimension object comprises (i) disposing a porous three-dimensional object and a flowable filler in an enclosure, (ii) densifying (a) the porous three-dimensional object to form the densified three-dimensional object that has a density greater than the porous three-dimensional object, (b) the flowable filler such that the flowable filler remains flowable upon the densification; and (iii) separating the densified three-dimensional object from the flowable filler that has been densified in (ii).

In some embodiments, the filler comprises a particulate material. In some embodiments, the particulate material comprises a core and a shell. In some embodiments, the core is porous (e.g., a porous core). In some embodiments, the porous core is formed of metal. In some embodiments, a transforming temperature of a material comprises a temperature at which the material is densified (e.g., by melting or sintering). In some embodiments, a transforming temperature of the shell is higher than a transforming temperature of the (e.g., porous) core. In some embodiments, the particulate material (e.g., of the filler) is transformed by heating. In some embodiments, particulate material that has been transformed by heating remains flowable, e.g., upon and/or after transformation by the heating. In some embodiments, the particulate material may be densified by at least about 5%, 10%, 15%, 25%, 35%, 45%, or 50% upon heating. The particulate material may be densified by any value between the afore-mentioned values (e.g., from about 5% to about 50%, from about 5% to about 25%, or from about 25% to about 50%). In some embodiments, the particulate material that is densified remains flowable, e.g., during, upon and/or after densification.

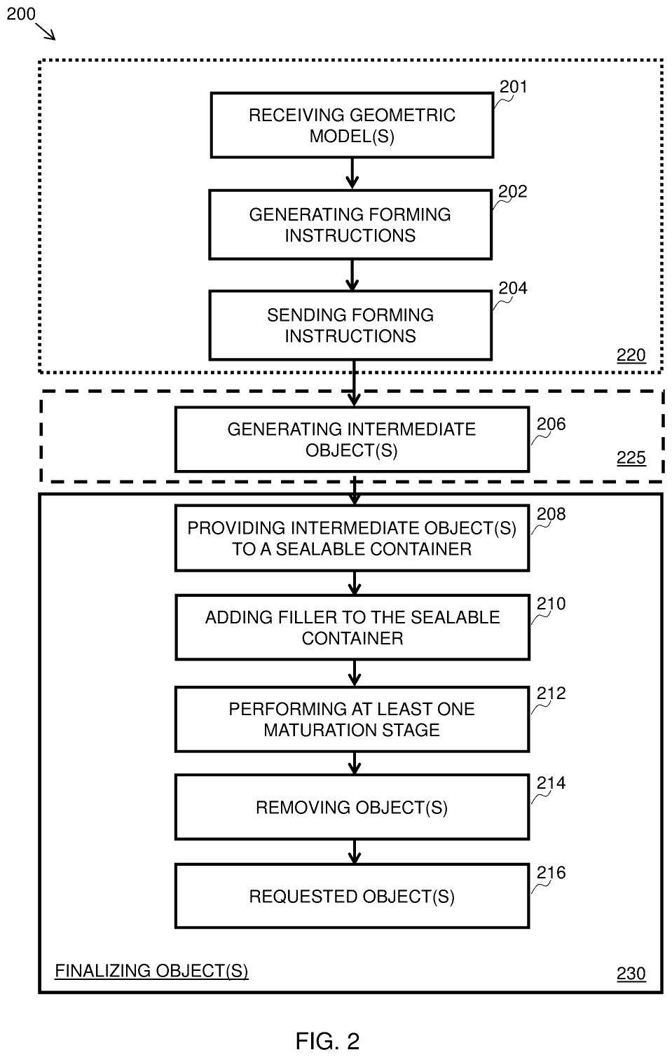

FIG. 2 depicts an example flowchart 200 for providing non-connected support (e.g., filler) to an intermediate 3D object (e.g., green 3D object or brown 3D object). The example FIG. 2 comprises: a (e.g., optional) first phase (e.g., 220) for generation of object forming instructions to form at least one requested 3D object; a (e.g., optional) second phase (e.g., 225) for generating (e.g., forming) at least one intermediate 3D object (e.g., 206), e.g., corresponding to the at least one requested 3D object; and a third phase (e.g., 230) for converting the at least one intermediate object to the respective at least one requested 3D object. In the example of FIG. 2, the first phase comprises: receiving at least one geometric model (e.g., 201); generating forming instructions (e.g., 202); and sending the forming instructions (e.g., 204), e.g., to a manufacturing device that is suitable to form the at least one requested and/or intermediate 3D object. A suitable manufacturing device may form the intermediate and/or requested 3D object(s) according to any of the forming methodologies described herein. In the example of FIG. 2, the third phase comprises: placing the at least one intermediate object in a sealable container (e.g., 208); adding filler to the sealable container (e.g., 210); performing at least one maturation stage (e.g., 212); removing the at least one (e.g., densified) 3D object (e.g., 214); and providing the final (e.g., requested) at least one 3D object (e.g., 216). In some embodiments, a manufacturing device that is suitable for forming the requested 3D object(s) performs at least two of the phases (e.g., 220, 225, and/or 230). In some embodiments, at least two (e.g., manufacturing) devices perform at least two of the phases (e.g., 220, 225, and/or 230), e.g., respectively.

In some embodiments, the filler is flowable, compressible, contractible, and/or shrinkable. For example, the filler may comprise a material that is flowable prior to initiation of, and upon completion of, at least one maturation stage. For example, the filler may comprise a material that remains flowable under conditions of at least one maturation stage. For example, the filler may withstand being connected to itself and/or to the intermediate 3D object during, upon completion, and/or after completion of a maturation stage. A filler may have at least one characteristic comprising: (i) at least a partial surface that facilitates flowability of the filler during, upon completion and/or after completion of the maturation stage(s); (ii) a shrinkage property(ies) similar to that of the intermediate 3D object, e.g., for at least one maturation stage; or (iii) sufficient stiffness to support the intermediate 3D object during at least one maturation stage. Sufficient stiffness may be afforded by at least a portion of the filler being semi-compressible, e.g., under conditions of the at least one maturation stage. Sufficient stiffness may comprise retaining (e.g., on average) a ratio between a volume and a FLS of particle(s) that constitute the filler. Retaining the ratio may be upon compression, contraction and/or shrinkage of the particle(s). Retaining the ratio may be in comparison with the (e.g., average) volume and FLS of the particle(s) prior to the shrinkage, contraction and/or compression. In some embodiments, the filler comprises a particulate material. For example, the particulate material may have an interior that comprises the requested material, the surface (e.g., material), or another material. The surface of the filler may comprise a material that promotes a flowable state during, upon, and/or after the maturation stage(s). The surface of the filler may comprise a material that deters agglomeration, aggregation, attachment, and/or connection of particles to each other during, upon and/or after the maturation stage(s). The surface (e.g., of the filler) may be (I) of the same material type (e.g., chemical makeup) as at least a portion of the filler interior, (II) a chemically treated surface (e.g., oxidized surface, and/or passivated surface), and/or (III) of a different material type than at least a portion of the filler interior (e.g., a coating over the interior). In some embodiments, the surface material (also referred to herein as the “separating material”) possesses a melting point (e.g., and/or evaporation point) that is higher than that of the requested material (e.g., the material of the requested 3D object). In some embodiments, the filler (e.g., separating) material comprises (a) a metal, (b) a ceramic, (c) an oxide, or (d) a zeolite. A metal may comprise an elemental metal or a metallic alloy. A ceramic may comprise alumina, zirconia, boron nitride, silicon nitride, silicon carbide, tungsten carbide, or magnesia. An oxide may comprise titanium oxide, copper oxide, iron oxide, silver oxide, nickel oxide, aluminum oxide, aluminum titanate, zirconium oxide, or spinel. A zeolite may comprise an aluminosilicate mineral, analcime, chabazite, clinoptilolite, heulandite, natrolite, phillipsite, or stilbite. For example, the requested material may comprise ice and the separating material may comprise metal. For example, the requested material may comprise metal and the separating material may comprise ceramic. For example, the requested material may comprise plastic (e.g., non-tactile) and the separating material may comprise metal.

In some embodiments, at least two physical properties of a requested material, a filler material, and a (e.g., sealable) container, are the same. The physical properties may comprise a (e.g., solid) density, a packing density, a melting point, or a surface energy (e.g., of the material). The physical properties (e.g., at a given temperature) may comprise Young's modulus, Poisson's ratio, coefficient of thermal expansion, thermal conductivity, or yield stress. In some embodiments, at least two physical properties of the requested material, the filler material, and the (e.g., sealable) container, are different.

In some embodiments, providing a (e.g., closable or sealable) container to accommodate at least one intermediate 3D object for at least one maturation stage, comprises at least partially filling the closable (e.g., sealable) container with filler. The container may be configured to accommodate a volume. The container may comprise one or more walls that enclose the volume. The volume may accommodate an environment. The container may comprise an opening. The opening may be closable and/or sealable. The container may comprise a closure (e.g. lid, or door) to close opening of the container (e.g., reversibly). The container and the closure may comprise the same material. The container and the closure may comprise a different material. The closure may close to container in a gas tight or non-gas tight manner. The closure may deter the at least one intermediate 3D object, the densified 3D object, and/or the filler to come through during the maturation stage(s). The filler may at least partially accommodate the internal volume of the container that is not accommodated by the at least one intermediate 3D object. The filler may be arranged in a close-packed arrangement between one or more internal walls of the container and at least one external surface of the at least one 3D object disposed in the container. In some embodiments, a container is configured (e.g., sized) to accommodate one intermediate object. In some embodiments, a container is configured (e.g., sized) to accommodate a plurality of intermediate objects (e.g., simultaneously). The container may be configured to accommodate an intermediate object that is formed with, or without, support (e.g., structures). For example, an intermediate object that is formed with, or without, sacrificial support (e.g., structures) such as auxiliary support structures.

In some embodiments, at least a portion of a (e.g., intermediate) 3D object may be supported (e.g., during its formation) by one or more auxiliary features. At least a portion of a (e.g., intermediate) 3D object may be connected (e.g., during its formation) to one or more auxiliary features. The auxiliary feature may or may not be anchored to a platform above which the 3D object is formed. The auxiliary feature may or may not be anchored to a container in which the 3D object is formed. The auxiliary feature(s) can be supported by (i) a material (e.g., powder) bed, and/or (ii) a platform, that supports the 3D object during formation. The term “auxiliary feature” or “auxiliary support” as used herein, generally refers to a feature that is part of a formed 3D object, but is not part of the desired, intended, designed, ordered, or requested. Auxiliary feature(s) (e.g., auxiliary support(s)) may provide structural support during and/or subsequent to the formation of the 3D object. The 3D object may have any number of support(s). The supports may have any shape and size. In some examples, the supports comprise a rod, plate, wing, tube, shaft, or pillar. In some cases, the support(s) support certain portions of the 3D object and does not support other portions of the 3D object. In some cases, the support(s) are (e.g., directly) coupled to a bottom surface the 3D object (e.g., relative to a platform). In some embodiments, the supports are anchored to the platform. In some embodiments, the platform is an auxiliary support (e.g., when the formed 3D object is directly anchored to the platform). In some examples, the support(s) are used to support portions of the 3D object having a certain (e.g., complex or simple) geometry. Auxiliary feature(s) may enable the removal of energy from the 3D object that is being formed. Auxiliary feature(s) may enable reduction in deformation of the 3D object during, upon, and/or after its formation, e.g., as compared to a respective 3D object formed without the auxiliary support(s).

In some embodiments, the container comprises a (e.g., reversibly) openable portion that facilitates ingress of the filler and/or of the intermediate object(s). In some embodiments, openable comprises hingedly, slidably, rollably, or rotably opened. In some embodiments, openable comprises removable. The openable portion of the container may comprise at least one wall, floor (e.g., bottom), or lid (e.g., top). Top and bottom may be with respect to a global vector. The openable portion may be coupled with (e.g., a remainder of) the container. In some embodiments, a coupling of the openable portion comprises a hinge, a bearing, a closure, a bracket, a buckle, a clasp, or a fastener. In some embodiments, the openable portion is configured to close sufficiently such that the filler (e.g., particles) does not escape container, e.g., during the maturation stage(s). For example, such that the filler does not escape at least during a maturation (e.g., densification) operation. In some embodiments, the openable portion is configured to allow environmental (e.g., gaseous and/or fluid) exchange. Environmental exchange may be with respect to an environment that is external to an interior (e.g., environment) of the container. In some embodiments, the container comprises pores, holes, slots, or gaps, that facilitate the environmental exchange. For example, the container may comprise open pores or channels. In some embodiments, the container comprises pores, holes, slots, or gaps, that do not facilitate the environmental exchange. For example, the container may have internal closed pores or channels. In some embodiments, environmental exchange may constrain (e.g., prevent) exit of the filler (e.g., particulate) material. For example, the filler may be constrained (e.g., prevented) from unintentional removal from an interior of the container, e.g., during at least one maturation stage. The container may retain (e.g., prevent removal of) particulate material having a fundamental length scale (FLS) that is of at least a retention size. A retention size may correspond to a FLS of a filler material and/or a pre-transformed (e.g., requested) material. In some embodiments, a retention size of the (e.g., sealable) container is at least about 5 microns (μm), 10 μm, 50 μm, 100 μm, 500 μm, 1 millimeter (mm), or 3 mm. The retention size of the container may be any value between the afore-mentioned values (e.g., from about 5 μm to about 3 mm, from about 5 μm to about 100 μm, or from about 100 μm to about 3 mm).

In some embodiments, a maturation stage comprises subjecting an intermediate object to conditions of increased temperature and/or pressure. The maturation stage may comprise hot isostatic pressing (“HIP”), isothermal forging, hot pressing, partial melting (e.g., of a particulate material), complete melting (e.g., of the particulate material), or sintering. Increased may be with respect to (I) an ambient temperature and/or an ambient (e.g., atmospheric) pressure, (II) a temperature and/or a pressure at which the (e.g., intermediate) object was formed, and/or (III) a temperature and/or a pressure of a (e.g., prior) maturation stage. Ambient condition may refer to a condition external to the container. The maturation stage may proceed according to maturing instruction(s), e.g., for a given maturation device. The maturing instruction(s), when executed, may cause a (e.g., suitable) maturation device to perform one or more (e.g., a series of) operations. The operation(s) may cause maturation of the at least one intermediate 3D object. The maturation stage (e.g., in which the maturing instruction(s) are executed) may comprise a variation in a temperature and/or pressure, e.g., during the (e.g., given) maturation stage. The variation may occur according to a profile (e.g., a maturation profile). A profile may comprise a target setting. A profile may comprise a series (e.g., sequence) of target setpoints, e.g., of the temperature and/or pressure. The profile (e.g., the target setting) may comprise a value, a function, or an equation. The profile may be linear, polynomial, exponential, and/or logarithmic. In some embodiments, a temperature of a maturation stage may be at least about 400 Celsius (° C.), 600° C., 800° C., 1000° C., 1200° C., or 1500° C. The temperature of a maturation stage may be any value between the afore-mentioned values (e.g., from about 400° C. to about 1500° C., from about 400° C. to about 1000° C., or from about 1000° C. to about 1500° C.). In some embodiments, a pressure of a maturation stage may be at least about 40 mega-Pascals (MPa), 80 MPa, 150 MPa, 250 MPa, or 350 MPa. The pressure of a maturation stage may be any value between the afore-mentioned values (e.g., from about 40 MPa to about 350 MPa, about 40 MPa to about 150 MPa, or from about 150 MPa to about 350 MPa). At the sealed container, the intermediate 3D object, and/or the filler, may undergo densification under the conditions of the maturation stage. For example, the complex of the sealed container, the intermediate 3D object, and the filler may undergo densification under the conditions of the maturation stage. In some embodiments, at least two of the container, the filler, and the intermediate 3D object have a similar (e.g., same) volume reduction factor, e.g., during the maturation stage.

In some embodiments, at least one intermediate object undergoes at least one maturation stage within (e.g., by) a maturation system (e.g., device). The maturation system may comprise an enclosure, a chamber, a container, an opening, a closure, a valve, a sensor, or a platform. The maturation system may comprise one or more apparatuses, e.g., a pump, a heat source, or a gas source. The maturation system may comprise one or more controllers, e.g., coupled with one or more apparatuses and/or components of the maturation system. The one or more controllers may be configured to control, individually and/or collectively, the one or more apparatuses. The same controller may control at least two apparatuses and/or components of the maturation system. A controller may control an apparatus and/or a component of the maturation system. Control may be according to one or more maturing instructions. For example, the one or more controllers may control (A) the heat source (e.g., to effectuate a temperature profile), and/or (B) the pump (e.g., to effectuate a pressure profile), of the maturation system. The controlled temperature and/or pressure may be within the chamber (e.g., container) of the maturation system. For example, the one or more controllers may control the gas source, e.g., to effectuate a selected environment (e.g., atmosphere) within the chamber. In some embodiments, an atmosphere of the (e.g., chamber of the) maturation system comprises an inert gas. In some embodiments, an atmosphere of the (e.g., chamber of the) maturation system comprises a non-inert gas. In some embodiments, an atmosphere of the maturation system comprises a gas that has at least one reactive species in a concentration lower than their concentration in the ambient environment. The reactive species may comprise oxygen or water. Inert may be with respect to a material of (a) the maturation system, (b) the sealable container, (c) the requested 3D object, (d) the intermediate 3D object, and/or (e) the filler material. The maturation system may accommodate one or more closeable (e.g., sealable) containers and/or one or more intermediate objects, e.g., in the chamber.

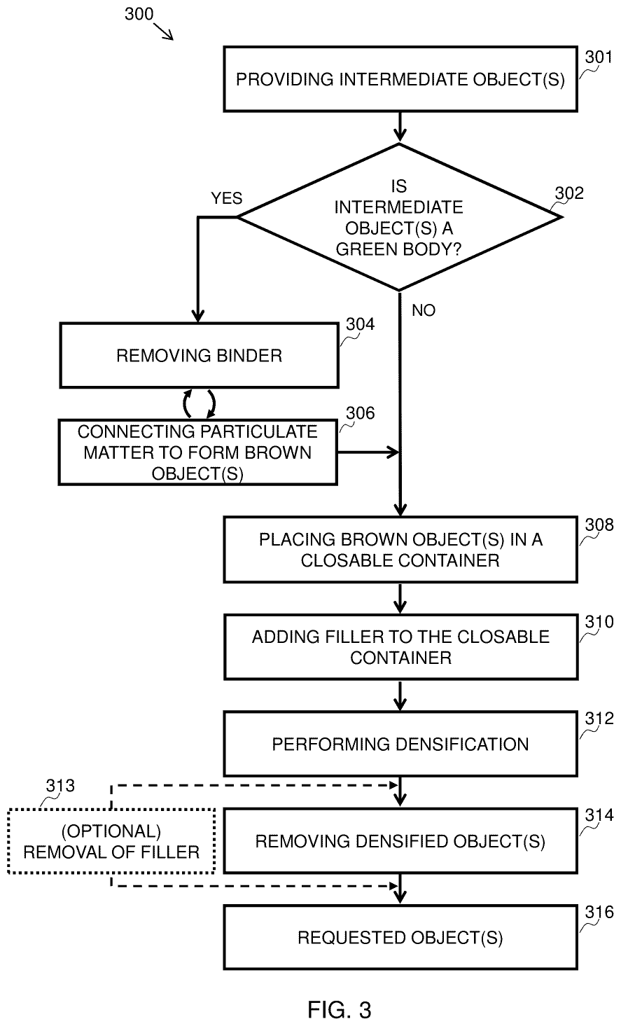

In some embodiments, one or more maturation stages to which an intermediate 3D object is subjected is performed considering a type of an intermediate object. A type of an intermediate object may comprise (i) a green object or (ii) a brown object. In some embodiments, a green object is subjected to (e.g., requires) at least one maturation stage (I) for removing binder material (e.g., debinding), and/or (II) for connecting particulate (e.g., requested) material, e.g., to form a brown object. In the green object, the particulate material may be embedded in the binder. The particulate material in the green object may be connected or disconnected. FIG. 3 depicts an example flowchart 300 for generating at least one requested object through one or more maturation stages. The example of FIG. 3 comprises operations of providing at least one intermediate object (e.g., 301), and determining a type of the intermediate object(s) (e.g., 302). In some embodiments, providing the intermediate object(s) comprises receiving and/or placing the intermediate object(s). Placing the intermediate object(s) may be within a (e.g., closeable) container. Placing the intermediate object(s) may be within a maturation system. In some embodiments, providing the intermediate object comprises generating (e.g., forming) the intermediate object(s), e.g., by any forming methodology described herein. In a case where the intermediate object(s) is not a green object(s), FIG. 3 depicts an example operation of placing the (e.g., brown) object(s) in a (e.g., closeable) container (e.g., 308). In the example of FIG. 3, the flowchart comprises operations of: adding filler material to the closeable container (e.g., 310); performing at least one maturation stage (e.g., densification, 312); removing a matured (e.g., densified) object(s) from the sealable container (e.g., 314); and, providing a requested 3D object(s) (e.g., 316). In some embodiments, an optional operation of removing the filler (e.g., 313) is performed before, during, and/or following the operation of removing the densified object(s). In a case where the intermediate object(s) is a green object(s), FIG. 3 depicts example operations of removing the binder material from the green object(s) (e.g., 304), and connecting particulate held by the binder material, e.g., to form a brown object (e.g., 306). In some embodiments, the operations in 304 and 306 comprise two maturation stages. In some embodiments, the two maturation stages (e.g., of 304 and 306) are different (e.g., comprise different conditions). In some embodiments, the two maturation stages (e.g., of 304 and 306) are the same (e.g., comprise the same conditions). In some embodiments, the operations of 304 and 306 are performed (a) serially, (b) simultaneously (e.g., in parallel), (c) in an alternating fashion, or (d) any combination thereof. In some embodiments, following connection of the particulate material to form the brown object(s) in 306, the brown object(s) is placed in the closable container (e.g., 308).

In some embodiments, determining the type of the intermediate object(s) is performed manually and/or automatically. For example, the type of intermediate object(s) may be determined considering a forming methodology and/or manufacturing device that was used in the formation of the intermediate object(s). The automatic determination may be using one or more controllers that are operatively coupled to at least one component of the manufacturing device and/or closable container. The one or more controllers may comprise respective one or more electric circuits (e.g., electrical circuitry). The electrical circuitry may connect one or more controllers to a component and/or apparatus that is utilized in the maturation stage(s). The electrical circuitry may connect one or more controllers to a component and/or apparatus that is controlled by the one or more controllers. The one or more controllers may comprise or be operatively coupled to, respective one or more signal transmitters and/or receivers. The signals may operatively couple a controller to a component and/or apparatus that is controlled by the controller (e.g., via signal communication). The component and/or apparatus may comprise a signal transmitter and/or receiver. The determination of the type of intermediate object(s) may be before, during, and/or after formation of the intermediate object(s).

In some embodiments, providing a requested pre-transformed material is according to any of the formation methodologies for generating an intermediate 3D object described herein. In some embodiments, a requested pre-transformed material is provided without (e.g., devoid of) a binder (e.g., material). In some embodiments, a requested pre-transformed material is provided with a binder material (e.g., embedded within the binder). For example, the requested pre-transformed material may be provided in a complex (e.g., a mixture) with the binder. In some embodiments, a condition at which a transformation of a binder and/or a requested pre-transformed material occurs, comprises a transformation type. A transformation type may comprise a temperature, a pressure, a radiation intensity (e.g., energy density), a radiation wavelength, or a pH, e.g., hydrogen cation concentration, e.g., acidity, neutral, or basicity, e.g., of a solution. In some embodiments, a condition of a transformation (e.g., type) may comprise a value, or a range of values (e.g., a profile). For example, a transformation condition may comprise a given temperature, or temperature threshold (e.g., threshold profile), at which a material transforms. For example, a transformation condition may comprise a given pressure, or pressure threshold (e.g., threshold profile), at which a material transforms. The threshold may be any threshold disclosed herein. In some embodiments, a binder transforms under a first transformation condition(s) and the requested pre-transformed material transforms under a second transformation condition. The first transformation condition may be different than, or the same as, the second transformation condition. For example, the binder may transform at a first condition comprising a first temperature (e.g., 200° C.), and the requested pre-transformed (e.g., particulate) material may transform at a second condition comprising a second temperature (e.g., 500° C.) that is higher than the first temperature. For example, the binder may transform at a first condition comprising a first (e.g., incident) energy density (e.g., 50 Joules/square centimeter, “J/cm²”), and the requested pre-transformed (e.g., particulate) material may transform at a second condition comprising a second (e.g., incident) energy density (e.g., 250 J/cm²) that is higher than the first energy density. In some embodiments, the requested pre-transformed and/or particulate material withstands (e.g., without transformation) the first transformation condition(s). For example, the second transformation condition may comprise an altered temperature, pressure, radiation (e.g., intensity), or pH, as compared to the first transformation condition. Altered may comprise increased or decreased.

In some embodiments, the first transformation condition (e.g., having a first value such as a first threshold value) and the second transformation condition (e.g., having a second value such as a second threshold value) comprise at least one transformation type (e.g., temperature, pH, radiation, and/or pressure) that is the same. For example, the transformation type may be pressure. For example, the binder may transform at a pressure of 45 mega-Pascals (MPa), and the requested pre-transformed material (e.g., metal powder) may transform at a pressure of 250 MPa. The first transformation condition may comprise a first radiation intensity, e.g., at a given radiation wavelength, and the second transformation condition may comprise a second (e.g., increased) radiation intensity at the given radiation wavelength. For example, the first transformation condition may comprise a first temperature, and the second transformation condition may comprise a second (e.g., higher) temperature. For example, the binder may have a melting point of 200° C., where the first transformation type is heating or temperature; and the metal powder may have a melting point of 1000° C., where the second transformation type is also heating or temperature.

In some embodiments, the first transformation condition (e.g., having a first threshold or value) and the second transformation condition (e.g., having a second threshold or value) comprise at least two transformation types that are different. The different transformation types may correspond to any permutation of the transformation types. For example, two different transformation types may be: pH and temperature, pressure and temperature, radiation and pressure, pH and pressure, or pH and radiation. For example, a first transformation condition of the binder may comprise a given (e.g., threshold) temperature (e.g., that is the first transformation type); and a second transformation condition of the requested (particulate) pre-transformed material may comprise a given (e.g., threshold) radiation intensity (e.g., with radiation being the second transformation type). For example, the first transformation condition may comprise a given pressure (e.g., first transformation type), and the second transformation condition may comprise a given temperature (e.g., second transformation type). For example, the first transformation condition may comprise a pH (e.g., second transformation type), e.g., of a solution, or a slurry, and the second transformation condition may comprise a given radiation intensity (e.g., second transformation type). For example, the binder may have a hydrolysis pH of 6, where the first transformation type is pH; and the metal powder may have a melting point of 1000° C., where the second transformation type is heating or temperature.

In some embodiments, the separating material (e.g., surface of the filler) comprises a (e.g., third) transformation condition (e.g., third threshold value). In some embodiments, the third transformation condition is different from the first transformation condition and/or from the second transformation condition. In some embodiments, the separating material (e.g., shell of the filler) withstands (e.g., without transformation) the conditions of (i) the first transformation condition and (ii) the second transformation condition. For example, the third transformation condition may comprise an alteration (e.g., increase or decrease) in temperature, pressure, radiation (e.g., intensity), or pH, as compared to the first transformation condition and/or the second transformation condition. In some embodiments, the requested material is provided (e.g., in a complex) with a binder material that has a first dissociation (e.g., hydrolysis) pH. The requested (e.g., pre-transformed and/or particulate) material may have a second dissociation pH that is (e.g., distinguishably) different (e.g., lower) than that of the first dissociation pH. In some embodiments, the separating material of the filler has a third dissociation pH that is (e.g., distinguishably) different (e.g., lower or higher) than that of the second dissociation pH. In some embodiments, the requested material is provided (e.g., in a complex or mixture) with a binder material that has a first melting point. The requested material may have a second melting point that is (e.g., distinguishably) higher than that of the first melting point. In some embodiments, the separating material of the filler has a third melting point that is (e.g., distinguishably) higher than that of the second melting point. For example, the binder material may comprise ice, the requested material may comprise a polymer, and the separating material may comprise a metal. For example, the binder comprises a polymer, the requested material comprises a metal, and the separating material comprises a ceramic. For example, (i) the binder comprises a resin, (ii) the requested material comprises a medium melting point (e.g. gold, silver, copper, iron, Inconel, or stainless steel), or a relatively low melting point metal (e.g., aluminum, lead, Rose's metal, Carrosafe, Wood's metal, or Field's metal), and (iii) the separating material comprises a relatively high melting point metal (e.g., tungsten, niobium, molybdenum, tantalum, rhenium, Ta₄HfC₅, hafnium carbide, or tantalum carbide).

In some embodiments, the separating material allows the filler to remain sufficiently flowable during (e.g., throughout), upon completion, and/or following, a maturation stage. Sufficiently flowable may be to the extent that the filler is readily separable and/or removable from the densified 3D object. Readily removable and/or separable may be using an attractive (e.g., vacuum suction), repulsive (e.g., gas pressure) force, or non-damaging mechanical force (e.g., vibrating, or brushing). Non damaging may be with respect to the densified 3D object(s). The separating material may withstand transformation under the condition of the maturation stage. The separating material may form at least a portion of the external surface of a particle of the filler. In some embodiments, a portion (e.g., granules and/or particles) of a filler material connect and/or coagulate. For example, the portion of the filler material may (e.g., partially) fuse (e.g., sinter or melt). In some embodiments, the portion of the filler material that connects and/or coagulates may be limited. The separating material may limit the connection and/or coagulation of the filler particles, e.g., during the maturation stage. Limited may be to an extent that the filler material retains (e.g., maintains) a flowable state during and/or following the maturation stage. Flowable may be sufficient to separate the filler from the matured 3D object(s) upon completion of the maturation stage. Flowable may be sufficient to separate the filler from the container upon completion of the maturation stage. Flowable may be sufficient to evacuate at least a portion of the filler from the container upon completion of the maturation stage. The flowable state may comprise a state in which the filler material is movable, e.g., under agitation, a gravitation force, and/or a (e.g., fluid, gas, vacuum) pressure. For example, the filler material may be movable by a gas flow and/or a liquid flow. The filler may be moveable by suction. The filler may be moveable by being attracted to a force source. The force source may comprise magnetic, electrostatic, or gas (e.g., vacuum) source. The filler may comprise a magnetic and/or conductive material. The filler may comprise a radiating and/or emitting material. The flowable state may be provided (e.g., maintained) to allow separation (e.g., removal) of the filler material, e.g., from the container and/or the matured (e.g., densified) 3D object(s). The separation of the filler may be following a maturation stage.

In some embodiments, providing a shrinkable, flowable filler material comprises providing a particulate material. In some embodiments, the particulate material comprises a powder. In some embodiments, conditions of a maturation stage comprise sufficient force(s) to shrink (e.g., deform) the filler material. In some embodiments, the reduction in size of the filler material is due to a change in (A) a packing density of (e.g., particles of) the filler material, and/or (B) a volume (e.g., of individual particles) of the filler material. A change in a packing density may comprise a change (e.g., a reduction) in a dimension of gaps or spaces between particles of the filler material. In some embodiments, a change in a volume of a shrinkable filler material results from a material that is deformable. A deformable material may be a material that experiences a change in a morphology (e.g., geometry) when it is subjected to a sufficient force (e.g., load). In some embodiments, a size (e.g., volume) of a particle of filler material is given by a bounding volume. The bounding volume may comprise a bounding box, a bounding sphere, a bounding ellipse, a bounding cylinder, or a convex hull. The bounding volume dimension(s) may correspond to the minimum that is required for enclosing all sides of a given object. In some embodiments, the minimum bounding volume dimension corresponds to an FLS of a given particle, e.g., of a filler material particle and/or of a requested material particle. For example, a (e.g., minimally-sized) radius of a bounding sphere that minimally encloses a (e.g., given) particle may correspond to the FLS of the (e.g., given) particle. For example, one of the (e.g., minimally-sized) sides of a bounding box that minimally encloses a (e.g., given) particle may correspond to the FLS of the (e.g., given) particle. The bounding box may be an arbitrarily oriented minimum bounding box or an axis-aligned bounding box. The dimensions (e.g., of the sides) of the bounding volume may be determined by a suitable methodology, e.g., according to a rotating calipers methodology, or using microscopy. In some embodiments, a first bounding volume encompasses a given particle prior a maturation stage, and a second bounding volume encompasses the given particle following the maturation stage. In some embodiments, a reduction in size (e.g., volume) corresponds to a reduction in a volume from the first bounding volume to a volume of the second bounding volume. In some embodiments, an amount of shrinkage (e.g. deformation) for a filler material may be limited, e.g., under the conditions of the maturation stage. Limited may be with respect to a reduction factor, e.g., of the intermediate 3D object during the maturation stage. For example, under the conditions of the maturation stage, the filler material may shrink (e.g., deform) according to a reduction factor that is at most about the reduction factor of the intermediate 3D object. In some embodiments, the filler material comprises at least two reduction factor(s) for at least two maturation stages. In some embodiments, the reductions factor(s) of a filler material are similar to (e.g., about equal to) reduction factor(s) of the intermediate 3D object (e.g., for at least two maturation stages). In some embodiments, the limited deformation (e.g., shrinkage) of the filler material during a maturation stage serves to support an adjacent intermediate 3D object, e.g., at least in part.

In some embodiments, a shrinkable filler material comprises an agglomeration of particulates. The agglomeration of particulates may comprises powder (e.g., particles). In some embodiments, the agglomeration comprises particles that are (a) loosely or closely packed, (b) small, e.g., with respect to particles of a requested material (e.g., “small-particles”), (c) coated at least in part, or (d) any combination of the above. In some embodiments, the filler material comprises a mixture of an interior material and a coating of a (e.g., small-particle) separating material. The interior material may comprise the requested pre-transformed (e.g., particulate) material. In some embodiments, the small-particle separating material may be sized such that, when packed along with (e.g., alongside) the interior material, the particles of separating material are sufficiently small to (e.g., fully or partially) surround the interior material. For example, a plurality of small-particles (e.g., separating material) may surround a plurality interior material cores, such that at least two particles (e.g., none) of the plurality of interior material cores do not contact each other (e.g., directly). In some embodiments, small-particles comprise particles that have a size (e.g., FLS) that is expressed as a relationship to an average size of particles of the interior material, e.g., to a mean FLS of particles of the interior material. In some embodiments, small-particles comprise particles that have a size that is at most about 0.7*(mean FLS of the interior material particles), 0.5*(mean FLS of the interior material), 0.3*(mean FLS of the interior material particles), 0.1*(mean FLS of the interior material particles), or 0.01*(mean FLS of the interior material particles), where “*” denotes the mathematical multiplication operation. The size of the small-particles may be any value between the afore-mentioned values (e.g., from about 0.7*(mean FLS of the interior material particles) to about 0.01*(mean FLS of the interior material particles), from about 0.7*(mean FLS of the interior material particles) to about 0.3*(mean FLS of the interior material particles), or from about 0.3*(mean FLS of the interior material particles) to about 0.01*(mean FLS of the interior material particles)).

In some embodiments, a filler material is formed of particulate material that comprises a coating and an inner body. The coating may occupy (e.g., engulf) an external surface of the inner body at least in part. For example, the coating may occupy at least about 40%, 50%, 60%, 70%, 80%, 90%, 95%, or 99% of the external surface of the inner body. The external surface of the inner body may be occupied by the coating at any value between the afore-mentioned values (e.g., from about 40% to about 99%, from about 40% to about 70%, or from about 70% to about 99%). The coating (e.g., material) may occupy an external surface (e.g., material) of the filler. The coating may comprise the separating material. In some embodiments, the coating material is different than the requested material. In some embodiments, the coating material comprises a (e.g., chemical) change to an exterior of the inner body. The chemical change may be a change to a chemical composition of the material of the inner body. In some embodiments, the change to the chemical composition comprises (e.g., is afforded by) a gas phase and/or liquid phase treatment, e.g., to the exterior of the inner body material. The exterior of the filler particles may comprise an outermost extent of the particles (e.g., an external surface). The treatment may comprise an oxidation and/or passivation to at least part of the exterior of the inner body. In some embodiments, the treatment (e.g., chemically) changes the chemical nature of at least a portion of the outermost extent of the particles, e.g., to form the separating material. In some embodiments, the coating comprises an addition of material to a requested material. For example, the coating material may be applied, e.g., by solid or liquid spattering, liquid phase treatment, or gas phase treatment, to an inner body that comprises the requested material. The treatment may comprise chemical vapor deposition or physical vapor deposition. The treatment may comprise immersion in a liquid. The treatment may comprise a spray of a liquid, a gas, a solid, a slurry, or an emulsion. The coating material (e.g., that is added) may be a material that withstands transformation under conditions of at least one maturation stage. Withstands transformation may be at least to an extent that allows the filler to remain flowable and/or readily removable from the maturing 3D object and/or from the container. The coating may comprise a thickness of material that has given physical (e.g., mechanical) properties, e.g., to withstand the conditions of the maturation stage(s). For example, the coating material that is added may withstand being connected, e.g., to itself and/or to the requested material. To withstand being connected may be to a sufficient degree such that the filler will remain flowable, e.g., during and/or after the maturation stage(s). The given physical properties of a coating may comprise thermal conductivity, hardness, stiffness, yield, ultimate tensile strength, or ductility. In some embodiments, the coating (e.g., material) possesses sufficient thickness and/or mechanical properties to reduce a likelihood that a defect is formed in the filler material.

In some embodiments, a portion of a separating material (e.g., coating) of a given particle of filler material comprises (e.g., develops) a defect during a maturation stage. The filler material that comprises the defect may remain flowable, e.g., during and/or after the maturation stage(s). The defect may occur at a surface or within an interior of the particle of filler material. The defect may comprise a dislocation, a deformation, or an opening. In some embodiments, an opening comprises a rupture (e.g., a tear and/or a crack). In some embodiments, the opening in the (e.g., separating material of the) given particle of filler material is insufficient to promote (e.g., allow) the given particle to connect with a neighboring particle. The neighboring particle may comprise (i) a (e.g., second) filler material particle, or (ii) a requested material particle. In some embodiments, the opening in the separating material of the given particle of filler material allows the given particle to connect with one or more neighboring particles. For example, the given particle may connect with one or more neighboring particles to form an agglomeration. In some embodiments, the agglomeration comprises (I) at least two particles of filler material, or (II) (a) one or more particles of filler material and (b) one or more particles of requested material (e.g., of a requested 3D object). For example, the at least two particles of filler material may agglomerate as a result of (e.g., at least partial) sintering together. For example, a particle of filler material may form an agglomerate as a result of (e.g., at least partial) a defect (e.g., failure) of a coating of the particle of filler material. The defect of the coating may allow an inner (e.g., requested) material to escape (e.g., leak or flow) to an exterior of the particle of filler material. For example, a portion of an internal material may at least partially transform (e.g., melt). The (e.g., at least partially melted) portion may exit the interior of the particle. The portion may (e.g., partially) connect with a neighboring filler material particle. Under conditions of the maturation stage(s), the escaped inner material may allow (e.g., cause) the defective particle to sinter to one or more neighboring particles. For example, the escaped inner material may cause the defective particle to sinter to another particle of filler material, and/or to a particle of requested material. The filler and/or maturation conditions may be designed to minimize connection to the requested pre-transformed material particles to the filler.

In some embodiments, a size (e.g., extent, or bounding volume) of agglomerated particles is limited. Limited may be with respect to a dimension (e.g., FLS) of the agglomeration of particles, or to a number of particles in the agglomeration. The FLS of the agglomerated particles may be related to an (e.g., average) FLS of (e.g., individual) filler material particles from which the agglomeration is formed (e.g., average particle size, “APS”). For example, an FLS of agglomerated particles may be at most about 2*APS, 3*APS, 5*APS, 8*APS, or 10*APS, where “*” denotes a multiplication operation. The FLS of the agglomerated particles may be limited to any value between the aforementioned values (e.g., from about 2*APS to about 10*APS, from about 2*APS to about 5*APS, or from about 5*APS to about 10*APS).

In some embodiments, the coating material comprises a material that (i) has a high melting point, and/or (ii) is ductile. A high melting point coating material may be with respect to a melting point of a requested material. In some embodiments, the coating material comprises a ceramic, e.g., alumina, zirconia, boron nitride, silicon nitride, silicon carbide, tungsten carbide, silica, and/or magnesia. In some embodiments, a high melting point metal comprises a refractory metal, e.g., niobium, molybdenum, tantalum, tungsten, or rhenium. In some embodiments, a ductile material (e.g., metal) affords a separating material (e.g., for a filler) that is deformable, e.g., under the conditions of at least one maturation stage. Deformation of the ductile material may comprise wrinkling, cracking, shifting, and/or reduction in an outer radius, e.g., of an outermost extent of the filler material. In some embodiments, an outermost extent comprises a shell. In some embodiments, a shell (e.g., completely) encapsulates (e.g., surrounds) an interior portion of the filler material. In some embodiments, a shell (e.g., coating) partially encapsulates an interior portion of the filler material. In some embodiments, for a filler material that comprises a separating material shell, a deformation (e.g., size reduction) of the separating material comprises a thickening of the shell.

At least a portion of the inner body of the filler material may comprise the requested material. In some embodiments, the requested material of the filler is similar to (e.g., the same as) the requested material that is used to form the requested 3D object. In some embodiments, the inner body material comprises a material that has a reduction factor that is similar to that of the material of the requested 3D object. In some embodiments, an inner body of a filler material is surrounded at least in part by at least one surface (e.g., coating, or shell) that is external to the inner body. In some embodiments, the inner body of the filler material is shrinkable. The coating may or may not be shrinkable under conditions of the maturation stage(s). The coating may or may not be deformable under conditions of the maturation stage(s). In some embodiments, at least two surrounding surfaces and/or coatings of a filler material comprise different materials. In some embodiments, at least two surrounding surfaces and/or coatings of a filler material comprise the same material(s). In some embodiments, a filler material comprises a pore (e.g., bubble). The pore(s) may be open or closed. At least two pores may connect. The connected pores may form a channel. The channel may be an open channel or a closed channel. Open may be with respect to an environment external to the filler particle. A closed pore and/or channel may be disconnected (e.g., closed) from the environment external to the filler particle. The pore(s) may comprise (e.g., be filled with and/or trap) at least one gas. In some embodiment, the gas within the filler material pore(s) is the same as a gas that is within an environment in which the requested 3D object is formed and/or subjected to one or more maturation stages. In some embodiment, the gas within the filler material pore(s) is different from the gas environment of the formation and/or maturation stage(s).

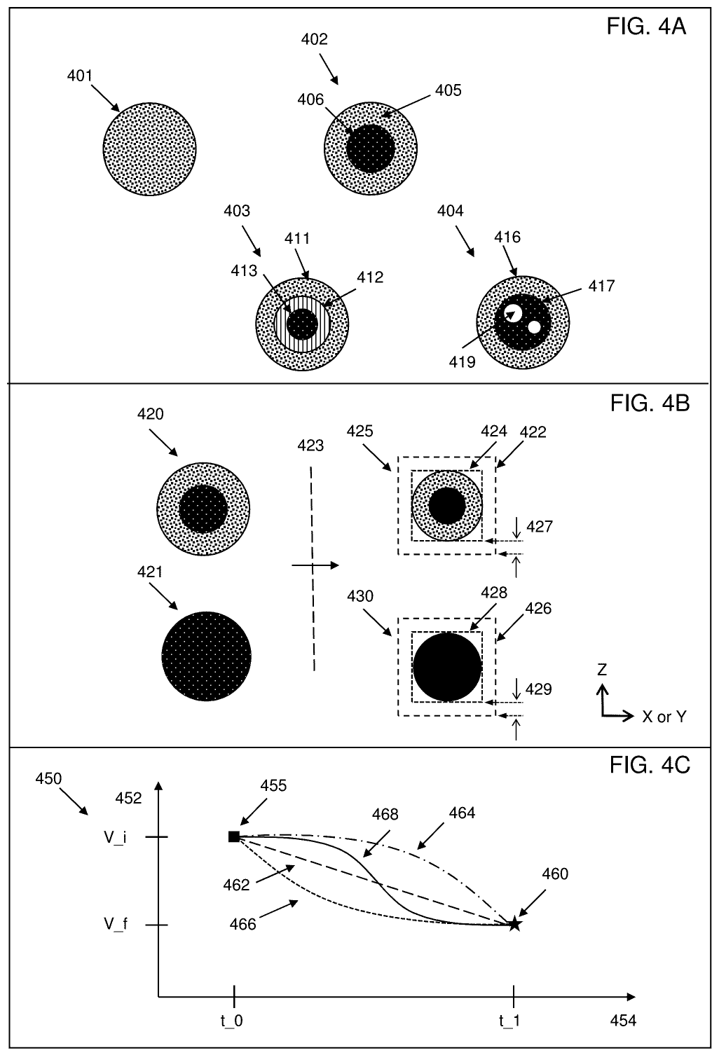

FIG. 4A depicts examples of filler material particles. The filler material particles may comprise (i) at least one separating material, (ii) an internal material, (iii) a pore, or (iv) a channel. The filler material particles may be formed such that any internal material that is included in the filler material is not exposed, e.g., at a surface of the filler particle, during (e.g., throughout) a maturation stage. The filler material particles may be formed such that the internal material that is included in the filler material is partially and/or minimally exposed, e.g., at a surface of the filler particle, during (e.g., throughout) a maturation stage. FIG. 4A depicts: an example particle 401 that comprises (e.g., only) a separating material; an example particle 402 that comprises an internal material 406 that is surrounded by a separating material 405; an example particle 403 that comprises an internal material 413 that is surrounded by a second material 412, and a separating material 411; and, an example particle 404 that comprises an internal material 417 having pores 419, the requested material surrounded by a separating material 416. In some embodiments, the second material 412 comprises a second requested material, or a second separating material. In the particle examples shown in FIGS. 4A and 4B, each shell appears to engulf a core that includes the internal material. However, the shell may cover only a portion of the core, e.g., as delineated herein. The internal material may be a material of the requested 3D object, or a material having shrinkage properties similar (e.g., the same as) those of the requested 3D object. The shrinkable property may comprise a size (e.g., FLS and/or volume) reduction factor. The internal material may be shrinkable and/or contractible during the maturation stage(s). The internal material may shrink due to (i) the existence of the one or more pores embedded in the pore, (ii) the shrinkage of the one or more pores, (iii) the transformation of the internal material during the maturation stage(s), or (iv) any combination thereof. The one or more pores may be engulfed at least in part by the internal material.

FIG. 4B depicts an example of size reduction for a filler material particle 420 and an internal material particle 421 during, upon, and/or following a maturation stage. The size reduction may be according to a reduction factor. In some embodiments, the requested material comprises a first reduction factor, and the filler material comprises a second reduction factor. In some embodiments, the first reduction factor and the second reduction factor are (e.g., substantially) the same, e.g., for at least one maturation stage. In some embodiments, the first reduction factor and the second reduction factor are different. The (e.g., first and/or second) reduction factor(s) may be determined according to a minimum bounding volume. In the example of FIG. 4B, following a maturation stage 423 (e.g., sintering), a filler material particle 425 is reduced from a (e.g., first) size 422 to a (e.g., second) size 424, e.g., by a reduction factor 427. In the example of FIG. 4B, a requested material particle 430 is reduced from a (e.g., third) size 426 to a (e.g., fourth) size 428, e.g., by a reduction factor 429.

FIG. 4C depicts several examples 450 of reduction factors for an intermediate object. In the example of FIG. 4C, an intermediate object size 452 is plotted as a relationship (e.g., a function) of time 454, e.g., during a maturation stage. FIG. 4C depicts an example first (e.g., initial) intermediate object size 455 at a (e.g., first) time t_0, and a second (e.g., final) intermediate object size 460 at a (e.g., second) time t_1. In some embodiments, a reduction factor corresponds to a relationship (e.g., a function) that is: (i) (e.g., substantially) linear (e.g., 462); (ii) logarithmic (e.g., 464 or 466); (iii) polynomial (e.g., 468); or (iv) any combination of the above.

In some embodiments, a shrinkable, flowable filler material comprises one or more shapes. The filler material may comprise particulate matter (e.g., powder). In some embodiments, the (e.g., particles of the) filler material comprises one or more morphologies or geometries. In some embodiments, the shape (e.g., of individual particles) comprises a shape that is spheroidal, ellipsoidal, cuboidal, oval, prismatic, conical, cylindrical, polyhedral, or closed amorphous (e.g., potato shaped). In some embodiments, the individual particles comprise a hollow portion (e.g., a hole). The hollow portion may have an opening to a (e.g., exterior) surface of the individual particles, and may be referred to herein as an open hollow portion. For example, a surface of the hollow portion may be continuous with an exterior surface of the individual particle. In some embodiments, a dimension of a hollow portion is limited with respect to a dimension of the individual particles. A limitation in a dimension of the hollow portion may reduce (e.g., prevent) a likelihood of insertion(s) of individual particles, e.g., of a first individual particle into a hollow portion of another individual particle. For example, a dimension of a hollow portion may be limited with respect to a diameter of a minor axis (e.g., “DMA”) of the individual particles. In some embodiments, a dimension of a hollow portion of an individual filler material particles may be limited to be at most about 0.1*DMA, 0.2*DMA, 0.3*DMA, 0.4*DMA, or 0.5*DMA. The dimension of the hollow portion may be limited to any value between the afore-mentioned values (e.g., from about 0.1*DMA to about 0.5*DMA, from about 0.1*DMA to about 0.3*DMA, or from about 0.3*DMA to about 0.5*DMA).

In some embodiments, a shrinkable, flowable filler material comprises a porous material. In some embodiments, a porous material comprises (i) a lightweight structure, (ii) a foam (e.g., sponge) structure, or (iii) a network structure, e.g., a lattice structure. In some embodiments, regions of a porous material that are (e.g., substantially) devoid of solid (e.g., dense) material may be referred to herein as “cells.” In some embodiments, a porous material comprises an open-cell structure or a closed-cell structure. A closed-cell structure may comprise cells (e.g., pores) that are (e.g., completely) enclosed by a surrounding wall of (e.g., dense) material. An open-cell structure may have at least one opening to the exterior of the material. A channel may be formed when at least two cells that are interconnected. In some embodiments, the portion(s) of the porous material that comprise solid material may be referred to as “dense material.” The dense material may comprise (A) a separating material, or (B) an interior (e.g., shrinkable) material. The porous filler material may have an increased porosity with respect to a porosity of an intermediate 3D object. The porous filler material may have a decreased porosity with respect to a porosity of an intermediate 3D object. In some embodiments, the porous filler material comprises individual sub-particles, e.g., forming a porous material. In some embodiments, the porous filler material comprises agglomerations of porous and/or dense material.

In some embodiments, the porous filler material comprises a unit that is repetitive. In some embodiments, the porous filler material is devoid of repeating units. The porous filler material may comprise at least 30%, 40%, 50%, 60%, 70%, 80%, 90%, or 95% porous region (measured as volume/volume), e.g., that does not comprise a separating material and/or a requested material. The network structure may comprise at most 0.5%, 5%, 10%, 20%, 30%, 40%, 50%, 60%, or 70% separating material and/or requested material, e.g., dense material (measured as volume/volume). In some embodiments, a porous filler material comprises at least one region having regular (e.g., repeating) order (e.g., a lattice region). A fundamental length scale (FLS) of a distance over which a network or a repeating order occurs (e.g., a repetition distance, or coherence length, “CL”) may be at most about 5 nanometers (nm), 10 nm, 30 nm, 40 nm, 50 nm, 100 nm, 200 nm, 300 nm, 400 nm, 500 nm, 1 micron (μm), 5 μm, 10 μm, 20 μm, 25 μm, 30 μm, 35 μm, 40 μm, 45 μm, or 50 μm. An FLS of a network or of a repeating distance for a porous filler material having a regular order may be between any value of the aforementioned values (e.g., from about 5 nm to about 50 μm, from about 5 nm to about 5 μm, or from about 5 μm to about 50 μm). The network may or may not be ordered. The network may or may not comprise a repeating unit. The network may be semi-repetitive, may be composed of repeating units, or be chaotic. The network may comprise an organized (e.g., repeating), a semi-organized (e.g., repeating within a tolerance), or a chaotic (e.g., non-repetitive) region. In some embodiments, a porous filler material comprises at least one region having a semi-regular order (e.g., a region that has a regular order within a given dimensional tolerance). The dimensional tolerance for a semi-regular order may be expressed as a fraction of a FLS of an ordered porous filler material repetition distance (e.g., a coherence length at a direction). For example, a dimensional tolerance for a semi-regular order may be at least about 0.01*CL (where “*” denotes a multiplication operation), about 0.05*CL, about 0.1*CL, about 0.25*CL, or about 0.5*CL. A dimensional tolerance for a semi-regular order may be between any value of the afore-mentioned values (from about 0.01*CL to about 0.5*CL, from about 0.01*CL to about 0.1*CL, or from about 0.1*CL to about 0.5*CL). The direction of the coherence length may correspond to the lattice structure in the network, e.g., corresponding to the coordinates defined by the repeating unit. In some embodiments, a porous filler material comprises at least one region that is devoid of regular order. For example, a region that is devoid of regular order may comprise an amorphous composition, a sponge-like composition, or a foam-like composition (e.g., a metal foam, or a ceramic foam).

In some embodiments, the porous filler material comprises a requested material that is the same as the requested material of the (e.g., intermediate) 3D object. The same may comprise the same type (e.g., of material). In some embodiments, the porous filler material is of the same type of (e.g., porous) at least one material of the intermediate (e.g., green and/or brown) object. In some embodiments, the porous filler material comprises a separating material. In some embodiments, a porous filler material comprises a coating (e.g., shell). The coating may comprise the separating material. The coating may comprise a ceramic coating, or a metal coating, e.g., that have a higher melting temperature than that of the requested material. The coating may coat (i) at least a portion of an individual particle of porous filler material, and/or (ii) at least two sub-particles of requested material. During at least one maturation stage, the coating may reduce (e.g., prevent) a connection of the filler with the maturing and/or matured 3D object and/or container wall(s). The coating may reduce (e.g., prevent) a connection with a neighboring particle during at least one maturation stage. A neighboring particle may comprise a particle of the filler material, or a particle of pre-transformed requested material (e.g., of an intermediate object). In some embodiments, the porous filler comprises a coating that deters connection from one particle to another particle (e.g., of porous filler).

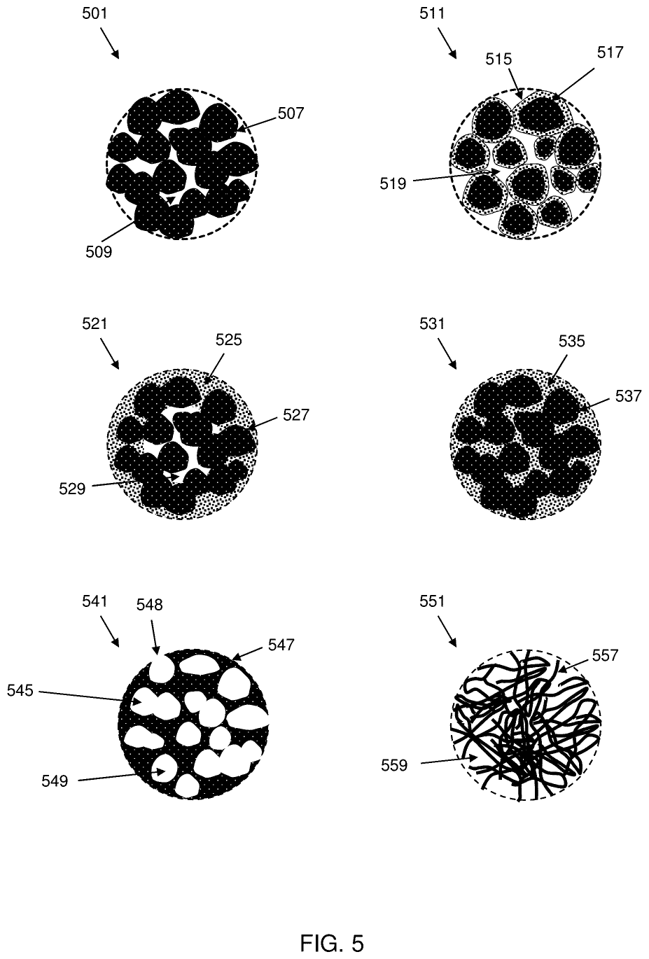

FIG. 5 depicts examples of filler material that is porous. In some embodiments, the porous filler material comprises individual (e.g., porous) particles. In some embodiments, the porous filler material comprises individual filler particles (e.g., 501) of agglomerated (e.g., connected, such as loosely connected) sub-particles of material (e.g., 507), and pores (e.g., 509). The sub-particles may comprise separating material, and internal material (also referred to herein as the “interior material”) and/or a requested (e.g., pre-transformed and/or particulate) material. The internal material may comprise the requested material. In some embodiments, filler particles (e.g., 511) comprise a separating material (e.g., 515) that at least partially surrounds (e.g., coats) individual sub-particles of an internal material (e.g., 517). At least two (e.g., all) of the coated sub-particles may be separated by a gaseous gap and/or by a pore (e.g., 519). In some embodiments, filler particles (e.g., 521) comprise a separating material (e.g., 525) that at least partially surrounds (e.g., coats) a plurality of sub-particles of a requested material (e.g., 527). The plurality of sub-particles of requested material may be coated by the separating material such that a porous region (e.g., 529) is maintained within an interior of the individual particle(s). The plurality of sub-particles may comprise an agglomeration. The plurality of sub-particles may be imprinted on a foam. The porous region may be filled with a gas. The porous region may be (e.g., substantially) devoid of the separating material and/or the interior (e.g., internal) material. In some embodiments, filler particles (e.g., 531) comprise a separating material (e.g., 535) that at least partially (e.g., completely) surrounds (e.g., coats) a plurality of sub-particles of an interior material (e.g., 537). The interior material and the separating material may be different. The plurality of sub-particles of requested material may be coated by the separating material such that an interior of the individual particle(s) is (e.g., substantially) filled by the separating material. In some embodiments, filler particles (e.g., 541) comprise a network of material (e.g., 547). The material of the network may comprise a separating material, interior material, and/or a requested material. The network may comprise a closed channel structure (e.g., 545), a closed-cell structure (e.g., 549), or an open-cell structure (e.g., 548). In some embodiments, filler particles (e.g., 551) comprise a network structure, e.g., a mesh (e.g., 557). The network may comprises wires or fibers. The material of the mesh may comprise a separating material, an interior material, and/or a requested material. In some embodiments, the network structure comprises porous region(s) (e.g., 559).

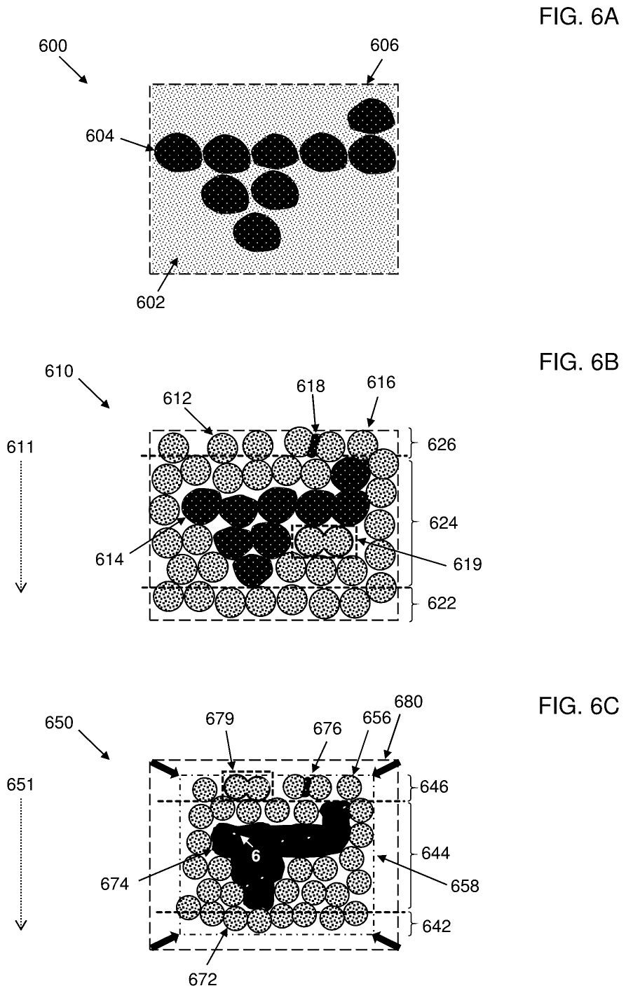

FIGS. 6A-6C depict examples of various maturation stages, e.g., at a particle-level (e.g., schematic view) of an intermediate 3D object. In the example of FIG. 6A, a portion 600 of an intermediate (e.g., green) 3D object comprises particles 604 of requested (e.g., pre-transformed) material, and binder material 602 that fixes the relative positions of the requested particulate material. Prior to a (e.g., any) maturation stage, the portion of the intermediate object may have a (e.g., first) size (e.g., 606). A first size may correspond to a size (e.g., volume) of a green object or a brown object. An intermediate 3D object may be subjected to one or more maturation stages. A non-connected support may be provided for the intermediate 3D object, e.g., during at least one maturation stage.

In the example of FIG. 6B, a portion 610 of an intermediate object having non-connected support is depicted following a (e.g., debinding) maturation stage. In some embodiments, a debinding maturation stage removes (e.g., substantially) all of a binder material of a green object. In some embodiments, a debinding maturation stage removes a portion of the binder material of a green object. A remainder of the binder material (e.g., following debinding) may assist in maintaining (e.g., retaining) a requested geometry of the intermediate object. For example, a debinding maturation stage may remove about 30%, 50%, 70%, 90%, or 95% of the binder material from an intermediate object. A debinding maturation stage may remove any amount between the afore-mentioned amounts (e.g., from about 30% to about 95%, from about 30% to about 70%, or from about 70% to about 95%). In some embodiments, (e.g., any) remaining portion of the binding material is removed in a subsequent maturation stage. In some embodiments, the non-connected support reduces (e.g., prevents) a defect (e.g., deformation) during the maturation stage(s). For example, the non-connected support (e.g., filler) may exert a force (e.g., counter-force) on the intermediate object. The force may be exerted onto a (e.g., exterior) surface of the intermediate object. In some embodiments, the (e.g., particles of the) requested material may be (e.g., loosely) connected (e.g., FIG. 6B, 614) following at least one maturation stage. The non-connected support (e.g., 612) may be provided to at least in part surround the requested material of the intermediate 3D object. Surround may comprise being adjacent to (e.g., 624). Surrounding may comprise being above (e.g., 626) and/or below (e.g., 622). Above and below may be with respect to a global vector (e.g., 611). The intermediate 3D object may be surrounded by at least one layer of the non-connected support that contacts at least a portion of the exterior surface of the intermediate 3D object. The surrounding filler particles may be closed packed, e.g., densely packed. The non-connected support may comprise a shrinkable, and/or flowable filler material. The non-connected support (e.g., filler material) may be (e.g., remain) flowable during (e.g., throughout), upon, and/or following at least one maturation stage. In some embodiments, a shrinkable filler material comprises an agglomeration of particulates (e.g., particles). The agglomeration of particulates may comprise be included in, or may form, a powder. The agglomeration may comprise a connection (e.g., by fusing) between at least two particles of filler material. The connection may be formed from a connection of separating material (e.g., 619). The connection may comprise a requested material. The connection may be formed from escaped inner (e.g., requested) material (e.g., 618). In some embodiments, the agglomeration is formed during and/or following a maturation stage. The agglomeration of particulates may remain flowable during, upon, and/or following the maturation stage. Following at least one maturation stage, the portion of the intermediate object may have a (e.g., second) size. In some embodiments, the second size is (e.g., substantially) the same as the first size. In some embodiments, the second size (e.g., 656) is different from (e.g., smaller than) the first size (e.g., 616). Different from may be according to a reduction factor, e.g., of the requested material.

In some embodiments, the intermediate object is subjected to a (e.g., final) densification maturation stage. The densification maturation stage may comprise conditions of varied (e.g., increased or decreased) temperature, chemical environment such as pH, and/or pressure, with respect to a prior maturation stage. The densification maturation stage may comprise conditions under which (e.g., particles of) the requested material are (e.g., fully) connected. Fully connected may be to a requested extent (e.g., density), e.g., of the requested 3D object, e.g., to be obtained once all maturation stage(s) are completed. The intermediate object may be supported by a non-connected support during the (e.g., densification) maturation stage. The at least a portion of the non-connected support (e.g., filler material) may remain in contact with surfaces of the intermediate 3D object and/or internal container wall(s), to prevent deformation of the intermediate object as it densifies (e.g., contracts). The contact may comprise a (e.g., average) force and/or pressure exerted on the (e.g., external) surface(s) of the intermediate 3D object. The non-connected support may occupy at least a portion of an internal cavity of the intermediate 3D object, e.g., during at least one maturation stage. In some embodiments, the average force and/or pressure the non-connected support exerts is (e.g., substantially) constant, e.g., during at least a portion of a maturation stage. In some embodiments, the average force and/or pressure the non-connected support exerts is varied, e.g., during at least a portion of a maturation stage. The variation in the exerted average force and/or pressure may be predetermined (e.g., controlled), and/or simulated. The non-connected support may remain flowable before, during, upon, and/or after the (e.g., densification) maturation stage(s). In some embodiments, a non-connected support that is used during the densification maturation stage is the same as the non-connected support that is used during at least one prior (e.g., debinding and/or sintering) maturation stage. In some embodiments, a non-connected support that is used during the densification maturation stage is different from a non-connected support that is used during at least one prior (e.g., debinding and/or sintering) maturation stage. Different may comprise a different type of filler material, e.g., of the non-connected support. Different may comprise a different type of coating and/or internal material(s). Different may comprise different particles (e.g., size and/or shape) of filler material, e.g., of a same type of non-connected support. In the example of FIG. 6C, a portion 650 of a 3D object (e.g., 674) having non-connected support (e.g., 672) is depicted following a densification stage. The portion of the intermediate object may have a (e.g., third) size following the (e.g., densification) maturation stage. In some embodiments, the third size is (e.g., substantially) the same as the second size. In some embodiments, the third size (e.g., 658) is different from (e.g., smaller than) the second size (e.g., 680). The non-connected support (e.g., 672) may be provided to surround the requested material of the (e.g., densifying) intermediate 3D object (e.g., 674). Surround may comprise being adjacent to (e.g., 644). Surrounding may comprise being above (e.g., 646) and/or below (e.g., 642). Above and below may be with respect to a global vector (e.g., 651). In some embodiments, a densified intermediate object comprises (e.g., retains) gaps and/or pores (e.g., 678). In some embodiments, the non-connected support (e.g., filler material) comprises an agglomeration of particles. The agglomeration may comprise a connection (e.g., upon fusion) between at least two particles of filler material. The connection may be formed by a connection of separating material (e.g., 679). The connection may comprise a requested material. The connection may be formed from escaped inner (e.g., requested) material (e.g., 676). The agglomeration may be formed during and/or following the (e.g., densification) maturation stage. The (e.g., filler material of the) non-connected support comprising agglomeration(s) may remain flowable during and/or following the (e.g., densification) maturation stage.

In some embodiments, a formation methodology to form a (e.g., porous) filler material comprises (i) 3D printing, (ii) molding, (iii) casting, (iv) extrusion, (v) jetting, (vi) spattering (e.g., sputtering), or (vii) compression. In some embodiments, once the filler material is formed, it is (e.g., at least externally) coated with a separating material. The filler material may be formed by considering (e.g., according to) forming instructions. The forming instructions may be utilized by a (e.g., control system of) a suitable manufacturing device for forming the filler material. In some embodiments, a coating methodology for applying the separating material comprises (a) chemical vapor deposition (CVD), (b) physical vapor deposition (PVD), (c) bath deposition, (d) solvent deposition, (e) casting, (f) spraying, or (g) sputtering. In some embodiments, a coating for a filler material comprises a change in a chemical structure of at least a portion of the (e.g., external) surface of the filler material, e.g., in contrast to a coating that comprises an addition of a material. For example, the surface can be treated, e.g., chemically treated such as oxidized, reduced, and/or passivated. The chemical treatment can comprise a gas phase or a liquid phase reactant, e.g., that acts on a (e.g., external) surface of the filler material. The reactant may covalently react with at least a portion of a surface of the filler material, e.g., of an internal material of the filler material. In some embodiments, the coating comprises impregnating a first material by a second material. In some embodiments, the first material comprises a requested material, and the second material comprises a separating material. In some embodiments, the first material comprises a separating material, and the second material comprises a requested material.

In some embodiments, the formation methodology forms a shrinkable, flowable filler material comprising a dense material and/or a porous material. The dense material and/or the porous material may comprise any material disclosed herein, e.g., any requested material, internal material, and/or any separating material. In some embodiments, a formation methodology forms a shrinkable, and/or flowable filler material that comprises a coating. In some embodiments, the formation methodology forms the shrinkable, and/or flowable filler material that comprises the coating in at least two (e.g., sequential) forming procedures. For example, the formation methodology may form an inner body portion (e.g., internal portion) in a first procedure, and the coating (e.g., shell) in a second procedure. For example, the formation methodology may form the coating in a first procedure, and the inner body portion in a second procedure. In some embodiments, the formation methodology forms at least two portions of a shrinkable, and/or flowable filler material in a given forming procedure. For example, the formation methodology may form an inner body portion and a coating in a same forming procedure (e.g., formation cycle, and/or same container). For example, the formation methodology may form a dense portion and a porous portion in a same forming procedure (e.g., formation cycle, and/or container). In some embodiments, a formation methodology that forms the shrinkable, and/or flowable filler material comprises a (I) foaming, (II) spraying, (III) casting, (IV) compression, (V) extrusion, (VI) jetting, (VII) molding, (VIII) sputtering, or (IX) 3D forming (e.g., printing), methodology. In some embodiments, a formation methodology that forms a dense material comprises a (i) casting, (ii) extrusion, (iii) molding, or (iv) 3D forming, methodology. In some embodiments, a formation methodology that forms a porous material comprises a (a) foaming, (b) spraying, (c) casting, (d) compression, (e) extrusion, (f) jetting, (g) molding, (h) sputtering, or (i) 3D forming, methodology.

In some embodiments, the formation methodology forms a (e.g., porous) filler material that comprises (A) an open-cell or (B) a closed-cell, structure. A methodology for generating a porous filler material may produce a filler material comprising a pore (e.g., cell) factor. A pore factor may comprise a (a) size (e.g., FLS or volume), (b) shape, or (c) distribution (e.g., porosity percentage), of pores of the porous filler material. In some embodiments, a pore shape comprises an isotropic geometry. In some embodiments, a pore shape comprises an anisotropic geometry. In some embodiments, a methodology for generating a porous filler material produces a filler material having at least one pre-determined (e.g., controlled) pore factor. In some embodiments, a methodology for generating a porous filler material produces a filler material comprising a variable pore factor. The variable pore factor may comprise a variation in the size, shape, and/or distribution of the cells of the porous filler material. The variable pore factor may comprise a variation with respect to a location within a (e.g., given) particle of filler material. A location may comprise a depth, e.g., with respect to an outermost extent of the particle. For example, a location may comprise an inner portion (e.g., core) or an outer portion (e.g., shell). In some embodiments, at least two locations within a given particle of filler material comprise cells having a different pore factor. In some embodiments, at least two locations within a given particle of filler material comprise cells having a pore factor that is (e.g., substantially) the same.

In some embodiments, a formation methodology that forms an open-cell (e.g., open pore) structure comprises: (A) a powder metallurgy (e.g., powder sintering), (B) a foaming, (C) a combustion synthesis, (D) a CVD, (E) an electrical field-assisted powder consolidation (FAST), or (F) a 3D forming, methodology. The material provided for forming the (e.g., requested) filler material may be in a solid phase, a liquid phase, and/or a gaseous (e.g., vapor) phase, e.g., according to the given formation methodology used in forming the filler material. For example, powder metallurgy may use a solid phase (e.g., powder particle), casting may use a liquid phase (e.g., molten) material, and/or CVD may use a gaseous phase. Powder metallurgy may comprise densification (e.g., sintering) of metal powders, e.g., to form the filler material. In some embodiments, a powder metallurgy methodology comprises use of a binder for holding the powder particles before and/or during the densification operation(s). The powder metallurgy methodology may comprise (a) a space holder (e.g., binder) methodology, or (b) a replication methodology. A space holder methodology may comprise (i) mixing a (e.g., space holder) binder with (e.g., filler material) powder, (ii) compacting the mixture (e.g., forming green objects), or (iii) fusing (e.g., sintering) the green objects to (also) remove the binder. A replication methodology may comprise (I) generating a (e.g., first) porous network of a first (e.g., binder) material, (II) infiltrating the porous network with a (e.g., second) filler material (e.g., via a solvent) to form a complex of the first and second materials (e.g., composite material), or (III) fusing the complex to remove the first (e.g., binder) material, and densify the second material. Combustion synthesis may comprise (e.g., dry) mixing (e.g., powder) particles of requested filler material, pressing the mixture, and/or igniting (e.g., compressing) the mixture. Ignition may be via thermal explosion, and/or self-propagating high thermal synthesis (SHS). Ignition may comprise an exothermic reaction and/or an explosive reaction. Ignition may be initiated by application of a suitable energy source, e.g., an electrically heated coil, an electric discharge, and/or an energy (e.g., laser or particle) beam. In the FAST formation methodology, a powder of (e.g., requested) filler material is provided in a compression chamber, e.g., comprising a punch and die. The compression chamber is configured to provide uniaxial pressure to the powder, while heating (e.g., of the powder) is provided by an electrical current in two stages. A first stage comprises application of a pulsed electrical current, and a second stage comprises application of a steady (e.g., direct) current. In some embodiments, a 3D forming methodology that forms an open-cell structure may comprise any 3D forming described herein.

In some embodiments, a formation methodology that forms a closed-cell structure comprises a (I) foaming, (II) spraying, or (III) 3D forming, methodology. In some embodiments, a formation methodology that is able to form a closed-cell structure is able also to form an open-cell structure. For example, a foaming methodology may be used to generate an open-cell structure and/or a closed-cell structure. For example, a 3D forming methodology may be used to generate an open-cell structure and/or a closed-cell structure. A foaming methodology may comprise (i) melting or (ii) powder metallurgy. A melting foaming methodology may comprise a self-foaming material. A self-foaming material (e.g., structure) may be generated by gas injection through a molten material, and/or by addition of a gas forming element(s) into the liquid material (e.g., metal). A powder metallurgy foaming methodology may comprise sintering (e.g., hollow spheres) of particulates, or melting of powder compacts that contain a gas evolving element, e.g., TiH₂. A spraying methodology may comprise (a) plasma, (b) detonation, (c) wire arc, (d) flame, (e) high velocity oxy-fuel coating (HVOF), (f) high velocity air fuel (HVAF), (g) warm, or (h) cold, spraying. In some embodiments, spraying is used to generate (A) a rough (e.g., dense, or solid) surface texture, (B) a porous surface coating (e.g., on a solid core), and/or (C) a fully porous structure. During spraying, a gas is typically heated to high temperatures (e.g., up to 20,000° C.), partially ionizing it and forming a plasma jet. Material (e.g., requested filler material) to be deposited may be provided in the form of a feedstock. A feedstock may comprise a powder, a liquid, a suspension, or a wire. Spraying may comprise injecting feedstock into a (e.g., plasma) gas stream, e.g., using an accelerated carrier gas. The feedstock may be melted within the gas stream, and impacted onto a substrate with a kinetic energy sufficiently high as to cause fusion of the feedstock material. In some embodiments, a 3D forming methodology that forms a closed-cell structure may comprise any 3D forming described herein.

In some embodiments, a formation methodology that forms a closed-cell (e.g., closed pore) structure generates a filler material comprising a variable pore factor. A variable pore factor may comprise a variation in a size, shape, or distribution of pores within a (e.g., given particle of) filler material. For example, any formation methodology for forming a closed-cell structure may be used to generate a filler material having a variable pore factor. For example, a pore factor may be varied using a forming (e.g., spraying) methodology, e.g., by adjusting the forming process parameter(s). For example, spraying process parameters may comprise a gas concentration (e.g., volume/volume), a feedstock concentration (e.g., volume/volume), a power output (e.g., of a heating source), or a distance between a dispenser of the feedstock-carrying gas stream and a substrate. In some embodiments, a formation methodology that forms a closed-cell structure generates a filler material comprising a (e.g., substantially) constant pore factor. For example, a 3D forming methodology may be used to form a filler material comprising a (e.g., substantially) constant pore factor.

In some embodiments, at least two portions of a shrinkable, flowable filler material are formed by the same forming methodology. For example, a dense portion and a porous portion may be formed using the same forming methodology (e.g., molding). For example, an inner portion and a coating may be formed using the same forming methodology (e.g., sputtering). For example, a (e.g., first) porous portion having an open-cell structure and a (e.g., second) porous portion having a closed-cell structure may be formed using the same forming methodology (e.g., 3D forming). For example, a (e.g., first) porous portion having a (e.g., first) pore factor and a (e.g., second) porous portion having a (e.g., second) pore factor may be formed using the same forming methodology (e.g., spraying). In some embodiments, at least two forming methodologies are used to form a shrinkable, flowable filler material. For example, a (e.g., first) forming methodology (e.g., 3D forming) may be used to form a dense portion, and a (e.g., second) forming methodology (e.g., compression) may be used to form a porous portion. For example, a (e.g., first) forming methodology (e.g., casting) may be used to form an inner portion, and a (e.g., second) forming methodology (e.g., spraying) may be used to form a coating. For example, a (e.g., first) forming methodology (e.g., 3D forming) may be used to form a (e.g., first) porous portion having a first pore factor, and a (e.g., second) forming methodology (e.g., molding) may be used to form a (e.g., second) porous portion having a second pore factor.

In some embodiments, a 3D forming methodology is used to form a porous filler material. For example, the porous filler material may be generated by (i) providing a pre-transformed material to a target surface (e.g., of a manufacturing device); and (ii) transforming at least a portion of the pre-transformed (e.g., particulate) material into a transformed material. The transformation may include using a transforming agent, such as an energy beam, an electron beam, and/or a binder. The transformation may comprise sintering or melting (e.g., completely melting). The transformation may comprise fusing. The transformed material may (e.g., subsequently) form a hardened (e.g., solid or dense, as opposed to a liquid material) material that is porous (e.g., a porous network). The pre-transformed material may be provided by streaming it to (e.g., towards) a target surface. The transformation may be at the target surface, or adjacent (e.g., directly adjacent) to the target surface. The porous filler material may be generated by providing a first layer of pre-transformed material (e.g., powder) in an enclosure, and transforming (e.g., hardening) at least a portion of the pre-transformed material to form a first porous layer (e.g., a partially densified layer). The transforming may be effectuated (e.g. conducted) with the aid of a transforming agent. The transforming agent may travel along a path (e.g., using a scanner). The transforming agent may be dispensed in a pattern, e.g., by a dispenser. The path and/or pattern may be according to (e.g., considering) a pore factor, e.g., of the porous filler material. The 3D forming method may further comprise forming a second porous layer adjacent to the first porous layer. Adjacent to may comprise (e.g., directly) above, e.g., with respect to a global vector and/or platform above which the transformation occurs. The second porous layer may contact the first porous layer at one or more positions.

In some embodiments, at least two of the porous layers are disposed in a sandwich-like structure comprising at least one layer of pre-transformed material, e.g., that has not been transformed. At times, the porous filler material may be formed from a porous material (e.g., comprising a network) that does not comprise a layer of pre-transformed material. In some embodiments, the porous structure is of a (e.g., substantially) homogenous structure that comprises a plurality of porous layers. At times, the porous network may comprise a heterogeneous structure. At times, the porous filler material (e.g., particle) is formed from a plurality of (e.g., connected or disconnected) porous networks (e.g., layers). At least two of the plurality of porous layers may have a different structure and/or porosity percentage (e.g., pore factor). At least two of the plurality of porous network layers may have a structure and/or porosity percentage (e.g., pore factor) that is (e.g., substantially) the same.

In some embodiments, at least a portion of a porous network serves as an intermediate stage in the formation of a porous filler material. For example, a portion of the porous network may be (e.g., subsequently) densified during formation of the porous filler material. The subsequent densification may be by a transforming agent, e.g., as described herein. In some embodiments, the porous filler material is formed by re-transforming—e.g., fusing such as sintering, and/or melting—at least a portion (e.g., the entire) porous network into a denser material. In some embodiments, the porous filler material comprises at least a portion of porous network that is not (e.g., further) densified.

At times, a porous layer may be supplemented with pre-transformed material before its re-transformation and/or densification (e.g., by a transforming agent). At times, the porous layer may not be supplemented with pre-transformed material before its re-transformation and/or densification. The method may further comprise transforming the porous structure (e.g., network) to form a hard material as part of the porous filler material. The method may further comprise transforming the porous structure to form a denser material as compared to (e.g., a remainder of) the pre-densification porous structure. The denser (e.g., and hardened) material can be subsequently transformed by a third transformation operation to form a denser yet (e.g., hardened) material. The transformation operation(s) on the porous structure may be repeated until a requested density of the filler material is obtained. The filler material may comprise solid (e.g., fully dense) material. Transforming may comprise re-transforming (e.g., re-sintering and/or re-melting) the one or more porous network layers.

At times, the porous structure (e.g., set of layers) has a controlled porosity value. The porous structure (e.g., layer) may comprise at most about 10%, 20%, 30%, 40%, 50%, or 60% (e.g., dense) material, calculated as volume per volume (v/v), or area/area porosity, e.g., of a cross-section plane of maximum porosity. The porous structure may comprise any suitable percentage between the afore-mentioned values (e.g., from about 10% to about 60%, from about 10% to about 40%, or from about 40% to about 60% material, e.g., v/v, or area/area porosity, e.g., of a cross-section plane of maximum porosity). The porous structure may be formed by control of impingement of a transforming agent on a material bed portion. For example, the cross-section of an energy beam or a flux of binder agent may be (e.g., substantially) constant during the formation of the porous structure. For example, the footprint of the cross-section of the energy beam or the flux of the binder agent on the target surface may vary during formation of the porous structure. Formation of porous material by a 3D forming device is disclosed, for example, in Patent Application serial number PCT/US18/20406, filed on Mar. 1, 2018, titled “THREE-DIMENSIONAL PRINTING OF THREE DIMENSIONAL OBJECTS,” which is incorporated herein by reference in its entirety.

In some embodiments, non-connected support is provided to an intermediate 3D object during at least one maturation stage. The non-connected support may comprise providing a shrinkable, flowable filler material into a (e.g., sealable) container. The container may comprise an interior (e.g., volume) that is configured to accommodate one or more intermediate 3D objects. The interior volume may be defined by one or more containment walls of the container, and/or of a cover (e.g., for closing the container). The one or more containment walls, and/or the cover (e.g., closure), may comprise an interior surface(s) that define an outermost extent of the interior volume. The container may comprise be configured to accommodate one or more intermediate 3D objects by virtue of a dimension (e.g., size) of the interior of the container, e.g., with respect to a dimension of the one or more intermediate 3D objects.

In some embodiments, the closeable (e.g., sealable) container comprises a (e.g., detectably) similar reduction factor to an intermediate 3D object, and/or to a non-connected support. Detectably similar may comprise a reduction factor that is detectably (e.g., substantially) the same. For example, the sealable container may comprise (e.g., substantially) the same reduction factor as a green 3D object, and/or a brown 3D object. The sealable container may by formed of a material that includes (e.g., substantially) the same material as the intermediate 3D object is formed, or a material different from a material from which the intermediate 3D object is formed. The closeable container may be formed by a same manufacturing device and/or methodology that forms the intermediate 3D object. For example, the sealable container may comprise a 3D object formed by the same manufacturing device. The sealable container may be formed prior to, during, upon, and/or following formation of the requested 3D object. In some embodiments, the closeable container is formed during a formation cycle that is different from that which forms the intermediate 3D object. For example, the closeable container may be (e.g., completely) formed prior to, or following, formation of the intermediate 3D object, e.g., on the same manufacturing device. For example, the closeable container may be formed on a different manufacturing device, e.g., different than a manufacturing device that forms the intermediate 3D object. In some embodiments, the closeable container is formed during a same formation cycle as the intermediate 3D object, e.g., on a same manufacturing device. In some embodiments, formation of the closeable container shares at least one formation lap with formation of the intermediate 3D object. For example, the closeable container may be formed in situ with one or more requested 3D objects. In some embodiments, the closeable container is formed in situ with the intermediate (e.g., green-body) 3D object, and/or from the same material as the requested (e.g., intermediate) 3D object. For example, the closeable container may be formed to at least partially surround (e.g., encompass) the one or more requested 3D objects. For example, the sealable container may be formed to be adjacent to the one or more requested 3D objects.

In some embodiments, filling the (e.g., sealable) container with the filler material comprises (i) providing a given volume of filler material, or (ii) distributing the given volume of filler material (e.g., in the closeable container). The given volume of filler material may comprise a remainder of an interior volume (e.g., chamber) of the container, e.g., the volume that is not occupied by the one or more intermediate 3D objects. In some embodiments, the filler material does not fill (e.g., occupy) open portions of the one or more intermediate 3D objects that are internal to the objects (e.g., cavities). In some embodiments, the filler material fills (e.g., occupies) hollow (e.g., crevice, and/or cavity) portions of the one or more intermediate 3D objects that comprise at least one opening to an exterior surface, e.g., of the 3D objects or a bounding envelope of the 3D object. Distributing the given volume of filler material may comprise moving the (e.g., flowable) filler material into, or within, the container. Distributing the filler material may comprise evenly distributing. An evenly distributed filler material may comprise a packing density of the (e.g., particles of the) filler material that is (e.g., substantially) the same, e.g., within the region(s) of the container that are not occupied by the one or more intermediate 3D objects. An evenly distributed filler may be filler material that is contact with (I) (e.g., all) interior surfaces of the container and/or of the cover, and/or (II) (e.g. all) exterior surfaces of one or more intermediate 3D objects. Moving may comprise flowing, rolling, bouncing, oscillating, translating, or rotating. Flowing may comprise (a) a particle flow, or (b) a fluid (e.g., liquid and/or gas) flow. The movement of the filler material may be relative to the container. The filler may be introduced into the container using a hopper, a funnel, a reservoir having an opening, a channel (e.g., rigid or flexible), a roller, a shovel, and/or a blade (e.g., Doctor's blade). The filler may be introduced gravitationally (e.g., along a direction of a global vector), using a repulsive force, or using a flowable agent (e.g., carried by a gas or by a liquid). The liquid may be volatile. The liquid may comprise a volatile ether (e.g., diethyl ether), a volatile chloride (e.g., methylene chloride, or chloroform), a volatile ketone (e.g., acetone), a volatile alcohol (e.g., methanol, or ethanol), or a volatile paraffin (e.g., hexane, or heptane). The liquid may comprise an organic liquid. The liquid may comprise an inorganic liquid (e.g., water).

In some embodiments, movement of the filler material is generated by agitating, shaking, stirring, or vibrating, the (e.g., particles of) filler material. Movement of the filler material may be generated by a distribution component (e.g., of the filler material). A distribution component may comprise a cam, a chain, a conveyor (e.g., conveyor belt), a (e.g., cyclonic) separator, an emitter (e.g., of a sonicator), a lever, a gear, a moving surface (e.g., platform), a piston, a rail, a shaft, a robotic arm, a rotating screw, or a wheel. An emitter may emit an energy flux (e.g., wave), e.g., an electromagnetic wave, and/or a sound wave. For example, an emitter may emit microwave radiation. For example, an emitter may emit ultrasound waves (e.g., by a sonicator). The energy flux of the emitter may be passed through a medium (e.g., a gas, a liquid and/or a gel) to generate movement of the filler material. For example, the energy flux from the emitter may stimulate (e.g., molecules and/or particles of) the medium to produce a movement within the medium, which movement may be transferred (e.g., directly and/or indirectly) to the filler material. The distribution component may be coupled with the (e.g., particles of) filler material directly, and/or indirectly. In some embodiments, the distribution component (e.g., at least intermittently) contacts the filler material to generate its movement. For example, a gear may rotate a blade to stir the filler material. For example, a conveyor may translate the filler material, e.g., into the container. In some embodiments, the distribution component contacts the container and/or a platform that supports the container, e.g., for indirect movement of the filler material. For example, movement of the filler material may be induced by a movement of a piston that contacts at least one wall of the container, and/or of the platform that supports the container.

In some embodiments, the distribution element is coupled with one or more actuators. The actuator may comprise one or more motors, e.g., a servo-motor. The servomotors may comprise actuated linear lead screw drive motors. The motors may comprise belt drive motors. The motors may comprise rotary encoders. The motors may comprise a moving coil direct current (DC) (e.g., rotary) motor. The motors may comprise a voice coil motor. The motors may comprise a material such as copper, stainless steel, iron, rare-earth magnet, e.g., an element in the lanthanide series of the periodic chart. The motors may comprise any material disclosed herein. The actuators may comprise linear actuators. The actuator(s) may comprise one or more encoders (e.g., for positional feedback).

In some embodiments, the distribution component(s) are coupled with one or more controllers, e.g., to effectuate the movement of the filler material. Control of the distribution component(s) may comprise using a control signal and source of energy (e.g., electricity). The distribution component may use electricity, magnetic power, electrostatic power, pneumatic pressure, hydraulic pressure, or human power. The one or more controllers may control the starting of an actuator (e.g., a motor). The one or more controllers may control the stopping of the actuator. The one or more controllers may be coupled to one or more sensors. In some embodiments, at least one characteristic of the distribution of the filler material is measured by the one or more sensors. A characteristic of the distribution of the filler material may comprise (i) a packing density, (ii) a (e.g., particle) size distribution, (iii) a degree of contact with external surface(s) of an intermediate 3D object, or (iv) a degree to which a closable container is occupied (e.g., filled). The degree of contact with external surface(s) may comprise a percentage of external surface area of the intermediate 3D object with which the filler material is in contact. The degree of occupation of the closable container may comprise a fill level, or a volume/volume (e.g., v/v) occupation of a volume of the filler material within an internal volume of the closable container, e.g., that is not occupied by the intermediate 3D object. The one or more sensors may be optical, capacitive, inductive and/or mechanical. The one or more sensors may comprise one or more transducers. The one or more sensors may comprise one or more switches. The switches may comprise limit or homing switches. The one or more controllers may detect (i) a position, and/or (ii) a temperature, of the intermediate 3D object(s) and/or filler material, e.g., within the container. The one or more controllers may detect a pressure, temperature, chemical (e.g., humidity, oxygen, and/or pH), within the container. The one or more controllers may detect a chemical within the container. The detected chemical may comprise hydrogen sulfide, hydronium ion, oxygen, peroxide, ozone, or water. The one or more controllers may dynamically (e.g. in real-time during at least one maturation stage) control the actuator to adjust the position of the intermediate 3D object(s) and/or filler material. The one or more controllers may detect the need to perform distribution of the filler material. The one or more controllers may detect the completion of distributing the filler material.

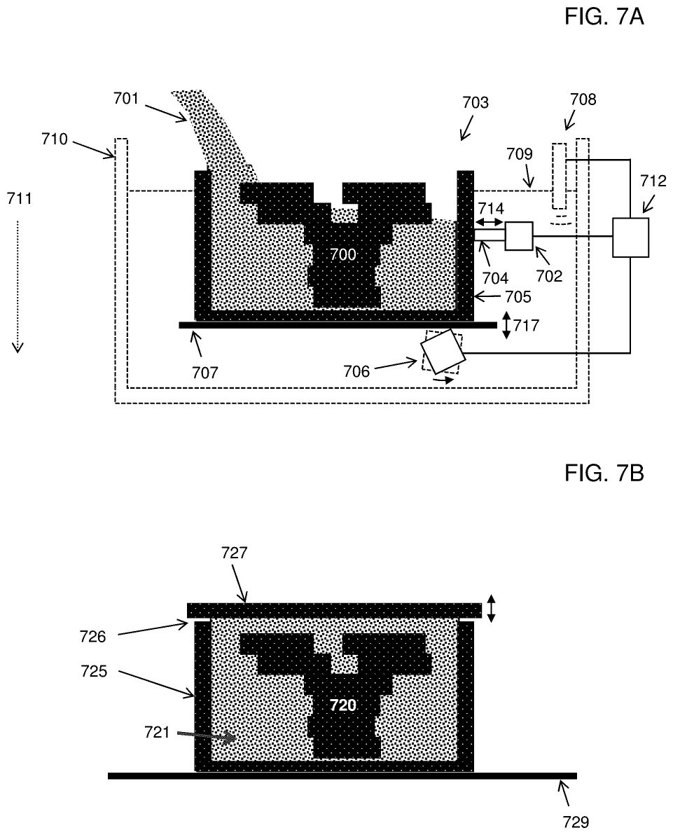

FIG. 7A depicts an example of a (e.g., sealable) container 703 that accommodates an intermediate 3D object 700 and is filled by a filler material 701. FIG. 7A depicts an example platform 707 above which the container is supported. The platform may support the container directly or indirectly. The container may be anchored or non-anchored to the platform. One or more distribution components may be coupled with the container and/or the filler material. The one or more distribution components may facilitate (e.g., direct) ingress of the filler to the container. The filler may flow into the container. The flow may be activated by a force. The force may comprise gravity, magnetic force, electrostatic force, mechanical force, hydraulic force, hydrostatic force, or manual force. The one or more distribution components may be operatively coupled to a source of the force. The one or more distribution components may be utilize (e.g., take advantage of) the force. The filler may flow using a carrier (e.g., gas or liquid). The force source may comprise a pump (e.g., vacuum or pressure pump). The one or more distribution components may generate a movement of the filler material and/or the container. The movement of the filler may be in the container. The movement may be horizontal (e.g., 714) and/or vertical (e.g., 717), e.g., with respect to a global vector (e.g., 711). The one or more distribution components may generate movement of the filler material directly and/or indirectly. The one or more distribution components may generate a movement of the filler that is in the container. In the example of FIG. 7A, an optional rotable object (e.g., gear) 706 is positioned to move the platform that supports the container; an optional piston 704 is positioned to contact a wall 705 to move the container; and an optional sonicator 708 is positioned within a medium 709 by which the container is at least partially surrounded, the medium contained within a retaining vessel (e.g., vat) 710. In some embodiments, the medium comprises a liquid, a gas, or a semi-solid (e.g., a gel). The liquid may comprise a polar liquid, an ionic liquid, an organic liquid or, an inorganic liquid (e.g., any liquid disclosed herein). In some embodiments, a distribution component is coupled with an actuator (e.g., 702). In some embodiments, a distribution component and/or an actuator is coupled with one or more controllers (e.g., 712).

In some embodiments, a closeable container that accommodates a (e.g., intermediate) 3D object comprises a cover (e.g., closure) by which the container is closed (e.g., sealed). The cover may comprise a lid, a door, or a (e.g., portion of a) wall. The closure may change its position to allow the movement of the 3D object and/or filler. The movement may be to and/or from the container interior. The change of position of the closure may be by sliding, flapping, pushing, magnetic opening or rolling. For example, the closure may be a sliding, flapping, or rolling door. The closure (e.g., seal) may be operatively coupled to an actuator. The actuator may cause the closure to alter its position (e.g., as described herein). The actuator may cause the closure to slide, flap, pivot, or roll (e.g., in a direction). The direction may be up, down, and/or sideways, with respect to a prior position of the closure. The actuator may be controlled, e.g., by at least one controller and/or manually. Altering the position may be laterally, horizontally, or at an angle with respect to the global vector and/or the platform. For example, the actuator may be controlled via at least one sensor (e.g., as disclosed herein). The sensor may comprise a position or motion sensor. The sensor may comprise an optical sensor. For example, the closure may be coupled to a dispensing mechanism that is configured to dispense the filler (e.g., into the container). Coupling may be using mechanical, electrical, electro-magnetic, pneumatic, or magnetic connectors. The closure may slide, open, pivot, and/or roll when contacted (e.g., pushed) by the dispensing mechanism. The closure may slide, close, open, pivot, or roll when the dispensing mechanism retracts from an opening of the container. The closure (e.g., cover) may be formed of a same material as a (e.g., remainder of a) body of the container. The cover may be operable (e.g., adapted) to seal an internal volume of the container, e.g., that accommodates the intermediate 3D object. The seal may be powder tight, liquid tight, and/or gas tight. In some embodiments a closure is operable for reversible coupling with at least one wall of the container. In some embodiments, the closure is sized to be larger than (e.g., to fully cover) an opening in an at least one wall of the container. The cover may be sized to be (e.g., substantially) a same size, or to be larger than, or to be smaller than, the size of an opening of the container to which it couples. The opening may be surrounded by a sealant. The sealant may be a flexible and/or compressible material, such as rubber. The (e.g., reversible) coupling of the container with the closure may comprise sealing, e.g., when the cover is fully coupled and/or engaged with the container (e.g., with an opening thereof). In some embodiments, the sealing is hermetic. In some embodiments, the sealing prevents the filler (e.g., and the 3D object) from exiting the container, e.g., during the maturation stage(s). In some embodiments, the sealing permits environmental (e.g., fluid) exchange, e.g., from an interior environment to an environment that is external to the container.

FIG. 7B depicts an example of a (e.g., sealable) container 725 having a closure (e.g., cover) 727 configured for closing an opening of the container. The container may accommodate a (e.g., intermediate) 3D object (e.g., 720) that is surrounded by a non-connected support (e.g., 721). The closure may close (e.g., seal) the container such that the non-connected support maintains contact with surfaces of the intermediate 3D object, e.g., to prevent deformation during and/or following at least one maturation stage. The example container is supported by (e.g., rests upon) a platform 729. The example container and cover comprises a gap 726 enabling environmental (e.g., fluid) exchange with an interior of the container. The container may comprise a valve, e.g., or be operatively coupled to a valve, to facilitate pressure equilibration. The cover may be reversibly engageable with the container (e.g., FIG. 7B, double-headed arrow). In some embodiments, the container includes a plurality of openings. The container may be configured to couple to a plurality of closures, e.g., that are configured to close the plurality of openings (e.g., respectively).

In some embodiments, the closure is controlled to couple and to de-couple (e.g., detach) from the container. One or more coupling members may be disposed on the closure (e.g., cover) and/or the container, the coupling members configured to reversibly secure the cover to the container. The coupling members may comprise a lever, a pin, a threaded fastener, a flap, a button, a valve, a latch, or a spring. To reversibly secure may comprise, (i) in a secured position, mating a face of the cover with a (e.g., corresponding) face (e.g., wall) of the container to close (e.g., seal) the container, and (ii) in an open (e.g., released) position, freeing the cover from the container. In some embodiments, freeing the cover from the container comprises maintaining at least one coupling between the cover and the container. In some embodiments, freeing the cover from the container comprises (e.g., complete) removal of the cover from the container. Control may be manual and/or automatic. Control may be by one or more controllers, e.g., individually and/or collectively. Control may comprise manipulation of at least one coupling member by a control member, e.g., comprising an actuator such as a motor, a drive, or a pump.

At times, one or more 3D objects are subjected to one or more maturation stages in the container (e.g., simultaneously, and/or sequentially). The container may comprise a (e.g., predetermined) pressure, or atmosphere, e.g., prior to, during, upon, and/or following the one or more maturation stages. Predetermined may comprise controlled. The control may be manual, or via at least one controller (e.g., control system). The atmosphere may comprise at least one gas. The container may comprise an (e.g., substantially) inert atmosphere. The atmosphere in the container may be (e.g., substantially) depleted of one or more gases that are present in the ambient atmosphere. The atmosphere in the container may include a reduced level of one or more gases relative to the ambient atmosphere. For example, the atmosphere may be (e.g., substantially) depleted, or have reduced levels of, water (i.e., humidity), oxygen, nitrogen, carbon dioxide, hydrogen sulfide, or any combination thereof. The depleted or reduced level of gas may be at most about 1 ppm, 10 ppm, 50 ppm, 100 ppm, 500 ppm, 1000 ppm, 5000 ppm, 10000 ppm, 25000 ppm, 50000 ppm, or 70000 ppm, volume by volume (v/v). The level of the gas (e.g., depleted or reduced level gas, oxygen, or water) may be between any of the afore-mentioned levels of gas (e.g., from about 1 ppm to about 70000 ppm, from about 1 ppm to about 5000 ppm, or from about 5000 ppm to about 70000 ppm). The atmosphere may comprise air. The atmosphere may be inert. The atmosphere may be non-reactive. Non-reactive may be with the filler, container (e.g., internal wall(s) thereof), pre-transformed requested material, transformed requested material, transforming requested material, and/or binder. Non-reactive may comprise a reaction occurring before, during, upon, and/or after the maturation stage(s). The atmosphere may be non-reactive with at least one material within the container. The material in the container may comprise the requested material of the intermediate 3D object, or the filler material. The atmosphere may reduce a likelihood of (e.g., prevent) oxidation, reduction, and/or any chemical (e.g. surface) treatment of the requested 3D object, e.g., during a maturation stage. The atmosphere may prevent reaction with the requested 3D object before maturation, during maturation, after maturation, or any combination of the above. The atmosphere may comprise a Nobel gas. The atmosphere may comprise argon gas or nitrogen gas. The atmosphere can comprise a gas selected from the group consisting of argon, nitrogen, helium, neon, krypton, xenon, hydrogen, carbon monoxide, and carbon dioxide. The atmosphere may comprise a (e.g., safe) amount of hydrogen gas. The atmosphere may comprise a v/v percent of hydrogen gas of at most about 0.05%, 0.1%, 0.2%, 0.3%, 0.4%, 0.5%, 0.7%, 0.8%, 0.9%, 1%, 2%, 3%, 4%, or 5%, at ambient pressure (e.g., and ambient temperature). The atmosphere may comprise any (e.g., v/v) percentage of hydrogen between the afore-mentioned percentages of hydrogen gas (e.g., from about 0.05% to about 5%, from about 0.05% to about 1%, or from about 1% to about 5%). Ambient may refer to an environment external to the container. Ambient may refer to a condition to which people are generally accustomed. For example, ambient pressure may be 1 atmosphere. Ambient temperature may be a typical temperature to which humans are generally accustomed. For example, ambient temperature may be −30° C., −10° C., 0° C., 10° C., 20° C., 30° C., 40° C., or 50° C. Ambient temperature may be any temperature between the afore-mentioned values (e.g., from about −30° C. to about 50° C., from about −30° C. to about 20° C., or from about 20° C. to about 50° C.).

In some embodiments, the (e.g., sealed) container comprises an ambient pressure (e.g., 1 atmosphere), a negative pressure (e.g., vacuum), or a positive pressure, e.g., during the maturation stage(s). The vacuum may comprise a pressure below 1 bar, or below 1 atmosphere. The positive pressurize may comprise pressure above 1 bar or above 1 atmosphere. The pressure in the container can be at least about 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, or 100 Torr. The pressure in the container can be at least about 1 bar, 2 bar, 3 bar, 4 bar, 5 bar, 10 bar, 20 bar, 30 bar, 40 bar, bar, 100 bar, 200 bar, 300 bar, 400 bar, 500 bar, 1000 bar, or 1100 bar. The pressure in the container can be at least about 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the container can be between any of the afore-mentioned container pressure values (e.g., from about 10⁻⁷ Torr to about 1200 Torr, from about 10⁻⁷ Torr to about 1 Torr, from about 1 Torr to about 1200 Torr, or from about 10⁻² Torr to about 10 Torr). In some cases, the container pressure can be standard atmospheric pressure. The pressure may be measured at an ambient temperature (e.g., room temperature, 20° C., or 25° C.). During a maturation stage, the internal volume of the container may or may not be subject to a pressure gradient. For example, the internal volume of the (e.g., closed) container may be devoid of any (e.g., substantial) pressure gradient during the maturation stage(s).

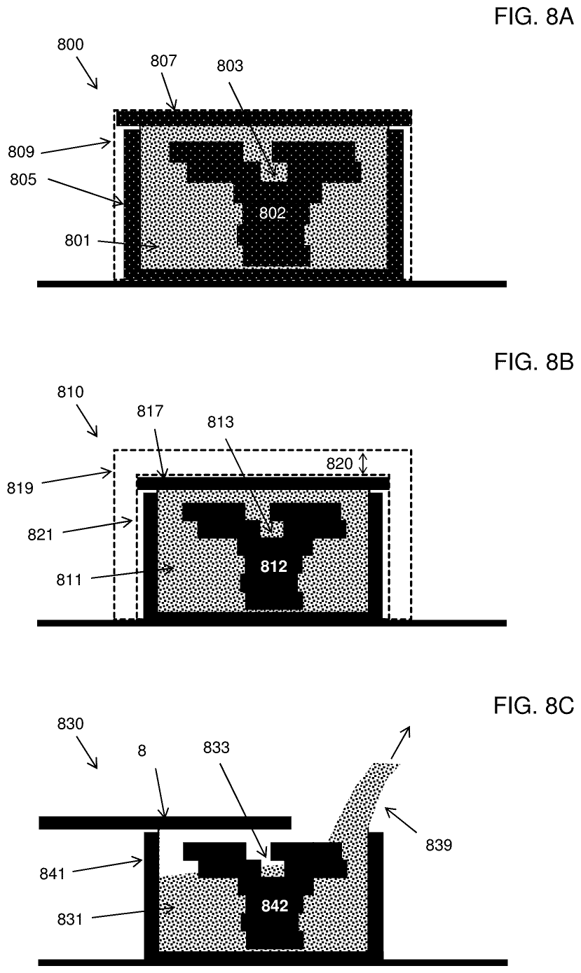

In some embodiments, the container, closure (e.g., cover), intermediate 3D object, and/or non-connected support comprise (e.g., components of) an assembly. The assembly may be referred to herein as a “maturation assembly.” The assembly may comprise the intermediate 3D object positioned within the container. The container may be filled with the non-connected support (e.g., filler material), and closed by a closure (e.g., cover). FIG. 8A depicts an example assembly 800. The example assembly of FIG. 8A comprises an intermediate object 802 that is positioned within a container 805, closed by a cover 807. FIG. 8A depicts an example of non-connected support 801 (e.g., a filler material) that fills the closed container and surrounds the intermediate 3D object. In some embodiments, a non-connected support may be disposed (e.g., positioned) within a (e.g., sealable) container to surround an intermediate 3D object such that, upon closing the container opening(s), exterior surfaces of the intermediate 3D object are (e.g., solely) in contact with the non-connected support. For example, exterior surfaces of the intermediate 3D object may be devoid of contact with the container (e.g., or cover). The non-connected support may be positioned (e.g., filled) to contact hollow portions (e.g., 803) of the intermediate 3D object (e.g., crevices). The assembly may comprise an initial (e.g., first) size (e.g., 809), prior to a maturation stage.

In some embodiments, the assembly is subjected to at least one maturation stage. In some embodiments, the container is configured to contract in a like manner to the (e.g., green body) intermediate 3D object, and/or the filler material (e.g., separating substance), e.g., during the maturation (e.g., densification) stage. In some embodiments, the contraction of the container (e.g., that is sealed) compresses the filler material (e.g., including its interior portion and/or separating material), which remains in contact with surfaces of the (e.g., pre-densified) intermediate 3D object, e.g., for support to prevent deformation as it densifies (e.g., contracts). The filler material may contract upon compression. In some embodiments, the container, filler material (e.g., separating substance), and (e.g., pre-densified) intermediate 3D object may have a similar (e.g., same) volume reduction factor during the densification stage. In some embodiments, the intermediate 3D object that is positioned in the container comprises connected support(s), e.g., that are formed during a formation cycle of the 3D object. The connected support(s) may be auxiliary supports. In some embodiments, the intermediate 3D object that is positioned in the container is devoid of connected supports. FIG. 8B comprise an example assembly 810. In the example of FIG. 8B, an intermediate 3D object 812 is positioned within a closed container 817 during a maturation stage. The example of FIG. 8B depicts non-connected support 811 (e.g., a filler material) that fills the sealed container and surrounds the intermediate 3D object. The conditions of the maturation stage may densify one or more components of the assembly. The components of the assembly may exhibit a (e.g., substantially) similar reduction in size (e.g., volume and/or FLS) during the at least one maturation stage. The reduction in size may be from a first size to a second size. The first size may correspond to a (e.g., initial) size of an assembly prior to subjecting the assembly to the conditions of a given maturation stage. The second size may correspond to a (e.g., final) size of the assembly during and/or following subjecting the assembly to the conditions of the given maturation stage. For example, the components of the assembly may comprise a (e.g., substantially) similar reduction factor. In the example of FIG. 8B, the assembly comprises an initial (e.g., first) size 819 and a final (e.g., second) size 821. The final (e.g., second) size may be related to the initial (e.g., first) size according to a reduction factor (e.g., 820). The non-connected support may contact exterior surfaces of the intermediate 3D object for at least part of the maturation stage. To contact may comprise to remain in contact, e.g., prior to, during, upon, and/or following the maturation stage(s). For example, the non-connected support may contact hollow portions (e.g., 813) of the intermediate 3D object (e.g., crevices), e.g., at least during the maturation stage. The hollow portion may be a cavity. To remain in contact may comprise to exert a (e.g., predetermined) force and/or pressure, e.g., on surfaces of the intermediate 3D object. The non-connected support (e.g., filler material) may move (e.g., flow) at least during the maturation stage. In some embodiments, the non-connected support remains in contact with surfaces of the intermediate 3D object and/or the container while moving.

In some embodiments, at least one component of a maturation assembly is removed from a closeable (e.g., sealable) container following a maturation stage. For example, a (e.g., matured) 3D object may be removed from the container following a maturation stage. The matured 3D object that is removed may be a consolidated (e.g., densified) object, e.g., with respect to a state of the 3D object prior to the maturation stage. For example, the matured 3D object may be a brown object that is formed by maturing a green object. For example, the matured 3D object may be a (e.g., final) requested 3D object that is formed by maturing (e.g., densifying) a brown object. In some embodiments, removal of at least one component comprises removal of a non-connected support from the container. The removal of the non-connected support may occur prior to, during, upon (e.g., concurrently with), and/or following the removal of the matured 3D object from the container. The removal of the non-connected support may comprise removal from surfaces of the matured 3D object. FIG. 8C depicts a maturation assembly 830 following (e.g., completion of) a maturation stage. In the example of FIG. 8C, a container 841 comprises a closure (e.g., cover) 837 that is partially opened, e.g., by sliding the cover relative to the container opening, to allow removal of a non-connected support (e.g., filler material) 831. Removal of the non-connected support may comprise moving (e.g., flowing) filler material (e.g., 839), e.g., out of an opening in the container. Removal of non-connected support may comprise removal from surfaces of a (e.g., final) matured 3D object (e.g., 840). The removal from surfaces of the matured 3D object may comprise recessed and/or hollow portions (e.g., 833) of the matured 3D object.

In some embodiments, removal of at least one component of a maturation assembly is performed manually. In some embodiments, removal of the at least one component of the maturation assembly is performed automatically. In some embodiments, the removal is facilitated by (i) an (e.g., human) operator, and/or (ii) an apparatus (e.g., removal system). A removal system may comprise an enclosure, a chamber, a base (e.g., platform), a (e.g., sealable) container, or one or more removal components. A removal system may comprise at least one wall. A removal component may comprise a robot (e.g., a robotic arm), a motor, a tweezer, a hook, a swivel axis, a joint, a spring, a crane, or a gripper. The removal system may comprise a force source (e.g., as disclosed herein). The force source may attract the filler material, and/or the 3D object(s). The removal system may comprise a channel (e.g. a hose). The channel may be configured to facilitate flow of the filler material therethrough. The channel may comprise a rigid or a flexible portion. The removal system may comprise an opening. The opening may be configured to facilitate flow the material removal therethrough. The channel and/or opening may be configured to facilitate the intermediate and/or matured 3D object to travel therethrough. A removal component may comprise a component that is similar to (e.g., the same as) a distribution component. The removal system may facilitate removal of the at least one component by movement of (A) the (e.g., densified) 3D object, (B) the filler material, and/or (C) the container. The movement of the at least one component may be prior to, during, upon (e.g., concurrently with), and/or following removal of the densified 3D object from the container. The removal system may comprise a metal, a ceramic, or any material disclosed herein. The (e.g., sealable) container may comprise a first atmosphere, an external environment may comprise a second atmosphere, and the removal system may comprise a third atmosphere. An external environment may be an (e.g., ambient) environment that is external to the (e.g., sealable) container and/or to the removal system. At least two of the first, second, and third atmospheres may be (e.g., detectibly) the same. At least two of the first, second, and third atmosphere may differ. Differ may be in material (e.g., gaseous) composition and/or pressure. For example, the pressure in the (e.g., sealable) container may be higher than in the external environment. For example, the pressure in the (e.g., sealable) container may be higher than in the removal system (e.g., before unsealing the container). For example, the pressure in the (e.g., sealable) container may be lower than in the removal system (e.g., before unsealing the container). For example, the pressure in the (e.g., sealable) container may be lower than in the external environment. The first and/or the third atmosphere may have a pressure above ambient pressure. The pressure above ambient pressure may deter reactive agents from the ambient atmosphere to penetrate into an enclosure having a positive atmospheric pressure, e.g., during the maturation stage(s). The atmosphere within the chamber of the removal system may be controlled. The chamber of the removal system may comprise at least one port (e.g., in a wall of the chamber) that accommodates a membrane. The membrane may be operable (e.g., configured) to maintain an atmosphere within the chamber. In some embodiments, a removal component can be manipulated through the membrane.

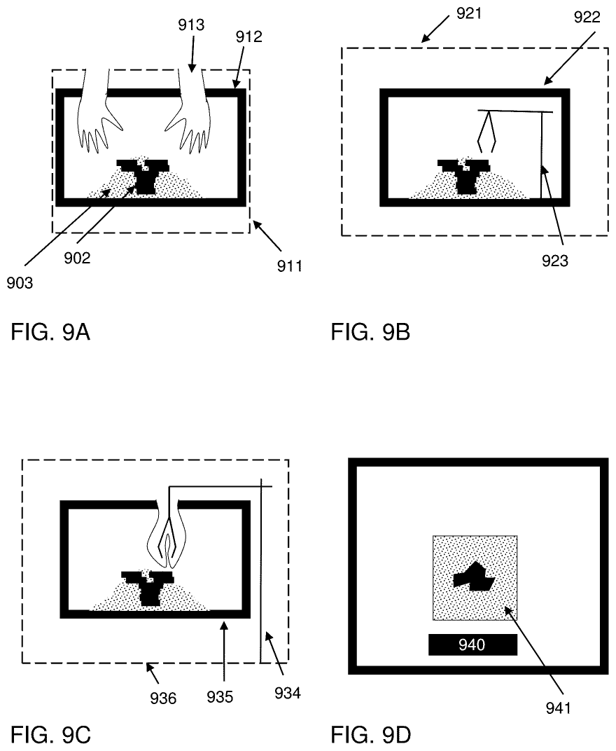

The (e.g., intermediate, matured, or densified) 3D object (e.g., FIG. 9A, 902) may be removed from the non-connected support (e.g., filler material) (e.g., FIG. 9A, 903). The removal may be in a controlled (e.g., inert) atmosphere. The removal may comprise using a human or a machine. The removal may comprise using a removal component. The removal may be fully automatic, partially automatic, or manual. FIGS. 9A-9C show examples of a (e.g., densified) 3D object removal using manual intervention (e.g., FIG. 9A), or mechanical intervention, e.g., via a removal component (e.g., FIG. 9B or 9C). The manual intervention may comprise using a glove box. The removal component (e.g., FIG. 9B, 923) may be disposed in a chamber of the removal system (e.g., FIG. 9B, 922). The removal component (e.g., FIG. 9C, 934) may be disposed in an enclosure of the removal system (e.g., FIG. 9C, 936). The removal component (e.g., FIG. 9C, 934) may be disposed outside of a chamber of the removal system (e.g., FIG. 9C, 935). The removal component may be disposed outside of the enclosure of the removal system. At least one side of a chamber of the removal system (e.g., 912) may be in contact with at least one respective side of the removal system enclosure (e.g., 911). At times, at least one side of a chamber of the removal system (e.g., 922) may not be in contact with at least one respective side of the removal system enclosure (e.g., 921). The removal component may be controlled by a controller (e.g., locally, or remotely). The remote control may use a remote input device. The remote control may use a remote console device (e.g., a joystick). The controller may use a gaming console device. The controller may use a home video game console, handheld game console, microconsole, a dedicated console, or any combination thereof. The local controller may be directly connected to the removal system (e.g., using one or more wires), or through a local network (e.g., as disclosed herein). The local controller may be stationary or mobile. The remote controller may connect to the removal system through a network that is not local. The remote controller may be stationary or mobile. The removal system may comprise its own controller. The controller may control (e.g., direct, monitor, and/or regulate) (I) a temperature, (II) a pressure, (III) an atmosphere, and/or (IV) one or more components (e.g., of the removal system).

In some embodiments, non-connected support (e.g., filler material) is removed from the (e.g., densified) 3D object, e.g., facilitated by the removal system. In some embodiments, filler material is removed from within the chamber of the removal system by suction (e.g., vacuum), gas blow, mechanical removal, magnetic removal, or electrostatic removal. Manners of material removal are disclosed, for example, in Patent Application serial number PCT/US15/36802, filed on Jun. 19, 2015, titled “APPARATUSES, SYSTEMS AND METHODS FOR THREE-DIMENSIONAL PRINTING,” which is incorporated herein by reference in its entirety. Removal of the filler material may comprise shaking the filler material (e.g., particles) from the densified 3D object. The shaking may comprise vibrating. Vibrating may comprise using a motor. Vibrating may comprise using a vibrator or a sonicator. The vibration may comprise ultrasound waves, sound waves, or mechanical force. For example, the 3D object may be disposed on a scaffold that vibrates. The ultrasonic waves may travel through the atmosphere of the chamber of the removal system. The ultrasonic waves may travel through a (e.g., filler) material bed disposed in the chamber of the removal system. The scaffold may comprise a sieve. The sieve may be disposed below the 3D object. The sieve may disposed adjacent to the 3D object. The 3D object may be moved over the (e.g., adjacent) sieve to facilitate removal of the filler material. The scaffold may be tilted at an angle that allows the filler material to separate from the 3D object. The scaffold may be rotated in a way that allows the filler material to separate from the 3D object (e.g., a centrifugal rotation). The scaffold may comprise a rough surface that can hold the 3D object (e.g., using friction). The scaffold may comprise hinges that prevent slippage of the 3D object (e.g., during the vibrating operation). The scaffold may comprise one or more holes. The scaffold may comprise a mesh. The one or more holes or mesh may allow the filler material to pass through, and prevent the 3D object from passing through, e.g., such that the 3D object is held on an opposite side of the mesh from the removed filler material. FIG. 9D shows an example of a top view of a scaffold 940 upon which filler material 941 rests.

The material (e.g., pre-transformed material, transformed material, requested material, and/or filler material) may comprise elemental metal, metal alloy, ceramics, an allotrope of elemental carbon, a polymer, or a resin. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball or a carbon nanotube. The ceramic material may comprise cement. The ceramic material may comprise alumina. The material may comprise sand, glass, stone, or molecular sieve. In some embodiments, the material may comprise an organic material, for example, a polymer or a resin. The organic material may comprise a hydrocarbon. The polymer may comprise styrene. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The solid material may comprise powder material. The powder material may be coated by a coating. The material may comprise an inorganic material. The coating may comprise an inorganic material (e.g., an oxide). The coating may comprise an organic coating such as the organic material (e.g., plastic coating). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) or wires.

In some embodiments, an intermediate 3D object comprises a single type of material. For example, the 3D object (e.g., a layer thereof) may comprise a single elemental metal type, or a single metal alloy type. In some examples, the 3D object comprises several types of material. For example, the 3D object may comprise several types of material (e.g., an elemental metal and an alloy, an alloy and a ceramic, an alloy and an allotrope of elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member (e.g., an allotrope) of elemental carbon (e.g., graphite). In some embodiments, the 3D object comprises more than one member of a material type.

The elemental metal can be an alkali metal, an alkaline earth metal, a transition metal, a rare-earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare-earth metal can be a lanthanide, or an actinide. The lanthanide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

The metal alloy can be an iron-based alloy, nickel-based alloy, cobalt-based alloy, chrome-based alloy, cobalt-chrome-based alloy, titanium-based alloy, magnesium-based alloy, copper-based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, or tablet), air conditioning, generators, furniture, musical equipment, art, jewelry, cooking equipment, or sport gear. The metal (e.g., alloy or elemental) may comprise an alloy used for products for human or veterinary applications comprising implants, or prosthetics. The metal alloy may comprise an alloy used for applications in the fields comprising human or veterinary surgery, implants (e.g., dental), or prosthetics.

The alloy may include a superalloy. The alloy may include a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy (e.g., Haynes 282), Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron alloy comprises Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may include cast iron, or pig iron. The steel may include Bulat steel, Chromoly, Crucible steel, Damascus steel, Hadfield steel, High speed steel, HSLA steel, Maraging steel (e.g., M300), Reynolds 531, Silicon steel, Spring steel, Stainless steel, Tool steel, Weathering steel, or Wootz steel. The high-speed steel may include Mushet steel. The stainless steel may include AL-6XN, Alloy 20, celestrium, marine grade stainless, Martensitic stainless steel, surgical stainless steel, or Zeron 100. The tool steel may include Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade such as 440F, 410, 312, 430, 440A, 440B, 440C, 304, 305, 304L, 304L, 301, 304LN, 301LN, 2304, 316, 316L, 316LN, 317L, 2205, 409, 904L, 321, 254SMO, 316Ti, 321H, 17-4, 15-5, 420, or 304H. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may include 316LVM. The steel may include 17-4 Precipitation Hardening steel (also known as type 630, a chromium-copper precipitation hardening stainless steel, 17-4PH steel).

The titanium-based alloys may include alpha alloys, near alpha alloys, alpha and beta alloys, or beta alloys. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy includes Ti-6Al-4V or Ti-6Al-7Nb.

The Nickel alloy may include Alnico, Alumel, Chromel, Cupronickel, Ferronickel, German silver, Hastelloy, Inconel, Monel metal, Nichrome, Nickel-carbon, Nicrosil, Nisil, Nitinol, Hastelloy-X, Cobalt-Chromium, or Magnetically “soft” alloys. The magnetically “soft” alloys may comprise Mu-metal, Permalloy, Supermalloy, or Brass. The brass may include Nickel hydride, Stainless or Coin silver. The cobalt alloy may include Megallium, Stellite (e. g. Talonite), Ultimet, or Vitallium. The chromium alloy may include chromium hydroxide, or Nichrome.

The aluminum alloy may include AA-8000, Al—Li (aluminum-lithium), Alnico, Duralumin, Hiduminium, Kryron Magnalium, Nambe, Scandium-aluminum, or Y alloy. The magnesium alloy may be Elektron, Magnox, or T-Mg—Al—Zn (Bergman phase) alloy.

The copper alloy may comprise Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may include Calamine brass, Chinese silver, Dutch metal, Gilding metal, Muntz metal, Pinchbeck, Prince's metal, or Tombac. The Bronze may include Aluminum bronze, Arsenical bronze, Bell metal, Florentine bronze, Guanin, Gunmetal, Glucydur, Phosphor bronze, Ormolu, or Speculum metal. The copper alloy may be a high-temperature copper alloy (e.g., GRCop-84).

In some examples, the material (e.g., powder material) comprises a material wherein its constituents (e.g., atoms or molecules) readily lose their outer shell electrons, resulting in a free-flowing cloud of electrons within their otherwise solid arrangement. In some examples, the material is characterized in having high electrical conductivity, low electrical resistivity, high thermal conductivity, or high density (e.g., as measured at ambient temperature (e.g., R.T., or 20° C.)). The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the afore-mentioned electrical conductivity values (e.g., from about 1*10⁵ S/m to about 1*10⁸ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the afore-mentioned electrical resistivity values (e.g., from about 1×10⁻⁵ Ω*m to about 1×10⁻⁸ Ω*m). The high thermal conductivity may be at least about 20 Watts per meters times Kelvin (W/m*K), 50 W/m*K, 100 W/m*K, 150 W/m*K, 200 W/m*K, 205 W/m*K, 300 W/m*K, 350 W/m*K, 400 W/m*K, 450 W/m*K, 500 W/m*K, 550 W/m*K, 600 W/m*K, 700 W/m*K, 800 W/m*K, 900 W/m*K, or 1000 W/m*K. The high thermal conductivity can be any value between the afore-mentioned thermal conductivity values (e.g., from about 20 W/m*K to about 1000 W/m*K). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore-mentioned density values (e.g., from about 1 g/cm³ to about 25 g/cm³).

In some examples, a metallic material (e.g., elemental metal or metal alloy) comprises small amounts of non-metallic materials, such as, for example, oxygen, sulfur, or nitrogen. In some cases, the metallic material comprises the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (based on weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, ppm, 100 ppm, 500 ppm, 1000 ppm, or 10000 ppm (based on weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

In some embodiments, a formation device is used to form (i) a filler material, and/or (ii) a requested 3D object (e.g., via an intermediate state). FIG. 10 shows an example of a 3D forming system 1000 (also referred to herein as “3D printer”) and apparatuses, comprising a transforming agent generator that generates a transforming agent. In the example of FIG. 10, a (e.g., first) energy source 1021 emits an (e.g., first) energy beam 1001 and an (e.g., second) energy source 1022 that emits a (e.g., second) energy beam 1011. In some embodiments, at least two transforming agents of a 3D forming system may be overlapping (e.g., at a target surface of the 3D forming system). In the example of FIG. 10 the energy from energy source 1021 travels through a (e.g., first) guidance system 1020 (e.g., comprising a scanner) and an optical window 1015 to be incident upon a target surface 1040 within an enclosure 1026 (e.g., comprising an atmosphere). The enclosure can comprise one or more walls that enclose the atmosphere. The target surface may comprise at least one layer of pre-transformed material (e.g., FIG. 10, 1008) that is disposed adjacent to a platform (e.g., FIG. 10, 1009). Adjacent can be above. In some embodiments, an elevator shaft (e.g., FIG. 10, 1005) is configured to facilitate movement of the platform (e.g., vertically; FIG. 10, 1012). The enclosure (e.g., 1032) may including sub-enclosures comprising an optical chamber (e.g., 1031), a processing chamber (e.g., 1007), and a build module (e.g., 1030). The sub-enclosures (e.g., chambers) may be reversibly detachable from each other, e.g., manually and/or automatically (e.g., using at least one controller). The chamber wall(s) may comprise any material disclosed herein, e.g., elemental metal, metal alloy, an allotrope of elemental carbon, ceramic, a polymer, a resin, or glass. The platform may be separated from one or more walls (e.g., side walls) of the build module by a seal (e.g., FIG. 10, 1003).

The guidance system of the energy beam may comprise a guidance mechanism (e.g., scanner and/or actuator). A guidance system may guide a transforming agent (e.g., from a transforming agent generator) to impinge upon a target surface (e.g., any target surface as described herein), and/or direct (e.g., pre-transformed) material towards the target surface. FIG. 10 shows the energy from the energy source 1022 travels through an optical system 1014 (e.g., comprising a scanner) and an optical window 1035 to impinge (e.g., be incident) upon the target surface 1040. The energy from the (e.g., plurality of) energy source(s) may be directed through the same optical system and/or the same optical window. At times, energy from the same energy source is directed to form a plurality of energy beams by one or more optical systems. The target surface may comprise a (e.g., portion of) transformed material (e.g., FIG. 10, 1006) formed via transformation of pre-transformed material in a material bed (e.g., FIG. 10, 1004). In the example of FIG. 10, a layer forming device 1013 includes a (e.g., powder) dispenser 1016, a leveler 1017, and material removal mechanism 1018. During formation, the filler material and/or intermediate 3D object (e.g., and the material bed) may be supported by a (e.g., movable) platform, which platform may comprise a base (e.g., FIG. 10, 1002). The base may be detachable (e.g., after the printing). A hardened material may be anchored to the base (e.g., via supports and/or directly), or non-anchored to the base (e.g., floating anchorlessly in the material bed, e.g., suspended in the material bed).

In some cases, one or more controllers control the operation of one or more components of a maturation device and/or a manufacturing device. For example, one or more controllers may control one or more aspects (e.g., temperature and/or pressure) of the maturation device. For example, one or more controllers may control one or more aspects (e.g., movement and/or speed) of a layer forming apparatus of the manufacturing device. One or more controllers may control one or more aspects of a transforming agent generator (e.g., energy beam power, scan speed and/or scan path). One or more controllers may control one or more aspects of a guidance system (e.g., energy beam scan path and/or energy beam focus). One or more controllers may control one or more operations of a gas flow system (e.g., gas flow speed and/or direction). In some embodiments, one or more controllers control aspects of multiple components or systems. For example, a first controller can control aspects of the energy source(s), a second controller can control aspects of a layer forming apparatus(es), and a third controller can control aspects of a gas flow system. In some embodiments, one or more controllers control aspects of one component or system. For example, multiple controllers may control aspects of an optical system. For instance, a first controller can control the path of the one or more energy beams, a second controller may control scan speed of the one or more energy beams, and a third controller may control a focus of the one or more energy beams. As another example, multiple controllers may control aspects of a transforming agent generator. For example, a first controller can control the power of one or more energy beams, a second controller may control pulsing (e.g., pulse versus continuous, or pulse rate) of the one or more energy beams, and a third controller may control a power profile over time (e.g., ramp up and down) one or more energy beams. For example, multiple controllers may control aspects of a maturation device. For example, a first controller can control a temperature (e.g., profile), and a second controller may control a pressure (e.g., profile), of a chamber of the maturation device. At times, the first controller, second controller, and the third controller are the same controller. At times, at least two of the first controller, second controller, and the third controller are different controllers. Any combination of one or more controllers may control aspects of one or more components or systems of a maturation device and/or a manufacturing device. The one or more controllers may control the operations before, during, and/or after a maturation stage, or a portion of the maturation stage. The one or more controllers may control the operations before, during, and/or after the forming, or a portion of the forming. The controller may comprise an electrical circuitry, one or more electrical wiring, a signal receiver, and/or a signal emitter. The controller may be operatively coupled to one or more components of the maturation device and/or the manufacturing device via a connecter and/or signal communication. The connection may be wired and/or wireless. The controller may communicate via signal receipt and/or transmission. The signal may comprise electrical, optical or audio signal.

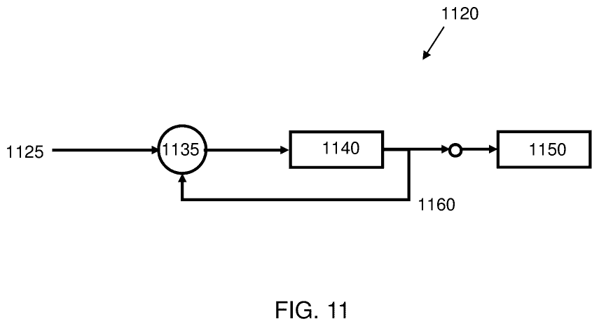

In some instances, the controller(s) can include (e.g., electrical) circuitry that is configured to generate output (e.g., voltage signals) for directing one or more aspects of the apparatuses (or any parts thereof) described herein. FIG. 11 shows a schematic example of a (e.g., automatic) controller (e.g., a control system, or a controller) 1120 that is programmed or otherwise configured to facilitate formation and/or maturation of one or more (e.g., intermediate) 3D objects, or of a filler material. The controller may comprise an electrical circuitry. The controller may comprise a connection to an electrical power. The controller (e.g., FIG. 11, 1120) can comprise a subordinate-controller 1140 for controlling formation and/or maturation of the one or more 3D objects, or of the filler material (e.g., FIG. 11, 1150). The controller may comprise one or more loop schemes (e.g., open loop, feed-forward loop and/or feedback loop). In the example of FIG. 11, the controller optionally includes feedback control loop 1160. The subordinate-controller may be an internal-controller. The controller (e.g., or subordinate controller) may comprise a proportion-integral-derivative (PID) loop. The subordinate-controller can be a second-controller as part of the first controller. The subordinate-controller can be a linear controller. The controller may be configured to control one or more components of a manufacturing device and/or a maturation device. The controller may be configured to control a transforming agent generator (e.g., an energy source, a dispenser of the binding agent and/or reactive agent), a guidance mechanism (e.g., scanner and/or actuator), at least one component of a layer dispenser, a dispenser (e.g., of a pre-transformed material and/or a transforming agent), at least one component of a gas flow system, at least one component of a chamber in which the intermediate 3D object (e.g., and/or filler material) is formed (e.g., a door, an elevator, a valve, a pump, and/or a sensor). The controller may control at least one component of the manufacturing device such as the transforming agent (e.g., forming agent). The controller may be configured to control a distribution component, a closeable container (e.g., control the closure and opening of the closure), a temperature, and/or a pressure, of a maturation device. For example, the controller (e.g., FIG. 11, 1120) may be configured to control (e.g., in real-time, during at least a portion of a formation cycle and/or a maturation stage) a controllable property. The controllable property (e.g., of a maturation device) may comprise: a temperature, or pressure, to which an intermediate 3D object is subjected, e.g., in the maturation stage(s). The controllable property may comprise a rate at which filler material is provided to a (e.g., closeable) container. The controllable property (e.g., of a manufacturing device) may comprise a property of a transforming agent, e.g., for forming a filler material. For example, the controllable property (e.g., for forming filler material and/or the intermediate object) may comprise: (i) an energy beam power (e.g., delivered to a target surface), (ii) temperature at a position in the target surface (e.g., on the forming 3D object), (iii) energy beam speed, (iv) energy beam power density, (v) energy beam dwell time, (vi) energy beam irradiation spot (e.g., on the target surface), (vii) energy beam focus (e.g., focus or defocus), or (viii) energy beam cross-section (e.g., beam waist, or FLS, e.g., diameter at half maximum radiation intensity). The controllable property (e.g., for forming filler material) may comprise a: (a) strength (e.g., reaction rate), (b) volume (e.g., delivered to the target surface), (c) density (e.g., on a location of the target surface), or (d) dwell time (e.g., on the target surface). The controllable property may be a control variable. The control may be to maintain a target parameter (e.g., temperature) of a position on the one or more intermediate 3D objects being formed, and/or matured. The target parameter may vary in time (e.g., in real-time) and/or in location. The target parameter may correspond to the signal sensed by the sensor. The target parameter may correlate to the controllable property. The (e.g., input) target parameter may vary in time and/or location in the forming and/or maturation device (e.g., on the maturing 3D object). The (e.g., input) target parameter may vary in time and/or location in the manufacturing device (e.g., on the target surface), e.g., during formation of filler material and/or 3D object (e.g., intermediate or matured). The controller may receive a pre-determined power per unit area (of the energy beam), temperature, and/or metrological (e.g., height) target value. For example, the controller may receive a target parameter (e.g., FIG. 11, 1125) (e.g. temperature, pH, or pressure) to maintain at least one characteristic of the maturing 3D object (e.g., dimension in a direction, and/or temperature). For example, the controller may receive a target parameter (e.g., FIG. 11, 1125) (e.g. temperature) to maintain at least one characteristic of the forming filler material (e.g., dimension in a direction, and/or temperature). The controller can receive one or a plurality of (e.g., five) types of target inputs: (i) a characteristic of a transforming agent (e.g., energy beam power), (ii) a temperature, (iii) a pressure, (iv) a pH, or (v) a geometry. Any of the target inputs may be user defined. The geometry may comprise geometric information of a previously formed 3D object. The geometry may be an input to the controller (e.g., via an open loop control scheme). At least some of the target values may be used to form instructions (e.g., FIG. 11, 1150), e.g., for maturing the intermediate 3D object. At least some of the target values may be used to generate forming instructions for the filler material. The (e.g., maturing, and/or forming) instructions may be dynamically adjusted in real-time. The controller may monitor (e.g., continuously) one or more signals from one or more sensors for providing feedback (e.g., FIG. 11, 1160). For example, the controller may monitor a temperature and/or a pressure in a chamber in which the intermediate object is undergoing a maturation stage (e.g., within a closable container). For example, the controller may monitor the energy beam power, temperature of a position on the target surface, and/or metrology (e.g., height) of a position on the target surface, during formation of a filler material and/or 3D object (e.g., intermediate 3D object). The position on the target surface may be of the forming filler material. The monitoring may be continuous or discontinuous. The monitoring may be in real-time, e.g., during a maturation stage, or during the forming of the filler material and/or the 3D object. The monitoring may be using the one or more sensors. The (e.g., maturing and/or forming) instructions may be dynamically adjusted in real-time (e.g., using the signals from the one or more sensors). A variation between the target parameter and the sensed parameter may be used to estimate an error in the value of that parameter (e.g., FIG. 11, 1135). The variation (e.g., error) may be used by the subordinate-controller (e.g., FIG. 11, 1140) to adjust the (e.g., maturing and/or forming) instructions. The controller may control (e.g., continuously) one or more parameters (e.g., in real-time). The controller may use historical data (e.g., for the parameters). The historical data may be of previously matured 3D objects and/or formed filler material. Configured may comprise built, constructed, designed, patterned, or arranged.

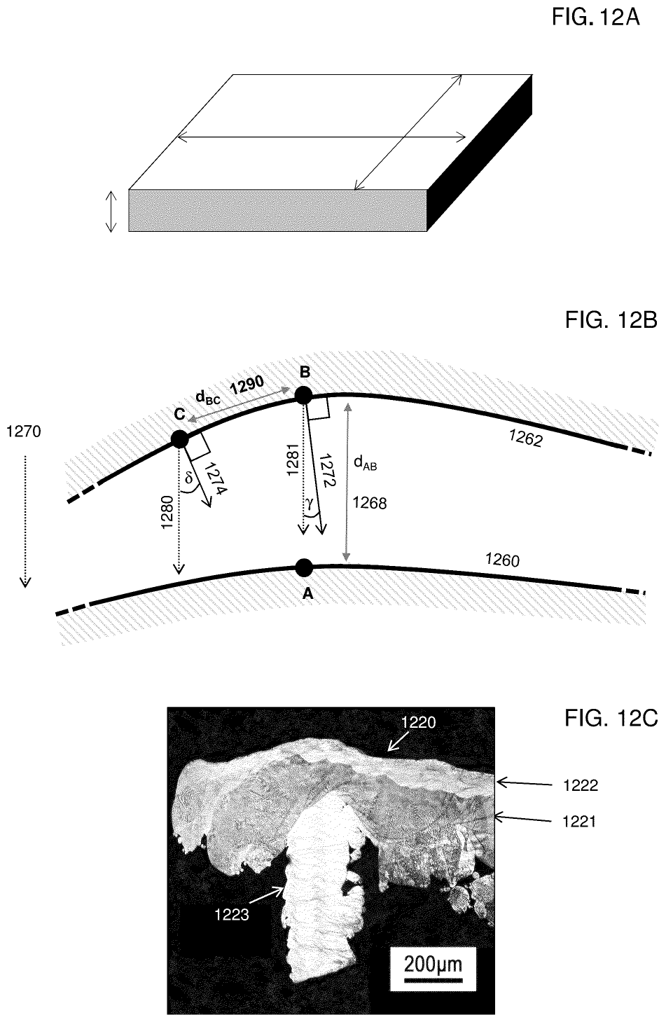

In some embodiments, 3D object (e.g., intermediate and/or matured) is formed to be (e.g., substantially) two-dimensional, such as a wire or a planar object. The (e.g., intermediate) 3D object may comprise a plane-like structure (referred to herein as “planar object,” “three-dimensional plane,” or “3D plane”). The 3D plane may have a relatively small thickness as compared to a relatively large surface area. The 3D plane may have a relatively small height relative to its width and length. For example, the 3D plane may have a small height relative to a large horizontal plane. FIG. 12A shows an example of a 3D plane that is (e.g., substantially) planar (e.g., flat). The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. The term “3D plane” is understood herein to be a generic (e.g., curved) 3D surface. For example, the 3D plane may be a curved 3D surface. In some embodiments, one or more layers within the intermediate 3D object may be (e.g., substantially) planar (e.g., flat). The planarity of a surface or a boundary of the layer may be (e.g., substantially) uniform. Substantially uniform may be relative to the intended purpose of the intermediate and/or requested (e.g., final, or matured) 3D object.

FIG. 12B shows an example of a first (e.g., top) surface 1260 and a second (e.g., bottom) surface 1262 of an (e.g., intermediate or matured) 3D object. At least a portion of the first and second surface may be separated by a gap. At least a portion of the first surface may be separated from at least a portion of the second surface (e.g., to constitute a gap). The gap may be filled with pre-transformed and/or binder material, e.g., during the formation of the 3D object. The gap may be filled with filler material, e.g., during at least one maturation stage. FIG. 12B shows an example of a vertical gap distance 1268 that separates the first surface 1260 from the second surface 1262. Point A (e.g., in FIG. 12B) may reside on the top surface of the first portion. Point B may reside on the bottom surface of the second portion. The second portion may be a cavity ceiling or hanging structure as part of the 3D object. Point B (e.g., in FIG. 12B) may reside above point A. Above (e.g., top) may be with respect to a global vector 1200. For example, for two positions in a 3D forming system, a (e.g., second) position (e.g., FIG. 12B, letter “B”) that has a lower global vector value than a (e.g., first) position (e.g., FIG. 12B, letter “A”) is above the (e.g., second) position. The gap may be the (e.g., shortest) distance (e.g., vertical distance) between points A and B. FIG. 12B shows an example of the gap 1268 that constitutes the shortest distance d_{AB} between points A and B. There may be a first normal to the bottom surface of the second portion at point B. FIG. 12B shows an example of a first normal 1272 to the surface 1262 at point B. The angle between the first normal 1272 and a direction of global vector 1270 may be any angle γ. A global vector may be (a) directed to a gravitational center, (b) directed opposite to the direction of a layer-wise deposition to form the 3D object, and/or (c) normal to a platform configured to support the 3D object during its formation and/or during a maturation stage, and directed away from a surface of the platform that supports the 3D object. Point C may reside on the bottom surface of the second portion. There may be a second normal to the bottom surface of the second portion at point C. FIG. 12B shows an example of the second normal 1274 to the surface 1262 at point C. The angle between the second normal 1274 and the global vector 1270 may be any angle δ. Vectors 1280, and 1281 are parallel to the global vector 1270. The angles γ and δ may be the same or different. The angle between the first normal 1272 and/or the second normal 1274 to the global vector 1200 may be an angle alpha. For example, the angle alpha (a) may be at most about 45°, 40°, 30°, 10°, 5°, 3°, 2°, 1°, or 0.5°. The angle alpha may be any value of the afore-mentioned values (e.g., at most about 45° to about 0.5°, from about 45° to about 20°, or from about 20° to about FIG. 12B shows an example of the shortest distance BC (e.g., 1290, d_{BC}). For example, the shortest distance d_{BC} may be at least about 0.1 millimeters (mm), 0.5 mm, 1 mm, 1.5 mm, 2 mm, 3 mm, 4 mm, 5 mm, 10 mm, 15 mm, 20 mm, 25 mm, 30 mm 35 mm, 40 mm, 50 mm, 100 mm, 200 mm, 300 mm, 400 mm, or 500 mm. The shortest distance d_{BC} may be any value between the afore-mentioned values (e.g., from about 0.1 mm to about 500 mm, from about 0.1 mm to about or from about 50 mm to about 500 mm). The vertical distance of the gap (e.g., d_{AB}) may be at least about 30 μm, 35 μm, 40 μm, 50 μm, 60 μm, 70 μm, 80 μm, 90 μm, 100 μm, 150 μm, 200 μm, 0.05 mm, 0.1 mm, 0.25 mm, 0.5 mm, 1 mm, 2 mm, 3 mm, 4 mm, 5 mm, 6 mm, 7 mm, 8 mm, 9 mm, 10 mm, 20 mm, 100 mm, or 150 mm. The vertical distance of the gap may be any value between the afore-mentioned values (e.g., from about 30 μm to about 200 μm, from about 100 μm to about 200 μm, from about 30 μm to about 100 mm, from about 80 mm to about 150 mm, from about 0.05 mm to about 20 mm, from about 0.05 mm to about 0.5 mm, from about 0.2 mm to about 3 mm, from about 0.1 mm to about 10 mm, or from about 3 mm to about 20 mm).

In some embodiments, a (e.g., intermediate, and/or maturing) 3D object includes one or more auxiliary features. The auxiliary feature(s) can be supported by a platform. The term “auxiliary feature,” or “auxiliary support,” as used herein, generally refers to a feature that is part of a formed (e.g., printed) 3D object, but may not be part of the intended, designed, ordered, and/or final 3D object. Auxiliary feature(s) (e.g., auxiliary support(s)) may provide structural support during and/or subsequent to the formation of the 3D object. The 3D object may comprise a single auxiliary support mark. The single auxiliary feature (e.g., auxiliary support or auxiliary structure) may be a platform (e.g., a building platform such as a base or substrate), or a mold. The auxiliary support may be adhered (e.g., connected) to the platform or mold. In some embodiments, the 3D object comprises one or more auxiliary support feature marks that are indicative of a presence or removal of the one or more auxiliary support features. Examples of auxiliary features comprise heat fins, wires, anchors, handles, supports, pillars, columns, frame, footing, scaffold, flange, projection, protrusion, mold (a.k.a. mould), or other stabilization features.

In some embodiments, the auxiliary supports (or a portion thereof) are removed from the 3D object after its maturation and/or formation. Removal can comprise machining (e.g., cutting, sawing and/or milling), polishing (e.g., sanding) and/or etching. Removal can comprise beam (e.g., laser) etching or chemical etching. In some cases, the supports (or a portion thereof) remain in and/or on the 3D object after formation. In some cases, the one or more supports leave respective one or more support marks on the 3D object that are indicative of a presence or removal of the one or more supports. FIG. 12C shows an example of a vertical cross section of a 3D object that includes a main portion 1220 coupled with a support 1223. In some embodiments, the main portion comprises a plurality of layers (e.g., 1221 and 1222) that were sequentially added (e.g., after formation of the support) during a forming operation. In some cases, the support causes a portion of the 3D object (e.g., one or more layers of the 3D object) to deform during formation. Sometimes, the deformed portion form a detectable (e.g., visible) mark. The mark may be a region of discontinuity in the layer, such as a microstructure discontinuity and/or an abrupt microstructural variation (e.g., FIG. 12C). The discontinuity in the microstructure may be explained by an inclusion of a foreign object (e.g., the support). The microstructural variation may include (e.g., abruptly) altered grain structure (e.g., crystals, e.g., dendrites) at or near the attachment point of the support. The microstructure variation may be due to differential thermal gradients due to the presence of the support. The microstructure variation may be due to a forced layer geometry due to the presence of the support. The discontinuity may be at an external surface of the 3D object. The discontinuity may arise from inclusion of the support in the surface of the 3D object, e.g. and may be visible as a breakage of the support when removed from the 3D object, e.g., after forming and/or at least one maturation stage. In some instances, the 3D object includes two or more supports and/or support marks. If more than one support is used, the supports may be spaced apart by a (e.g., pre-determined) distance.

At times, one or more controllers are configured to control (e.g., direct) one or more apparatuses and/or operations. Control may comprise regulate, modulate, adjust, maintain, alter, change, govern, manage, restrain, restrict, direct, guide, oversee, manage, preserve, sustain, restrain, temper, or vary. The control configuration (e.g., “configured to”) may comprise programming. The controller may comprise an electronic circuitry, and electrical inlet, or an electrical outlet. The configuration may comprise facilitating (e.g., and directing) an action or a force. The force may be magnetic, electric, pneumatic, hydraulic, and/or mechanical. Facilitating may comprise allowing use of ambient (e.g., external) forces (e.g., gravity). Facilitating may comprise alerting to and/or allowing: usage of a manual force and/or action. Alerting may comprise signaling (e.g., directing a signal) that comprises a visual, auditory, olfactory, or a tactile signal.

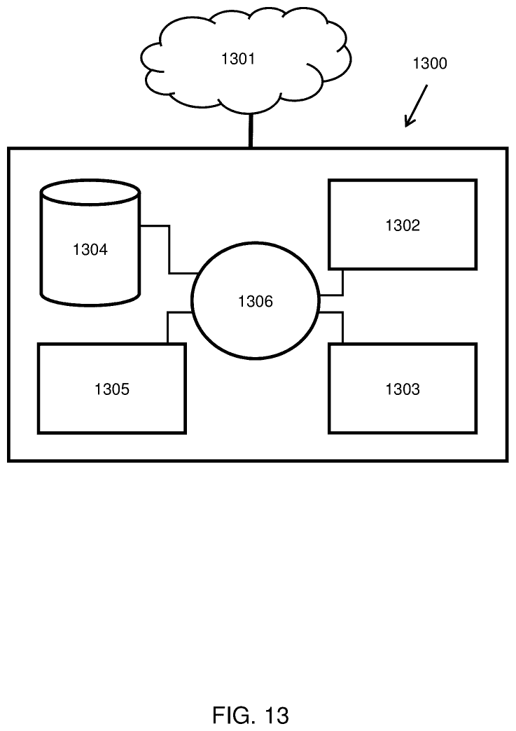

The controller may comprise processing circuitry (e.g., a processing unit). The processing unit may be central. The processing unit may comprise a central processing unit (herein “CPU”). The controllers or control mechanisms (e.g., comprising a computer system) may be configured to (e.g., programmed to) implement methods of the disclosure. The controller may control at least one component of the systems and/or apparatuses disclosed herein. FIG. 13 is a schematic example of a computer system 1300 that is programmed or otherwise configured to facilitate the formation of a filler material, an intermediate 3D object, a matured 3D object, and/or maturation of a (e.g., intermediate) 3D object, e.g., according to the methods provided herein. The computer system 1300 can control (e.g., direct and/or regulate) various features of formation methods, apparatuses and systems of the present disclosure, such as, for example, generation of forming instructions for formation of a 3D object (e.g., intermediate and/or matured), and/or a filler material. Generated forming instructions may comprise application of a pre-transformed material, application of a transforming agent to a selected location, a detection system activation and deactivation, sensor data and/or signal acquisition, image processing, process parameters (e.g., dispenser layer height, planarization, chamber pressure), or any combination thereof. The computer system 1300 can be part of, or be in communication with, a forming system or apparatus (or any of their components and/or ancillary devices), such as a 3D forming system or apparatus, and/or a maturation assembly, of the present disclosure. The computer system 1300 can control (e.g., direct and/or regulate) various features of maturation methods, apparatuses and systems of the present disclosure, such as, for example, generation of maturing instructions for maturation of an intermediate 3D object. The computer system 1300 can control a temperature and/or a pressure of a maturing system (e.g., chamber, or enclosure). The processor may be coupled to one or more mechanisms disclosed herein, and/or any parts thereof. For example, the computer may be coupled to one or more energy sources, optical elements, processing chamber, sealable containers (e.g., covers), distribution components, platform, sensors, valves, switches, motors, pumps, or any combination thereof.

The computer system 1300 can include a processing unit 1306 (also “processor,” “computer” and “computer processor” used herein). The computer system may include memory or memory location 1302 (e.g., random-access memory, read-only memory, flash memory), electronic storage unit 1304 (e.g., hard disk), communication interface 1303 (e.g., network adapter) for communicating with one or more other systems, and peripheral devices 1305, such as cache, other memory, data storage and/or electronic display adapters. The memory 1302, storage unit 1304, interface 1303, and peripheral devices 1305 are in communication with the processing unit 1306 through a communication bus (solid lines), such as a motherboard. The storage unit can be a data storage unit (or data repository) for storing data. The computer system can be operatively coupled to a computer network (“network”) 1301 with the aid of the communication interface. The network can be the Internet, an Internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. For example, the machine-readable instructions may comprise forming instructions or maturing instructions. The instructions may be stored in a memory location, such as the memory 1302. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a system on module (SOM) a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 1300 can be included in the circuit.

The storage unit 1304 can store files, such as drivers, libraries, and saved programs. The storage unit can store user data, e.g., user preferences and user programs. The storage unit may store at least one (e.g., set of) forming instruction(s). The storage unit may store at least one (e.g., set of) maturing instruction(s). The computer system in some cases can include one or more additional data storage units that are external to the computer system, such as located on a remote server that is in communication with the computer system through an intranet or the Internet.

The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory 1302 or electronic storage unit 1304. The machine executable or machine-readable code can be provided in the form of software. During use, the processor 1306 can execute the code. In some cases, the code can be retrieved from the storage unit and stored on the memory for ready access by the processor. In some situations, the electronic storage unit can be precluded, and machine-executable instructions are stored on memory.

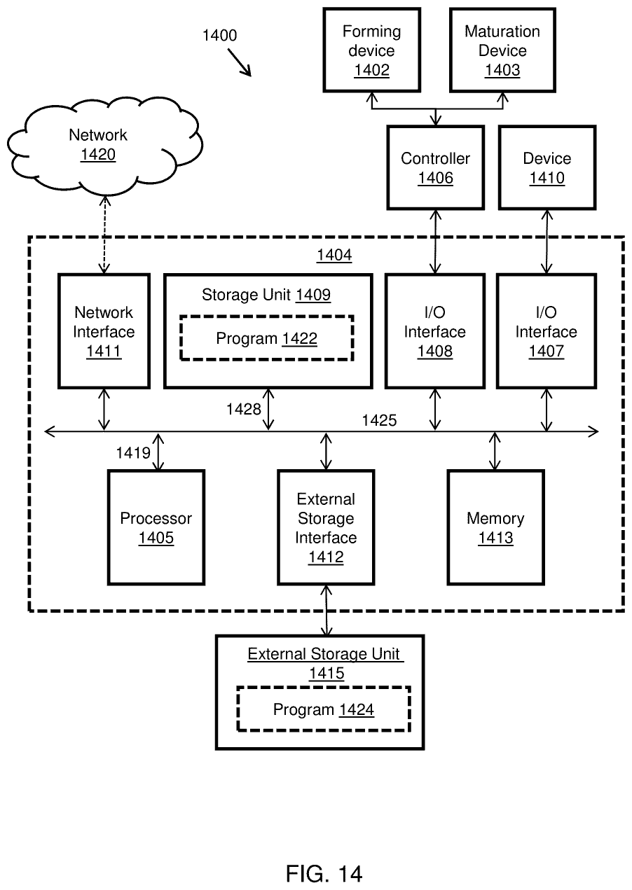

FIG. 14 shows an example computer system 1400, upon which the various arrangements described, can be practiced. The computer system (e.g., FIG. 14, 1400) can control and/or implement (e.g., direct and/or regulate) various features of forming and/or maturation methods, apparatus and/or system operations of the present disclosure. For example, the computer system may generate maturing instructions for maturation of an intermediate 3D object. The maturing instructions may comprise commands for a temperature and/or a pressure of a maturing system (e.g., chamber, or enclosure). The maturing instructions may comprise directing ingress and/or egress of the filler from the container. The maturing instructions may comprise directing opening and/or closing of the closure of the container. The computer(s) may be operatively coupled to one or more mechanisms of a maturation device. For example, the computer system can be used to instantiate a forming instructions engine. A forming instructions engine may generate instructions for forming a filler material, and/or a 3D object. The forming instructions may comprise commands to control: (i) parameters of a transforming agent generator (e.g., output power, or duty cycle), (ii) processing chamber (e.g., including container) parameters (e.g., chamber pressure, gas flow and/or temperature), (iii) transforming agent parameters (e.g., scanning rate, path and/or power), (iv) platform parameters (e.g., location and/or speed), (v) forming apparatus parameters (e.g., speed, location and/or vacuum), or (vi) any combination thereof. A forming instructions engine may generate instructions for forming a 3D object and/or filler in a layerwise manner. The forming instructions may be provided to at least one controller (e.g., FIG. 14, 1406). The computer system can be part of, or be in communication with, one or more forming devices (e.g., 3D printers, or manufacturing devices) (e.g., FIG. 14, 1402), and/or one or more maturation devices (e.g., FIG. 14, 1403) (including any of their (e.g., sub-) components and/or ancillary devices). The computer system can include one or more computers (e.g., FIG. 14, 1404). The computer(s) may be operatively coupled to one or more mechanisms of the maturation device(s) and/or forming devices(s). For example, the computer(s) may be operatively coupled to one or more sensors, valves, switches, actuators (e.g., motors), pumps, optical components, closeable containers (e.g., closures), and/or distribution components, of the maturation device(s) and/or energy sources of the printer(s). For example, the computer(s) may be operationally coupled to one or more sensors, valves, switches, actuators (e.g., motors), pumps, guidance systems, and/or transforming agent generators of the manufacturing device(s). In some cases, the computer(s) controls aspects of the maturation device(s) and/or forming device(s) via one or more controllers (e.g., FIG. 14, 1406). The controller(s) may be configured to direct one or more operations of the one or more maturation device(s) and/or forming device(s). For example, the controller(s) may be configured to direct one or more distribution components of the maturation device(s). For example, the controller(s) may be configured to direct one or more transforming agent generators of the forming device(s). In some cases, the controller(s) is part of the computer(s) (e.g., within the same unit(s)). In some cases, the controller(s) is separate (e.g., a separate unit) from the computer(s). In some instances, the computer(s) communicates with the controller(s) via one or more input/output (I/O) interfaces (e.g., FIG. 14, 1408). The input/output (I/O) interface(s) may comprise one or more wired or wireless connections to communicate with the maturation device(s) and/or forming device(s). In some embodiments, the I/O interface comprises Bluetooth technology to communicate with the controller(s).

The computer(s) (e.g., FIG. 14, 1404) may have any number of components. For example, the computer(s) may comprise one or more storage units (e.g., FIG. 14, 1409), one or more processors (e.g., FIG. 14, 1405), one or more memory units (e.g., FIG. 14, 1413), and/or one or more external storage interfaces (e.g., FIG. 14, 1412). In some embodiments, the storage unit(s) includes a hard disk drive (HDD), a magnetic tape drive and/or a floppy disk drive. In some embodiments, the memory unit(s) includes a random access memory (RAM) and/or read only memory (ROM), and/or flash memory. In some embodiments, the external storage interface(s) comprises a disk drive (e.g., optical or floppy drive) and/or a universal serial bus (USB) port. The external storage interface(s) may be configured to provide communication with one or more external storage units (e.g., FIG. 14, 1415). The external storage unit(s) may comprise a portable memory medium. The external storage unit(s) may be a non-volatile source of data. In some cases, the external storage unit(s) is an optical disk (e.g., CD-ROM, DVD, Blu-ray Disc™), a USB-RAM, a hard drive, a magnetic tape drive, and/or a floppy disk. In some cases, the external storage unit(s) may comprise a disk drive (e.g., optical or floppy drive). Various components of the computer(s) may be operationally coupled via a communication bus (e.g., FIG. 14, 1425). For example, one or more processor(s) (e.g., FIG. 14, 1405) may be operationally coupled to the communication bus by one or more connections (e.g., FIG. 14, 1419). The storage unit(s) (e.g., FIG. 14, 1409) may be operationally coupled to the communication bus one or more connections (e.g., FIG. 14, 1428). The communication bus (e.g., FIG. 14, 1425) may comprise a motherboard.

In some embodiments, methods described herein are implemented as one or more software programs (e.g., FIGS. 14, 1422 and/or 1424). The software program(s) may be executable within the one or more computers (e.g., FIG. 14, 1404). The software may be implemented on a non-transitory computer readable media. The software program(s) may comprise machine-executable code. The machine-executable code may comprise program instructions. The program instructions may be carried out by the computer(s) (e.g., FIG. 14, 1404). The machine-executable code may be stored in the storage device(s) (e.g., FIG. 14, 1409). The machine-executable code may be stored in the external storage device(s) (e.g., FIG. 14, 1415). The machine-executable code may be stored in the memory unit(s) (e.g., FIG. 14, 1413). The storage device(s) (e.g., FIG. 14, 1409) and/or external storage device(s) (e.g., FIG. 14, 1415) may comprise a non-transitory computer-readable medium. The processor(s) may be configured to read the software program(s) (e.g., FIGS. 14, 1422 and/or 1424). In some cases, the machine-executable code can be retrieved from the storage device(s) and/or external storage device(s), and stored on the memory unit(s) (e.g., FIG. 14, 1406) for access by the processor (e.g., FIG. 14, 1405). In some cases, the access is in real-time, e.g., during a maturation stage, or during a forming stage. In some situations, the storage device(s) and/or external storage device(s) can be precluded, and the machine-executable code is stored on the memory unit(s). The machine-executable code may be pre-compiled and configured for use with a machine have a processer adapted to execute the machine-executable code, or can be compiled during runtime (e.g., in real-time). The machine-executable code can be supplied in a programming language that can be selected to enable the machine-executable code to execute in a pre-compiled or as-compiled fashion.

In some embodiments, the computer(s) is operationally coupled with, or comprises, one or more devices (e.g., FIG. 14, 1410). In some embodiments, the device(s) (e.g., FIG. 14, 1410) is configured to provide one or more (e.g., electronic) inputs to the computer(s). In some embodiments, the device(s) (e.g., FIG. 14, 1410) is configured to receive one or more (e.g., electronic) outputs from the computer(s). The computer(s) may communicate with the device(s) via one or more input/output (I/O) interfaces (e.g., FIG. 14, 1407). The input/output (I/O) interface(s) may comprise one or more wired or wireless connections. The device(s) can include one or more user interfaces (UI). The UI may include one or more keyboards, one or more pointer devices (e.g., mouse, trackpad, touchpad, or joystick), one or more displays (e.g., computer monitor or touch screen), one or more sensors, and/or one or more switches (e.g., electronic switch). In some cases, the UI may be a web-based user interface. At times, the UI provides a model design or graphical representation of an intermediate 3D object to be matured and/or formed. The sensor(s) may comprise a light sensor, a thermal sensor, a pressure sensor, an audio sensor (e.g., microphone), and/or a tactile sensor. In some cases, the sensor(s) are part of the maturation and/or forming device(s) (e.g., FIG. 14, 1403). A maturation device may comprise a maturation assembly. For example, the sensor(s) may be located within a maturation chamber (e.g., to monitor an atmosphere therein). The sensor(s) may be configured to monitor one or more signals (e.g., a thermal and/or a pressure signal) that is generated during a maturation and/or formation stage. In some cases, the sensor(s) are part of the manufacturing and/or forming device(s). For example, the sensor(s) may be located within a processing chamber of a manufacturing and/or forming device (e.g., to monitor an atmosphere therein). The sensor(s) may be configured to monitor one or more signals (e.g., thermal and/or light signal) that is generated during a forming and/or maturation operation. In some cases, the sensor(s) are part of a component or apparatus that is separate from the maturation and/or forming device(s). In some cases, the device(s) is a pre-maturing processing apparatus. For example, in some cases, the device(s) can be one or more scanners (e.g., 2D or 3D scanner) for scanning (e.g., dimensions of) an intermediate 3D object. In some embodiments, the I/O interface comprises Bluetooth technology to communicate with the device(s).

In some embodiments, the computer(s) (e.g., FIG. 14, 1404), controller(s) (e.g., FIG. 14, 1406), forming device(s) (e.g., FIG. 14, 1402), maturation device(s) (e.g., FIG. 14, 1403), and/or device(s) (e.g., FIG. 14, 1410) comprises one or more communication ports. For example, one or more I/O interfaces (e.g., FIG. 14, 1407 or 1408) can comprise communication ports. The communication port(s) may be a serial port or a parallel port. The communication port(s) may be a Universal Serial Bus port (e.g., USB). The USB port can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, EOh, EFh, FEh, or FFh. The communication port(s) may comprise a plug and/or a socket (e.g., electrical, AC power, DC power). The communication port(s) may comprise an adapter (e.g., AC and/or DC power adapter). The communication port(s) may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some embodiments, the computer(s) is configured to communicate with one or more networks (e.g., FIG. 14, 1420). The network(s) may comprise a wide-area network (WAN) or a local area network (LAN). In some cases, the computer(s) includes one or more network interfaces (e.g., FIG. 14, 1411) that is configured to facilitate communication with the network(s). The network interface(s) may include wired and/or wireless connections. In some embodiments, the network interface(s) comprises a modulator demodulator (modem). The modem may be a wireless modem. The modem may be a broadband modem. The modem may be a “dial up” modem. The modem may be a high-speed modem. The WAN can comprise the Internet, a cellular telecommunications network, and/or a private WAN. The LAN can comprise an intranet. In some embodiments, the LAN is operationally coupled with the WAN via a connection, which may include a firewall security device. The WAN may be operationally coupled the LAN by a high capacity connection. In some cases, the computer(s) can communicate with one or more remote computers via the LAN and/or the WAN. In some instances, the computer(s) may communicate with a remote computer(s) of a user (e.g., operator). The user may access the computer(s) via the LAN and/or the WAN. In some cases, the computer(s) (e.g., FIG. 14, 1404) store and/or access data to and/or from data storage unit(s) that are located on one or more remote computers in communication via the LAN and/or the WAN. The remote computer(s) may be a client computer. The remote computer(s) may be a server computer (e.g., web server or server farm). The remote computer(s) can include desktop computers, personal computers (e.g., portable PC), slate or tablet PC's (e.g., Apple® iPad, Samsung® Galaxy Tab), telephones, smart phones (e.g., Apple® iPhone, Android-enabled device, Blackberry®), or personal digital assistants.

At times, the processor (e.g., FIG. 14, 1405) includes one or more cores. The computer system may comprise a single core processor, a multiple core processor, or a plurality of processors for parallel processing. The processor may comprise one or more central processing units (CPU) and/or graphic processing units (GPU). The multiple cores may be disposed in a physical unit (e.g., Central Processing Unit, or Graphic Processing Unit). The processor may be a single physical unit. The physical unit may be a die. The physical unit may comprise cache coherency circuitry. The processor may include multiple physical units. The physical unit may comprise an integrated circuit chip. The integrated circuit chip may comprise one or more transistors. The integrated circuit chip may comprise at least about 0.2 billion transistors (BT), 0.5 BT, 1 BT, 2 BT, 3 BT, 5 BT, 6 BT, 7 BT, 8 BT, 9 BT, 10 BT, 15 BT, 20 BT, BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The multiple cores may be disposed in close proximity. The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The independent central processors may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. The multiplicity of cores may include at least about 2, 10, 40, 100, 400, 1000, 2000, 3000, 4000, 5000, 6000, 7000, 8000, 9000, 10000, 11000, 12000, 13000, 14000 or 15000 cores. The multiplicity of cores may include at most about 1000, 2000, 3000, 4000, 5000, 6000, 7000, 8000, 9000, 10000, 11000, 12000, 13000, 14000, 15000, 20000, 30000, or 40000 cores. The multiplicity of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 Peta Flops (P-FLOPS), 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS, or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, or from about T-FLOP to about 10 EXA-FLOPS). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

At times, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by NVidia, ATI Technologies, S3 Graphics, Advanced Micro Devices (AMD), or Matrox. The processor(s) may be able to process algorithms comprising a matrix or a vector. The core may comprise a complex instruction set computing core (CISC), or reduced instruction set computing (RISC).

At times, the computer system includes an electronic chip that is reprogrammable (e.g., field programmable gate array (FPGA), e.g., application programming unit (APU)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

At times, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, APU, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration.

At times, the computing system includes an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most about 0.1 microsecond (μs), 1 μs, 10 μs, 100 μs, or 1 millisecond (ms). The physical unit may produce the algorithm output in any time between the afore-mentioned times (e.g., from about 0.1 μs, to about 1 ms, from about 0.1 μs, to about 100 μs, or from about 0.1 μs to about 10 μs).

In some instances, the controller(s) (e.g., FIG. 14, 1406) uses real-time measurements and/or calculations to regulate one or more components of the forming device(s) and/or maturation device(s). In some cases, the controller(s) regulates temperature and/or pressure within a chamber of the maturation device(s). In some cases, the controller(s) regulate characteristics of the transforming agent(s), e.g., of the forming device(s). The sensor(s) (e.g., on the printer) may provide a signal (e.g., input for the controller and/or processor) at a rate of at least about 0.1 KHz, 1 KHz, 10 KHz, 100 KHz, 1000 KHz, or 10000 KHz). The sensor(s) may be a temperature, a pressure, a chemical property (e.g., pH, oxygen, and/or water), and/or positional sensor(s). The sensor(s) may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processor(s) may be at least about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processor(s) may be at most about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processor(s) may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real-time measurements may be conducted during at least a portion of (i) a 3D forming process, or (ii) a maturation stage. The real-time measurements may be in-situ measurements in the forming device (e.g., 3D forming system), maturation device, and/or apparatus. The real-time measurements may be during at least a portion of the formation, and/or the maturation, of the intermediate 3D object. In some instances, the processor(s) may use the signal obtained from the at least one sensor to provide a processor(s) output, which output is provided by the processing system at a speed of at most about 100 minute (min), 50 min, 25 min, 15 min, 10 min, 5 min, 1 min, 0.5 min (i.e., 30 seconds (sec)), 15 sec, 10 sec, 5 sec, 1 sec, 0.5 sec, 0.25 sec, 0.2 sec, 0.1 sec, 80 milliseconds (ms), 50 ms, 10 ms, 5 ms, or 1 ms. In some instances, the processor(s) may use the signal obtained from the at least one sensor to provide a processor(s) output, which output is provided at a speed of any value between the aforementioned values (e.g., from about 100 min to about 1 ms, from about 100 min to about 10 min, from about 10 min to about 1 min, from about 5 min to about 0.5 min, from about 30 sec to about 0.1 sec, or from about 0.1 sec to about 1 ms). The processor(s) output may comprise an evaluation of an attribute of a maturation stage (e.g., temperature, chemical environment (e.g., pH), or pressure) at a location (e.g., of a maturation device), or of a forming process parameter (e.g., position of a transforming agent) at a location (e.g., of a forming device). The location may comprise a map of locations. The location may be on a target surface. The location may be within a maturation device (e.g., enclosure). The location may be on a surface of a filler material (e.g., particle) (e.g., during formation, or maturation). The map may be of any sensed signal (e.g., temperature, pH, or topology).

At times, the processor(s) (e.g., FIG. 14, 1405) uses the signal obtained from one or more sensors, e.g., on the maturation device(s) and/or the forming device(s). The signal may be used according to (e.g., at) an output rate (e.g., speed) of the processing system. The processor may use the signal obtained from the at least one sensor in an algorithm that is used to configure one or more parameters and/or apparatuses relating to the maturation and/or forming process(es). The parameters may comprise a characteristic of a chamber of a maturation device (e.g., temperature and/or pressure). The signal may be used in an algorithm that is used in controlling the transforming agent (e.g., energy beam) of a 3D forming device. The algorithm may comprise the path of the transforming agent. In some instances, the algorithm may be used to alter the path of the transforming agent on a target surface of a forming device that is forming a filler material. The algorithm may relate to the manner of formation and/or maturation (e.g., removal of a binder, or densification of an intermediate object). The algorithm may incorporate one or more parameters (e.g., sensed signals) relating to the manner of maturation and/or formation. The processor may use the signal obtained from the at least one sensor in an algorithm that is used to configure one or more parameters and/or apparatuses relating to the 3D forming procedure. The parameters may comprise a characteristic of the transforming agent. Alternatively, or additionally, the controller(s) (e.g., FIG. 14, 1410) may use historical data for the control. Alternatively, or additionally, the processor may use historical data in its one or more algorithms. The parameters may comprise a temperature profile, chemical profile (e.g., pH profile), and/or a pressure profile, e.g., of a chamber of the maturation device. The parameters may comprise a scanning rate, path, flow rate, and/or power of a transforming agent, e.g., at a target surface of a forming device for forming a filler material.

At times, the memory (e.g., FIG. 14, 1406) comprises a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complement to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

At times, all or portions of the software program(s) (e.g., FIG. 14, 1427) are communicated through the WAN or LAN networks. Such communications, for example, may enable loading of the software program(s) from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software program(s). As used herein, unless restricted to non-transitory, tangible “storage” media, terms such as computer or machine “readable medium” refer to any medium that participates in providing instructions to a processor for execution. Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and/or infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

At times, the computer system monitors and/or controls various aspects of the maturation device(s) and/or forming device(s) (e.g., 3D printer(s)). In some cases, the control is via controller(s) (e.g., FIG. 14, 1406). The control may be manual and/or programmed. The control may comprise an open loop control or a closed loop control (e.g., including feed forward and/or feedback) control scheme. The closed loop control may utilize signals from the one or more sensors. The control may utilize historical data. The control scheme may be pre-programmed. The control scheme may consider an input from one or more sensors (described herein) that are connected to the control unit (e.g., control system or control mechanism) and/or processor(s). The computer system (including the processor(s)) may store historical data concerning various aspects of the operation of the maturation device(s) and/or the forming device(s). The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the maturation device(s) and/or the forming device(s) (as described herein) in real time or in a delayed time. The output unit may output the maturation and/or formation progress of the maturing 3D object. The output unit may output at least one of the total time, time remaining, and time expended on maturing and/or forming the 3D object. The output unit may output (e.g., display, voice, and/or print) the status of sensors, their reading, and/or time for their calibration or maintenance. The output unit may output the type of material(s) used and various characteristics of the material(s). The material(s) may comprise material of the intermediate 3D object, the matured 3D object, or filler material. The characteristics may comprise temperature and flowability (e.g., of the pre-transformed, binder, and/or filler material). The computer may generate a report comprising various parameters of the maturation device and/or the forming device(s), method, filler material, and/or maturing 3D object(s). The report may be generated at predetermined time(s), on a request (e.g., from an operator), and/or at a whim. The output unit may comprise a screen, printer, a light source (e.g., lamp), or speaker. The control system may provide a report. The report may comprise any items recited as optionally output by the output unit.

At times, the systems, methods, and/or apparatuses disclosed herein comprise providing control of at least one process variable and/or attribute for maturing a requested 3D object (e.g., in a maturing stage). The process variable and/or attribute (e.g., sensed signal) may comprise a temperature, a chemical parameter (e.g., water, oxygen, and/or pH), or a pressure (e.g., of a maturation device). The process variable and/or attribute may be (e.g., at least indirectly) controlled as a control variable. The control variable and/or attribute may be controlled according to a (e.g., maturation) profile. A maturation profile may be formed considering maturing instructions for an intermediate 3D object. The software program(s) (e.g., FIGS. 14, 1422 and/or 1424) may comprise the maturing and/or forming instructions. The instructions may exclude a 3D model of the intermediate 3D object. The maturing instructions may consider (e.g., based on) the 3D model. The maturing instructions may comprise using a calculation (e.g., embedded in a software program(s)) that considers the 3D model, simulations, historical data, sensor input, or any combination thereof. The maturing instructions may be provided to at least one controller (e.g., FIG. 14, 1406) that provides control of at least one control variable. The control may comprise computing a calculation. The at least one controller may compute the calculation during the maturing procedure (e.g., in real-time), prior to the maturing procedure, after the maturing procedure, or any combination thereof.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method for forming a densified three-dimensional object, comprising:
(a) disposing a porous three-dimensional object and a flowable filler in an enclosure;
(b) densifying (i) the porous three-dimensional object to form the densified three-dimensional object that has a density greater than the porous three-dimensional object, and (ii) the flowable filler such that the flowable filler remains flowable upon formation of the densified three-dimensional object; and
(c) separating the densified three-dimensional object from the flowable filler.

2. The method of claim 1, further comprising separating the densified three-dimensional object from the enclosure.

3. The method of claim 1, wherein the flowable filler that is separated from the densified three-dimensional object in (c), has been densified in (b).

4. The method of claim 1, further comprising contracting the enclosure during densification of the porous three-dimensional object.

5. The method of claim 1, wherein the enclosure is a porous enclosure, and wherein the method further comprises densifying the porous enclosure during densification of the porous three-dimensional object.

6. The method of claim 1, further comprising evacuating the densified three-dimensional object from the enclosure after forming the densified three-dimensional object.

7. The method of claim 1, further comprising evacuating the flowable filler from the enclosure after forming the densified three-dimensional object.

8. The method of claim 1, wherein the flowable filler is flowable (i) during densification of the porous three-dimensional object and/or (ii) during contraction of the flowable filler.

9. The method of claim 1, wherein during densification, the flowable filler supports (i) the porous three-dimensional object and/or (ii) the densified three-dimensional object.

10. The method of claim 1, wherein the enclosure has an opening that can facilitate ingress and/or egress of (i) the porous three-dimensional object, (ii) the flowable filler, and/or (iii) the densified three-dimensional object.

11. The method of claim 10, wherein the opening is openable and/or closable by a lid.

12. The method of claim 11, wherein during densification of the porous three-dimensional object, the lid is closed.

13. The method of claim 1, wherein at least two of: (i) the enclosure, (ii) the porous three-dimensional object, and (iii) the flowable filler, comprise the same material.

14. The method of claim 1, wherein at least two of: (i) the enclosure, (ii) the porous three-dimensional object, and (iii) the flowable filler, contract in the same manner during densification of the porous three-dimensional object.

15. The method of claim 1, wherein the porous three-dimensional object is a green body or a brown body.

16. The method of claim 1, wherein densification of the porous three-dimensional object comprises using heat or pressure.

17. The method of claim 1, further comprising controlling densification of the porous three-dimensional object using one or more controllers.

18. The method of claim 1, wherein the flowable filler is smaller than the densified three-dimensional object.

19. An apparatus for forming a densified three-dimensional object, comprising:
at least one controller that is configured to:
(a) operatively couple to a first component, and a second component;
(b) direct the first component to provide a flowable filler to an enclosure to at least partially support a porous three-dimensional object disposed within the enclosure, wherein the enclosure is configured to enclose an interior environment in a volume, wherein the enclosure is configured to accommodate in the volume the porous three-dimensional object and the flowable filler during densification of the porous three-dimensional object that forms the densified three-dimensional object that has a greater density as compared to the porous three-dimensional object; and
(c) direct the second component to adjust a characteristic of the interior environment to (i) densify the porous three-dimensional object to form the densified three-dimensional object, and (ii) densify the flowable filler, wherein the flowable filler remains flowable upon formation of the densified three-dimensional object.

20. The apparatus of claim 19, wherein the at least one controller is further configured to direct the first component to distribute the flowable filler to at least partially surround the porous three-dimensional object, in order to provide the flowable filler.

21. The apparatus of claim 19, wherein the first component comprises a conveyor, an emitter, a hopper, a piston, a robotic arm, or a rotating screw.

22. The apparatus of claim 21, wherein the emitter is configured to emit an electromagnetic wave, and/or a sound wave, into a medium that is coupled with the enclosure.

23. The apparatus of claim 19, wherein the first component comprises a hopper, a dispenser, a funnel, an opening, or a channel, wherein the opening and/or the channel are configured to flow the flowable filler therethrough.

24. The apparatus of claim 19, wherein the second component comprises a pump, a heat source, a gas source, or a fluid source.

25. The apparatus of claim 19, wherein the first component and/or the second component comprises an actuator.

26. The apparatus of claim 19, wherein to adjust the characteristic of the interior environment comprises an adjustment to a temperature, a pH, and/or to a pressure.

27. The apparatus of claim 26, wherein the adjustment comprises an increase with respect to an environment that is external to the interior environment.

28. The apparatus of claim 26, wherein the adjustment comprises a decrease with respect to an environment that is external to the interior environment.

29. The apparatus of claim 19, wherein the at least one controller is further configured to consider a maturing instruction(s) to perform (b) and/or (c).

30. The apparatus of claim 29, wherein the maturing instruction(s) comprises a temperature profile, a pH profile, or a pressure profile.

31. The apparatus of claim 29, wherein one or more commands of the maturing instruction(s) consider a given maturation stage of the porous three-dimensional object.

32. The apparatus of claim 31, wherein the maturing instruction(s) comprise one or more commands for at least two maturation stages of the porous three-dimensional object.

33. The apparatus of claim 32, wherein the at least two maturation stages comprise (i) removal of a binder material of the porous three-dimensional object, (ii) connecting material of the porous three-dimensional object, or (iii) densifying material of the porous three-dimensional object.

34. The apparatus of claim 33, wherein densifying material of the porous three-dimensional object comprises fusing the material.

35. The apparatus of claim 29, wherein the maturing instruction comprises a densification instruction.

36. The apparatus of claim 19, wherein the at least one controller is further configured to operatively couple to a third component, and to direct the third component to separate between the densified three-dimensional object and the flowable filler.

37. The apparatus of claim 36, wherein the at least one controller is further configured to consider a signal from a sensor to direct the third component.

38. The apparatus of claim 36, wherein the at least one controller is configured to direct the third component to evacuate the flowable filler from the enclosure to separate.

39. The apparatus of claim 38, wherein the third component comprises, or is configured to operatively couple to a force source comprising: a magnetic, electrostatic, gaseous, or mechanical force source.

40. The apparatus of claim 38, wherein the third component comprises, or is configured to operatively couple to a brush, a squeegee, a crane, a robotic arm, an agitator, or an actuator.

41. The apparatus of claim 36, wherein the at least one controller is configured to direct the third component to remove the densified three-dimensional object from the enclosure to separate.

42. The apparatus of claim 36, wherein the first component and the third component are the same.

43. The apparatus of claim 36, wherein the first component and the third component are different.

44. The apparatus of claim 19, wherein the at least one controller comprises a closed loop control scheme.

45. The apparatus of claim 44, wherein the closed loop control scheme comprises a feedback or a feed-forward control scheme.

46. The apparatus of claim 19, wherein the at least one controller is further configured to consider a signal from a sensor to direct the first component and/or the second component.

47. The apparatus of claim 46, wherein the at least one controller is configured to consider the signal to perform a feedback and/or a feed-forward control scheme.

48. The apparatus of claim 46, wherein the sensor comprises an optical, capacitive, inductive, or mechanical, sensor.

49. The apparatus of claim 48, wherein the sensor comprises a transducer or a switch.

50. The apparatus of claim 19, wherein the at least one controller is configured to operatively couple to an opening of the enclosure, and to direct ingress and/or egress of (i) the porous three-dimensional object, (ii) the flowable filler, and/or (iii) the densified three-dimensional object.

51. The apparatus of claim 50, wherein the at least one controller is configured to direct operation of (A) a shutter, (B) a lid, and/or (C) a valve, to direct the ingress and/or the egress.

52. The apparatus of claim 50, wherein during (c), the at least one controller is configured to direct the opening to separate the interior environment from an external environment.

53. The apparatus of claim 19, wherein (b) and (c) are performed by a same controller.

54. The apparatus of claim 19, wherein (b) and (c) are performed by different controllers.

55. The apparatus of claim 19, wherein the enclosure comprises an inert and/or non-reactive atmosphere, which non-reactive is with respect to (i) the porous three-dimensional object, (ii) the densified three-dimensional object, and/or (iii) the flowable filler.

56. The apparatus of claim 19, wherein the interior environment of the enclosure comprises an atmosphere maintained at a pressure above an ambient pressure.

57. The apparatus of claim 19, further comprising the at least one controller configured to operatively couple with a communication component, the communication component configured to communicate with the first component and/or the second component by a signal.

58. The apparatus of claim 57, wherein the communication component is configured to communicate wireless or via a wired connection.

59. The apparatus of claim 19, wherein the at least one controller comprises a socket.

60. The apparatus of claim 19, wherein the at least one controller comprises an electrical circuit.

61. A particulate material, comprising: one or more particles having characteristics comprising: (a) an average fundamental length scale of at most three (3) millimeters, (b) is flowable prior to densification of the one or more particles by at least twenty-five percent, (c) densifiable by the at least twenty-five percent upon heating, and (d) remains flowable upon densification by the at least twenty-five percent.

62. The particulate material of claim 61, wherein the particulate material comprises an elemental metal or a metal alloy.

63. The particulate material of claim 61, wherein the particulate material is flowable prior to densification by the at least twenty-five percent.

64. The particulate material of claim 61, wherein the particulate material comprises a plurality of particles that do not adhere to each other before, upon, and/or after densification by the at least twenty-five percent.

65. The particulate material of claim 61, wherein before, upon, and/or after densification by the at least twenty-five percent, at least two particles of the particulate material are clumped together.

66. The particulate material of claim 61, wherein before, upon, and/or after densification by the at least twenty-five percent, at least two particles of the particulate material are disconnected.

67. The particulate material of claim 61, wherein the particulate material comprises a plurality of particles that adhere to each other before, upon, and/or after densification by the at least twenty-five percent.

68. The particulate material of claim 61, wherein before, upon, and/or after densification by the at least twenty-five percent, the particulate material has a basic flow energy of at least about 100 milli-Joule (mJ).

69. The particulate material of claim 61, wherein before, upon, and/or after densification by the at least twenty-five percent, the particulate material has a specific energy of at least about 1.0 milli-Joule per gram (mJ/g).

70. The particulate material of claim 61, wherein before, upon, and/or after densification by the at least twenty-five percent, the particulate material has a critical angle of repose of 50 degrees or less.

71. The particulate material of claim 61, wherein a flowability of the particulate material prior to and upon densification by the at least twenty-five percent, remains the same.

72. The particulate material of claim 61, wherein a flowability of the particulate material prior to the densification by the at least twenty-five percent, is higher than the flowability upon and/or after the densification.

73. The particulate material of claim 61, wherein the particulate material comprises a pore.

74. The particulate material of claim 73, wherein the pore is a closed pore.

75. The particulate material of claim 73, wherein the pore is an open pore.

76. The particulate material of claim 73, wherein the pore is isotropic.

77. The particulate material of claim 73, wherein the pore is anisotropic.

78. The particulate material of claim 61, wherein the particulate material comprises a plurality of pores.

79. The particulate material of claim 78, wherein at least two pores of the plurality of pores are disconnected.

80. The particulate material of claim 78, wherein at least two pores of the plurality of pores are interconnected.

81. The particulate material of claim 61, wherein the particulate material comprises an elemental metal or a metal alloy.

82. The particulate material of claim 61, wherein the particulate material has at least a partial coating that comprises an elemental metal, a metal alloy, a ceramic, or an allotrope of elemental carbon.

83. The particulate material of claim 61, wherein the particulate material has a coating that encapsulates the one or more particles.

84. The particulate material of claim 61, wherein the particulate material is a mature particulate material having a coating that comprises a material generated at least in part by a surface treatment of an immature particulate material from which the mature particulate material is derived.

85. The particulate material of claim 61, wherein the particulate material is a mature particulate material having a coating that comprises a material generated at least in part by a chemical manipulation of an immature particulate material from which the mature particulate material is derived.

86. The particulate material of claim 85, wherein the chemical manipulation comprises oxidation.

87. The particulate material of claim 61, wherein the particulate material comprises a network, or a lattice.

88. The particulate material of claim 61, wherein the particulate material comprises a foam.

89. The particulate material of claim 61, wherein the particulate material comprises a layer.

90. The particulate material of claim 89, wherein on average, the layer is an ellipsoid.

91. The particulate material of claim 89, wherein on average, the layer is planar.

92. The particulate material of claim 89, wherein the layer at least partially surrounds a core of the particulate material.

93. The particulate material of claim 61, wherein the particulate material comprises multi layers.

94. A method for forming a particulate material, comprising:
forming one or more particles having characteristics comprising: (a) an average fundamental length scale of at most three (3) millimeters, (b) are flowable prior to densification of the one or more particles by at least twenty-five percent, (c) densifiable by the at least twenty-five percent upon heating, and (d) remain flowable upon densification by the at least twenty-five percent.

95. The method of claim 94, wherein forming the one or more particles comprises three-dimensional printing.

96. The method of claim 94, wherein forming the one or more particles comprises sintering or melting.

97. The method of claim 94, wherein forming the one or more particles comprises gas injection, or gas forming.

98. The method of claim 97, wherein gas forming comprises decomposition or combustion.

99. The method of claim 94, wherein forming the one or more particles comprises casting, molding, replication, imprinting, or deposition.

100. The method of claim 99, wherein the deposition comprises chemical deposition or physical deposition.

101. The method of claim 99, wherein the deposition comprises plasma deposition or vapor deposition.

102. The method of claim 94, wherein forming the one or more particles comprises using a binder.

103. The method of claim 94, wherein forming the one or more particles excludes using a binder.

104. The method of claim 94, wherein forming the one or more particles comprises forming a coating on, or impregnating, the one or more particles.

105. The method of claim 104, wherein the coating or impregnating is of a polymer.

106. The method of claim 104, wherein the coating or impregnating is of a foam.

107. The method of claim 106, wherein the foam comprises an elemental metal or a metal alloy.

108. The method of claim 94, wherein forming the one or more particles comprises passivating or oxidizing at least a portion of an external surface of the one or more particles.

109. The method of claim 94, wherein forming the one or more particles comprises forming a pore within the one or more particles.

110. The method of claim 109, wherein the pore comprises a closed pore.

111. The method of claim 109, wherein the pore comprises an open pore.

112. The method of claim 94, wherein densifiable comprises contractible.

113. The method of claim 94, wherein densifiable facilitates supporting (i) a porous three-dimensional object during its densification, and (b) a densified three-dimensional object formed upon densification of the porous three-dimensional object.

114. The method of claim 94, further wherein the one or more particles are flowable during densification by the at least twenty-five percent.

115. A particulate material comprising: a plurality of particles having a fundamental length scale of at most three (3) millimeters, which plurality of particles includes a particle having characteristics comprising:
(a) a shell constituent that (I) occupies at least a portion of an external surface of the particle and (II) is transformed at a first temperature, wherein transformation of the shell constituent comprises (i) densification by melting or (ii) densification by sintering; and
(b) a core constituent that (A) has at least one pore, and (B) at least a portion of the core constituent is transformed at a second temperature lower than the first temperature, wherein transformation of the at least the portion of the core constituent comprises (b1) densification by melting or (b2) densification by sintering; and
(c) before and upon transformation of the at least the portion of the core constituent, the particulate material is flowable.

116. The particulate material of claim 115, wherein transformation of the at least the portion of the core constituent comprising densifying the at least the portion of the core constituent by at least twenty-five percent.

117. The particulate material of claim 115, wherein the shell constituent occupies at least fifty percent of the external surface of the particle.

118. The particulate material of claim 115, wherein the particulate material comprises an elemental metal or a metal alloy.

119. The particulate material of claim 115, wherein the particulate material is flowable prior to transformation of the at least the portion of the core constituent.

120. The particulate material of claim 115, wherein the plurality of particles do not adhere to each other before, upon, and/or after transformation of the at least the portion of the core constituent.

121. The particulate material of claim 115, wherein before, upon, and/or after transformation of the at least the portion of the core constituent, at least two particles of the plurality of particles are clumped together.

122. The particulate material of claim 115, wherein before, upon, and/or after densification transformation of the at least the portion of the core constituent, at least two particles of the particulate material are disconnected.

123. The particulate material of claim 115, wherein at least two particles of the plurality of particles are adhered to each other before, upon, and/or after transformation of the at least the portion of the core constituent.

124. The particulate material of claim 115, wherein before, upon, and/or after transformation of the at least the portion of the core constituent, the particulate material has a basic flow energy of at least about 100 milli-Joule (mJ).

125. The particulate material of claim 115, wherein before, upon, and/or after transformation of the at least the portion of the core constituent, the particulate material has a specific energy of at least about 1.0 milli-Joule per gram (mJ/g).

126. The particulate material of claim 115, wherein before, upon, and/or after transformation of the at least the portion of the core constituent, the particulate material has a critical angle of repose of 50 degrees or less.

127. The particulate material of claim 115, wherein a flowability of the particulate material prior and upon transformation of the at least the portion of the core constituent, remains the same.

128. The particulate material of claim 115, wherein a flowability of the particulate material prior to the transformation of the at least the portion of the core constituent, is higher than the flowability upon and/or after the transformation of the at least the portion of the core constituent.

129. The particulate material of claim 115, wherein the particulate material comprises a pore.

130. The particulate material of claim 129, wherein the pore is a closed pore.

131. The particulate material of claim 129, wherein the pore is an open pore.

132. The particulate material of claim 129, wherein the pore is isotropic.

133. The particulate material of claim 129, wherein the pore is anisotropic.

134. The particulate material of claim 115, wherein the particulate material comprises a plurality of pores.

135. The particulate material of claim 134, wherein at least two pores of the plurality of pores are disconnected.

136. The particulate material of claim 134, wherein at least two pores of the plurality of pores are interconnected.

137. The particulate material of claim 115, wherein the particulate material comprises an elemental metal or a metal alloy.

138. The particulate material of claim 115, wherein the core constituent comprises an elemental metal or a metal alloy.

139. The particulate material of claim 115, wherein the shell constituent comprises an elemental metal, a metal alloy, a ceramic, or an allotrope of elemental carbon.

140. The particulate material of claim 115, wherein the shell constituent at least in part encapsulates the core constituent.

141. The particulate material of claim 115, wherein the shell constituent is generated at least in part by a surface treatment of the core constituent.

142. The particulate material of claim 115, wherein the shell constituent is generated at least in part by a chemical manipulation of an external surface of the core constituent.

143. The particulate material of claim 142, wherein the chemical manipulation comprises oxidation.

144. The particulate material of claim 115, wherein the particulate material comprises a network, or a lattice.

145. The particulate material of claim 115, wherein the particulate material comprises a foam.

146. The particulate material of claim 115, wherein the core constituent comprises a network, or a lattice.

147. The particulate material of claim 115, wherein the core constituent comprises a foam.

148. The particulate material of claim 115, wherein the particulate material comprises a layer.

149. The particulate material of claim 148, wherein the shell constituent comprises the layer.

150. The particulate material of claim 148, wherein on average, the layer is an ellipsoid.

151. The particulate material of claim 148, wherein on average, the layer is planar.

152. The particulate material of claim 148, wherein the layer at least partially surrounds a core of the particulate material.

153. The particulate material of claim 115, wherein the particulate material comprises multi layers.

154. The particulate material of claim 153, wherein the shell constituent comprises the multi layers.

155. The particulate material of claim 153, wherein the core constituent comprises the multi layers.

156. A method for forming a particulate material, comprising:
forming a plurality of particles, wherein forming a particle of the plurality of particles comprises:
(a) forming a core such that the core (I) includes at least one pore and (II) at least a portion of the core is transformed at a first temperature, which transformation of the at least the portion of the core comprises: (i) densifying by melting or (ii) densifying by sintering, wherein the at least the portion of the core is transformable by heating, and wherein before and upon transformation of the at least the portion of the core, the particulate material is flowable; and
(b) forming a shell such that the shell (I) at least partially occupies an external surface of the particle, and (II) is transformed at a second temperature that is higher than the first temperature, which transformation of the shell comprises: (i) densifying by melting or (ii) densifying by sintering, and
wherein the plurality of particles have an average fundamental length scale of at most three (3) millimeters.

157. The method of claim 156, wherein forming the plurality of particles comprises three-dimensional printing.

158. The method of claim 156, wherein forming the plurality of particles comprises an exothermic reaction and/or an explosive reaction.

159. The method of claim 156, wherein forming the plurality of particles comprises casting, molding, replication, imprinting, or deposition.

160. The method of claim 159, wherein deposition comprises chemical deposition or physical deposition.

161. The method of claim 159, wherein deposition comprises plasma deposition or vapor deposition.

162. The method of claim 156, wherein forming the plurality of particles comprises sintering or melting.

163. The method of claim 156, wherein forming the plurality of particles comprises gas injection, or gas forming.

164. The method of claim 163, wherein gas forming comprises decomposition or combustion.

165. The method of claim 156, wherein forming the plurality of particles comprises using a binder.

166. The method of claim 156, wherein forming the plurality of particles excludes using a binder.

167. The method of claim 156, wherein forming the shell comprises coating, or impregnating.

168. The method of claim 167, wherein coating or impregnating is of a material comprising a polymer.

169. The method of claim 167, wherein coating or impregnating is of a material comprising a foam.

170. The method of claim 156, wherein the at least one pore comprises an open pore.

171. The method of claim 156, wherein the at least one pore comprises a closed pore.

172. The method of claim 156, wherein the plurality of particles is contractible to facilitate supporting (a) a porous three-dimensional object during its densification, and (b) a densified three-dimensional object that is formed upon densification of the porous three-dimensional object.

173. The method of claim 172, wherein each particle of the plurality of particles is contractible.

174. The method of claim 156, wherein the core comprises a network, or a lattice.

175. The method of claim 156, wherein the core comprises a foam.

176. The method of claim 156, wherein the core comprises a first material and the shell comprises a second material, and further wherein forming the shell comprises modifying the first material by the second material.

177. The method of claim 176, wherein the modifying comprises adding the second material to the first material.

178. The method of claim 176, wherein the modifying comprises treating the first material by a surface treatment.

179. The method of claim 176, wherein the modifying comprises chemically manipulating.

180. The method of claim 179, wherein chemically manipulating comprises passivating or oxidizing.

181. The method of claim 156, wherein forming the core in (a) and forming the shell in (b) are performed simultaneously.

182. The method of claim 156, wherein forming the core in (a) and forming the shell in (b) are performed sequentially.

183. The method of claim 182, wherein forming the core in (a) is performed prior to forming the shell in (b).

184. The method of claim 182, wherein forming the shell in (b) is performed prior to forming the core in (a).

185. A particulate material, comprising:
(a) a first material that forms a core of the particulate material, which particulate material supports: (i) a porous three-dimensional object during its densification to a densified three-dimensional object that has a density greater than the porous three-dimensional object, and (ii) the densified three-dimensional object upon densification; and
(b) a second material disposed in an exterior of the particulate material, which second material allows the particulate material to be flowable during, and upon densification of the porous three-dimensional object, wherein flowable is at least to an extent that the particulate material is separable from the densified three-dimensional object.

186. The particulate material of claim 185, wherein the first material is contractible to facilitate supporting (a) the porous three-dimensional object during its densification, and (b) the densified three-dimensional object upon densification.

187. The particulate material of claim 185, wherein the first material comprises a pore.

188. The particulate material of claim 187, wherein the pore is a closed pore.

189. The particulate material of claim 187, wherein the pore is an open pore.

190. The particulate material of claim 187, wherein the pore is isotropic.

191. The particulate material of claim 187, wherein the pore is anisotropic.

192. The particulate material of claim 185, wherein the first material is comprised in the porous three-dimensional object and/or in the densified three-dimensional object.

193. The particulate material of claim 185, wherein the first material comprises a plurality of pores.

194. The particulate material of claim 193, wherein at least two pores of the plurality of pores are disconnected.

195. The particulate material of claim 193, wherein at least two pores of the plurality of pores are interconnected.

196. The particulate material of claim 185, wherein the first material comprises an elemental metal or a metal alloy.

197. The particulate material of claim 185, wherein the second material comprises an elemental metal, a metal alloy, a ceramic, or an allotrope of elemental carbon.

198. The particulate material of claim 185, wherein the second material at least partially results from a surface treatment of the first material.

199. The particulate material of claim 185, wherein the second material comprises the first material that has been altered by a chemical manipulation.

200. The particulate material of claim 199, wherein the chemical manipulation of the first material to the second material comprises oxidation.

201. The particulate material of claim 185, wherein the first material comprises a network, or a lattice.

202. The particulate material of claim 185, wherein the first material comprises a foam.

203. The particulate material of claim 185, wherein the particulate material is smaller than the densified three-dimensional object.

204. The particulate material of claim 185, wherein the second material encapsulates the first material.

205. The particulate material of claim 185, wherein the particulate material comprises a layer.

206. The particulate material of claim 205, wherein on average, the layer is an ellipsoid.

207. The particulate material of claim 205, wherein on average, the layer is planar.

208. The particulate material of claim 205, wherein the layer surrounds the core of the particulate material.

209. The particulate material of claim 185, wherein the particulate material comprises multi layers.

210. A method for forming a particulate material, comprising:
(a) forming a first material that is a core of the particulate material, which particulate material supports: (i) a porous three-dimensional object during its densification to a densified three-dimensional object that has a density greater than the porous three-dimensional object, and (ii) the densified three-dimensional object upon densification; and
(b) forming a second material that at least partially covers the first material, which second material allows the particulate material to be flowable during and upon densification of the porous three-dimensional object, wherein flowable is at least to an extent that the particulate material is separable from the densified three-dimensional object.

211. The method of claim 210, wherein forming the first material comprises three-dimensional printing.

212. The method of claim 210, wherein forming the first material comprises sintering or melting.

213. The method of claim 210, wherein forming the first material comprises gas injection, or gas forming.

214. The method of claim 213, wherein gas forming comprises decomposition or combustion.

215. The method of claim 210, wherein forming the first material comprises casting, molding, replication, imprinting, or deposition.

216. The method of claim 215, wherein the deposition comprises chemical deposition or physical deposition.

217. The method of claim 215, wherein the deposition comprises plasma deposition or vapor deposition.

218. The method of claim 210, wherein forming the first material comprises using a binder.

219. The method of claim 210, wherein forming the first material excludes using a binder.

220. The method of claim 210, wherein forming the first material includes coating, or impregnating.

221. The method of claim 220, wherein coating or impregnating is of a polymer.

222. The method of claim 220, wherein coating or impregnating is of a foam.

223. The method of claim 210, wherein forming comprises an exothermic reaction and/or an explosive reaction.

224. The method of claim 210, wherein the first material comprises a closed pore.

225. The method of claim 210, wherein the first material comprises an open pore.

226. The method of claim 210, wherein the first material is contractible to facilitate supporting (a) the porous three-dimensional object during its densification, and (b) the densified three-dimensional object upon densification.

227. The method of claim 210, wherein the first material comprises a pore.

228. The method of claim 210, wherein the first material is comprised in the porous three-dimensional object and/or in the densified three-dimensional object.

229. The method of claim 210, wherein the first material comprises an elemental metal or a metal alloy.

230. The method of claim 210, wherein the second material comprises an elemental metal, a metal alloy, a ceramic, or an allotrope of elemental carbon.

231. The method of claim 210, wherein forming the second material comprises addition of the second material to the first material.

232. The method of claim 210, wherein forming the second material comprises passivation.

233. The method of claim 210, wherein forming the second material comprises chemically manipulating the first material.

234. The method of claim 233, wherein chemically manipulating the first material to the second material comprises oxidation.

235. The method of claim 210, wherein the first material comprises a network, or a lattice.

236. The method of claim 210, wherein the first material comprises a foam.

237. The method of claim 210, wherein the particulate material is smaller than the densified three-dimensional object.

238. The method of claim 210, wherein the second material encapsulates the first material.

239. The method of claim 210, wherein the particulate material comprises a layer.

240. The method of claim 239, wherein on average, the layer is an ellipsoid.

241. The method of claim 239, wherein on average, the layer is planar.

242. The method of claim 239, wherein the layer surrounds the core of the particulate material.

243. The method of claim 210, wherein the particulate material comprises multi layers.

244. The method of claim 210, wherein the first material and the second material are of the same material.

245. The method of claim 210, wherein forming the first material in (a) and forming the second material in (b) is performed simultaneously.

246. The method of claim 210, wherein forming the first material in (a) and forming the second material in (b) is performed sequentially.
